(19) United States
(12) Patent Application Publication
(10) Pub. No.: US 2025/0076737 A1
(43) Pub. Date: Mar. 6, 2025

(54) CAMERA ACTUATOR, LENS TRANSFER DEVICE, AND CAMERA DEVICE COMPRISING SAME

(71) Applicant: LG INNOTEK CO., LTD., Seoul (KR)

(72) Inventors: Hyun Joong LEE, Seoul (KR); Jun Taek LEE, Seoul (KR)

(21) Appl. No.: 18/722,951

(22) PCT Filed: Dec. 27, 2022
(86) PCT No.: PCT/KR2022/021341

§ 371 Date: Jun. 21, 2024

(30) Foreign Application Priority Data
Dec. 27, 2021 (KR) 10-2021-0188724
Dec. 27, 2021 (KR) 10-2021-0188725
Dec. 27, 2021 (KR) 10-2021-0188726

(51) Int. Cl. G03B 13/36; G03B 5/02

(52) U.S. Cl. CPC G03B 13/36; G03B 5/02; G03B 2205/0046; G03B 2205/0069

(57) ABSTRACT

Embodiments of the present disclosure disclose a camera device including a housing, a first bobbin configured to move in an optical axis direction with respect to the housing, and a first driving unit configured to move the first bobbin, wherein the first driving unit includes a first coil and a first magnet facing the first coil, the camera device includes a first yoke which is coupled to the first bobbin and on which the first magnet is disposed, the first yoke includes a bottom portion and a side plate portion disposed on a side surface of the bottom portion, and the first magnet is surrounded by the bottom portion and the side plate portion.

### CROSS-REFERENCE TO RELATED PATENT APPLICATIONS

This application is a U.S. National Stage Application under 35 U.S.C. § 371 of PCT Application No. PCT/KR2022/021341, filed Dec. 27, 2022, which claims priority to Korean Patent Application Nos. 10-2021-0188724, 10-2021-0188725 and 10-2021-0188726, all filed Dec. 27, 2021, whose entire disclosures are hereby incorporated by reference.

### TECHNICAL FIELD

The present disclosure relates to a camera actuator, a lens transfer device, and a camera device including the same.

### BACKGROUND ART

A camera is a device for taking pictures or videos of subjects and is mounted on portable devices, drones, vehicles, or the like. A camera module may have an image stabilization (IS) function of correcting or preventing the image shake caused by the movement of a user in order to improve the quality of the image, an auto focusing (AF) function of aligning a focal length of a lens by automatically adjusting an interval between an image sensor and the lens, and a zooming function of taking a picture of a remote subject after increasing or decreasing the magnification of the remote subject through a zoom lens.

Meanwhile, a pixel density of the image sensor increases as a resolution of the camera increases, and thus a size of the pixel becomes smaller, and as the pixel becomes smaller, the amount of light received for the same time decreases. Therefore, as the camera has a higher pixel density, the image shake caused by hand shaking due to a shutter speed decreased in a dark environment may more severely occur. As a representative IS technique, there is an optical image stabilizer (OIS) technique of correcting motion by changing a path of light.

According to the general OIS technique, the motion of the camera may be detected through a gyro sensor or the like, and a lens may tilt or move, or a camera module including a lens and an image sensor may tilt or move based on the detected motion. When the lens or the camera module including the lens and the image sensor tilts or moves for an OIS, it is necessary to additionally secure a space for tilting or moving around the lens or the camera module.

Meanwhile, an actuator for an OIS may be disposed around the lens. In this case, the actuator for an OIS may include actuators in charge of two axes (i.e., an X-axis and a Y-axis perpendicular to a Z-axis which is an optical axis) tilting.

However, according to the needs of ultra-slim and ultra-small camera devices, there is a large space constraint for arranging the actuator for an OIS, and it may be difficult to secure a sufficient space where the lens or the camera device including the lens and the image sensor itself may be tilted or moved for an OIS. In addition, as the camera has a higher pixel density, it is preferable that a size of the lens be increased to increase the amount of received light, and there may be a limit to increasing the size of the lens due to a space occupied by the actuator for an OIS.

In addition, when a zooming function, an AF function, and an OIS function are all included in a camera device, there is also a problem that an OIS magnet and an AF or zoom magnet are disposed close to each other to cause magnetic field interference.

In addition, although camera actuators for AF and zoom in the camera device provide a long stroke to improve performance, there is a problem that magnetic field interference occurs between adjacent magnets and coils. In addition, there is a problem that a restoring force of the lens assembly is reduced due to the magnetic field interference, and Hall sensors also have a problem that it is difficult to perform accurate measurement due to the magnetic field.

In addition, there is a problem that the performance of the Hall sensor is degraded due to a magnetic force of the coil or the like in the camera device.

In addition, there may be a problem that the lens is shocked and broken by an impact as the assembly moves in a direction of the long stroke in the camera device.

### DISCLOSURE

### Technical Problem

Embodiments of the present disclosure are directed to providing a camera actuator and a camera device having a driving unit for providing a long stroke (long moving distance) when auto focusing (AF) and zooming functions are performed.

In addition, embodiments of the present disclosure are directed to providing a camera actuator and a camera device in which magnetic field interference between facing magnets, coils, and Hall sensors is minimized.

In addition, embodiments of the present disclosure are directed to providing a camera actuator and a camera device in which a long stroke is accurately implemented by reducing the influence of a magnetic field through a yoke.

In addition, embodiments of the present disclosure may implement a camera actuator and a camera device for increasing a moving distance of a lens assembly through the number of driving coils.

In addition, embodiments of the present disclosure may provide a camera actuator and a camera device for more accurately detecting an increased moving distance by improving positional linearity through connection of a plurality of Hall sensors.

In addition, embodiments of the present disclosure are directed to providing a camera actuator and a camera device in which a blocking member is disposed in a coil so that a Hall sensor disposed in the coil is not affected by a magnetic force generated by the coil.

In addition, embodiments of the present disclosure are directed to providing a camera actuator and a camera device, in which an impact between a lens assembly and a housing is reduced through a protrusion of a lens assembly so as to suppress damage to a lens group.

In addition, embodiments of the present disclosure are directed to providing a camera actuator and a camera device, in which an impact between a lens assembly and a housing is reduced through a protrusion of the housing so as to suppress damage to a lens group.

In addition, the embodiments of the present disclosure are directed to providing a camera actuator and a camera device, in which the straight movement of a lens assembly is facilitated through a protrusion.

An object of the embodiment is not limited thereto and will also include objects or effects which may be identified from the following descriptions or embodiments.

### Technical Solution

A camera device according to an embodiment of the present disclosure includes a housing, a first bobbin configured to move in an optical axis direction with respect to the housing, and a first driving unit configured to move the first bobbin, wherein the first driving unit includes a first coil and a first magnet facing the first coil,
a first yoke which is coupled to the first bobbin and on which the first magnet is disposed, the first yoke includes a bottom portion and a side plate portion disposed on a side surface of the bottom portion, and the first magnet is surrounded by the bottom portion and the side plate portion.

The side plate portion may include first side plate portions facing in the optical axis direction and second side plate portions facing in a vertical direction, and the first yoke may include a coupling portion extending from the bottom portion toward the first bobbin.

The second side plate portion may include a first sub-side plate portion and a second sub-side plate portion disposed to be spaced apart from each other in the optical axis direction.

The coupling portion may be disposed between the first sub-side plate portion and the second sub-side plate portion.

At least a portion of the coupling portion may overlap the first bobbin in the vertical direction.

The first sub-side plate portion and the second sub-side plate portion may have the same length in the optical axis direction.

A length of the coupling portion in the optical axis direction may be smaller than a length of the first sub-side plate portion or the second sub-side plate portion in the optical axis direction.

The bottom portion may include a yoke groove disposed in at least one of a space between the first sub-side plate portion and the coupling portion and a space between the second sub-side plate portion and the coupling portion.

The first yoke may include a yoke hole disposed in the bottom portion, and the yoke hole may be disposed on a first virtual line that bisects the first yoke in a vertical direction.

The coupling portion may be disposed on a virtual line that bisects the first yoke in the optical axis direction.

The first sub-side plate portion and the second sub-side plate portion may have different lengths in the optical axis direction.

The coupling portion may not be disposed on a second virtual line, and the second virtual line may be a line that bisects the first yoke in the optical axis direction.

The coupling portion may be provided as a plurality of coupling portions that do not overlap each other in a vertical direction.

A length of the second side plate portion in a horizontal direction may be smaller than or equal to a length of the first magnet in the horizontal direction.

An outer surface of the first magnet may be disposed outside the second side plate portion.

The first coil may include a first sub-coil and a second sub-coil disposed to overlap each other in the optical axis direction, and a maximum length of the first sub-coil in the optical axis direction may be greater than a length of the first magnet in the optical axis direction.

A length of the first magnet in the optical axis direction may be greater than a maximum moving distance of the first bobbin.

The camera device may include a second bobbin configured to move in the optical axis direction and a second driving unit configured to move the second bobbin, wherein the second driving unit may include a second coil and a second magnet facing the second coil, and the second coil may include a third sub-coil and a fourth sub-coil disposed to overlap each other in the optical axis direction.

The camera device may include an image sensor, wherein the second bobbin may be disposed closer to the image sensor than the first bobbin is, and a moving distance of the second bobbin in the optical axis direction may be greater than a moving distance of the first bobbin in the optical axis direction.

A camera device according to an embodiment includes a housing, a first bobbin and a second bobbin configured to move in an optical axis direction with respect to the housing, a first driving unit including a first magnet configured to move the first bobbin, and a second driving unit including a second magnet configured to move the second bobbin, wherein the first magnet and the second magnet may be positioned at sides opposite to each other, and the camera device includes a yoke on which any one of the first magnet and the second magnet is disposed.

The yoke may include a bottom portion and a side plate portion disposed on a side surface of the bottom portion, and any one of the first magnet and the second magnet may be surrounded by the bottom portion and the side plate portion.

The housing may include a housing opening disposed in an upper surface thereof, and the first bobbin and the second bobbin may be at least partially exposed through the housing opening.

The camera device may further include a housing yoke disposed outside the housing opening on at least one of the upper surface and lower surface of the housing, wherein the housing yoke may include at least one of a first housing yoke positioned above the first magnet and a second housing yoke positioned above the second magnet.

The first driving unit may include a first coil facing the first magnet, the second driving unit may include a second coil facing the second magnet, and at least a portion of the first housing yoke may overlap the first coil and the first magnet in the vertical direction.

A portion of the first housing yoke may not overlap the first magnet in the vertical direction according to the movement of the first magnet.

A camera device according to an embodiment of the present disclosure includes a housing, a first lens assembly configured to move in an optical axis direction with respect to the housing, and a first driving unit configured to move the first lens assembly, wherein the first driving unit includes a first coil and a first magnet facing the first coil, and a first Hall sensor disposed in the first coil and a first blocking member disposed between an inner surface of the first coil and the first Hall sensor.

The first coil may include a first sub-coil and a second sub-coil disposed to overlap each other in the optical axis direction, and the first Hall sensor may be disposed in the first sub-coil.

The first blocking member may be disposed on an inner surface of the first sub-coil.

The first blocking member may have a thickness smaller than a thickness of the first sub-coil.

A separation distance between the first blocking member and the first magnet may be smaller than a thickness of the first magnet.

An inner end of the first sub-coil may be disposed closer to the first magnet than an inner end of the first blocking member is.

The camera device may include a first yoke coupled to the first magnet and the first lens assembly, wherein the first yoke and the first blocking member may at least partially overlap each other in a horizontal direction in at least some sections while the first yoke moves.

The first yoke and the first blocking member may be disposed to be spaced apart from each other in the horizontal direction.

The camera device may further include a second lens assembly configured to move in the optical axis direction and a second driving unit configured to move the second lens assembly, wherein the second driving unit may include a second coil and a second magnet facing the second coil, and the second coil may include a third sub-coil and a fourth sub-coil disposed to overlap each other in the optical axis direction.

The third sub-coil of the second coil may be disposed to correspond to the first sub-coil with respect to an optical axis, and the fourth sub-coil of the second coil may be disposed to correspond to the second sub-coil with respect to the optical axis.

The camera device may include a second Hall sensor disposed in the fourth sub-coil and a second blocking member disposed on an inner surface of the fourth sub-coil and formed of a magnetic material.

The second blocking member may have a thickness smaller than a thickness of the fourth sub-coil.

An inner end of the fourth sub-coil may be disposed closer to the second magnet than an inner end of the second blocking member is.

The first Hall sensor and the second Hall sensor may not overlap each other in the horizontal direction.

The camera device may include a second yoke coupled to the second magnet and the second lens assembly, wherein the second yoke and the second blocking member may at least partially overlap in the horizontal direction in at least some sections while the second yoke moves.

The first blocking member and the second blocking member may not overlap each other in the horizontal direction.

The first blocking member may be formed of a magnetic material.

A camera device according to an embodiment of the present disclosure includes a housing, a first lens assembly configured to move in an optical axis direction with respect to the housing, and a first driving unit configured to move the first lens assembly, wherein the first driving unit includes a first driving coil and a first driving magnet facing the first driving coil, and any one of the first lens assembly and the housing includes a protrusion protruding toward the other.

The housing may include a housing opening disposed in an upper surface thereof, and at least a portion of the first lens assembly may be exposed through the housing opening.

The protrusion may not overlap the housing opening in a vertical direction.

The protrusion may extend in the vertical direction.

The protrusion may be disposed on a first side surface of the first lens assembly and a second side surface that is a surface opposite to the first side surface.

The first lens assembly may include a first assembly region in a front portion thereof and a second assembly region in a rear portion thereof, and the protrusion may be disposed in the first assembly region. a lens group disposed in the first lens assembly, wherein the lens group may include at least one lens, and the at least one lens may be made of glass.

The at least one lens may be disposed on a foremost end of the first lens assembly.

The protrusion may include a first protrusion disposed on the first side surface of the first lens assembly and a second protrusion disposed on the second side surface of the first lens assembly, wherein the first protrusion and the second protrusion may at least partially overlap each other in the vertical direction.

Any one may be a housing, and a length of the protrusion in the optical axis direction may be greater than a length of the first lens assembly in the optical axis direction.

The camera device may include a second lens assembly configured to move in the optical axis direction and a second driving unit configured to move the second lens assembly, wherein the second driving unit may include a second driving coil and a second driving magnet facing the second driving coil, and the second driving coil may include a third sub-coil and a fourth sub coil disposed to overlap each other in the optical axis direction.

At least a portion of the protrusion may overlap the second lens assembly in the vertical direction.

The camera device may include an image sensor, wherein the second lens assembly may be disposed closer to the image sensor than the first lens assembly is, and a moving distance of the second lens assembly in the optical axis direction may be greater than a moving distance of the first lens assembly in the optical axis direction.

### Advantageous Effects

According to the present disclosure, it is possible to implement a camera actuator and a camera device, which have a driving unit for providing a long stroke (long moving distance) upon AF or zooming.

In addition, according to the present disclosure, it is possible to implement a camera actuator and a camera device in which magnetic field interference between facing magnets, coils, and Hall sensors is minimized.

In addition, according to the present disclosure, it is possible to implement a camera actuator and a camera device in which a long stroke is accurately implemented by reducing the influence of a magnetic field through a yoke.

It is possible to implement a camera actuator and a camera device for increasing a moving distance of a lens assembly through the number of driving coils.

In addition, according to the present disclosure, it is possible to implement a camera actuator and a camera device in which a blocking member is disposed in a coil so that a Hall sensor disposed in the coil is not affected by a magnetic force generated by the coil.

In addition, according to the present disclosure, it is possible to implement a camera actuator and a camera device, in which an impact between a lens assembly and a housing can be reduced through a protrusion of the lens assembly, thereby suppressing damage to a lens group.

In addition, according to the present disclosure, it is possible to implement a camera actuator and a camera device, in which an impact between a lens assembly and a housing can be reduced through a protrusion of the housing so as to suppress damage to a lens group.

In addition, according to the present disclosure, it is possible to implement a camera actuator and a camera device, in which the straight movement of a lens assembly is facilitated through a protrusion.

According to the present disclosure, it is possible to implement a camera actuator and a camera device applicable to ultra-slim, ultra-small, and high-resolution cameras.

In addition, according to the present disclosure, it is possible to provide a camera actuator and a camera device, in which an increased moving distance can be more accurately detected by improving the positional linearity through the connection of a plurality of Hall sensors.

Various and beneficial advantages and effects of the present disclosure are not limited to the above-described contents and will be more easily understood in the above process of describing specific embodiments of the present disclosure.

### DESCRIPTION OF DRAWINGS

FIG. 1 is a perspective view of a camera device according to an embodiment;

FIG. 2 is an exploded perspective view of the camera device according to the embodiment;

FIG. 3 is a cross-sectional view along line A-A′ in FIG. 1;

FIG. 4 is an exploded perspective view of a first camera actuator according to an embodiment;

FIG. 5 is a perspective view of the first camera actuator according to the embodiment from which a first shield can and a board are removed;

FIG. 6A is a cross-sectional view along line B-B′ in FIG. 5;

FIG. 6B is a cross-sectional view along line C-C′ in FIG. 5;

FIG. 7A is an exploded perspective view of a first camera actuator according to another embodiment;

FIG. 7B is a cross-sectional view of the first camera actuator according to another embodiment;

FIG. 7C is another cross-sectional view of the first camera actuator according to another embodiment;

FIG. 8 is a perspective view of a second camera actuator according to an embodiment;

FIG. 9 is an exploded perspective view of the second camera actuator according to the embodiment;

FIG. 10A is a cross-sectional view along line D-D′ in FIG. 8;

FIG. 10B is a perspective view showing a first optical driving unit, a moving assembly, and first and second guide units in the second camera actuator according to the embodiment;

FIG. 10C is a view for describing the movement of a first lens assembly in the second camera actuator according to the embodiment;

FIG. 10D is a graph for describing a restoring force of a second lens assembly in the second camera actuator according to the embodiment;

FIG. 10E is a graph for describing a restoring force of a third lens assembly in the second camera actuator according to the embodiment;

FIG. 11A is an exploded perspective view related to the driving of the first lens assembly;

FIG. 11B is a perspective view of components coupled to each other in FIG. 11A;

FIG. 11C is a perspective view of a first yoke and a first magnet in FIG. 11B;

FIG. 11D is a top view of FIG. 11C;

FIG. 11E is a perspective view of the first yoke according to the embodiment;

FIG. 11F is a side view of the first yoke according to the embodiment;

FIG. 11G is a view of a first yoke according to a modified example;

FIG. 11H is a view of a first yoke according to another embodiment;

FIG. 11I is a view of a first yoke according to still another embodiment;

FIG. 11J is a view of a first yoke according to yet another embodiment;

FIG. 11K is a view of a first yoke according to yet another embodiment;

FIG. 11L is a view of a first yoke according to yet another embodiment;

FIG. 11M is a perspective view of a first blocking member, a first lens assembly, a first magnet, a first coil, and a first guide unit according to an embodiment;

FIG. 11N is a top view of FIG. 11M;

FIG. 11O is a cross-sectional view along line E-E′ in FIG. 11N;

FIG. 11P is a view of the first coil and the first blocking member according to the embodiment;

FIG. 12A is an exploded perspective view related to the driving of the second lens assembly;

FIG. 12B is a perspective view of components coupled to each other in FIG. 12A;

FIG. 12C is a perspective view of a second yoke and a second magnet in FIG. 12B;

FIG. 12D is a top view of FIG. 12C;

FIG. 12E is a perspective view of the second yoke according to the embodiment;

FIG. 12F is a perspective view of the first yoke and the second yoke according to the embodiment;

FIG. 12G is a perspective view of a second blocking member, a second lens assembly, the second magnet, a second coil, and a second guide unit according to the embodiment;

FIG. 12H is a top view of FIG. 12G;

FIG. 12I is a cross-sectional view along line F-F′ in FIG. 12H;

FIG. 12J is a view of the second coil and the second blocking member according to the embodiment;

FIG. 12K is a perspective view of the first coil, the second coil, a first Hall sensor unit, the first blocking member, and the second blocking member according to the embodiment;

FIG. 12L is a graph of an output of a Hall sensor adjacent to the second lens assembly when first and second blocking members are not present;

FIG. 12M is a graph of an output of the Hall sensor adjacent to the second lens assembly when the first and second blocking members are present;

FIG. 12N is a perspective view of a first coil, a second coil, a first Hall sensor unit, a first blocking member, and a second blocking member according to another embodiment;

FIG. 13 is a view showing the driving of the second camera actuator according to an embodiment;

FIG. 14 is a schematic diagram showing a circuit board according to an embodiment;

FIG. 15 is a perspective view of some components of the second camera actuator according to the embodiment;

FIG. 16 is a view showing a first optical driving coil, a first optical driving magnet, and a yoke according to an embodiment;

FIG. 17 is a view describing the movement of the first optical driving magnet by a second driving unit according to an embodiment;

FIG. 18A is a view showing the movement of the second and third lens assemblies according to the embodiment;

FIG. 18B is an exploded perspective view of a second housing and a housing yoke according to an embodiment;

FIG. 18C is a view of the second housing and the housing yoke according to the embodiment;

FIG. 18D is a view of a second housing and a housing yoke according to a modified example;

FIG. 19 is a perspective view of the first lens assembly, the second lens group, the second lens assembly, and a third lens group;

FIG. 20 is a view showing the second housing added to FIG. 19;

FIG. 21 is a view showing a bottom surface of FIG. 19;

FIG. 22 is a cross-sectional view along line E-E′ in FIG. 20;

FIG. 23 is a cross-sectional view along line F-F′ in FIG. 20;

FIG. 24 shows modified examples of elements in FIG. 19;

FIG. 25 is a view showing bottom surfaces of elements in FIG. 24;

FIG. 26 is a perspective view of the second housing according to the embodiment;

FIG. 27 is a perspective view in a different direction of FIG. 26;

FIG. 28 is a perspective view of a portable terminal to which the camera device according to the embodiment is applied; and

FIG. 29 is a perspective view of a vehicle to which the camera device according to the embodiment is applied.

### MODES OF THE INVENTION

Since the present disclosure may have various changes and various embodiments, specific embodiments are shown and described in the accompanying drawings. However, it should be understood that it is not intended to limit specific embodiments, and it should be understood to include all modifications, equivalents, and substitutes included in the spirit and scope of the present disclosure.

Terms including ordinal numbers such as second or first may be used to describe various components, but the components are not limited by the terms. The terms are used only for the purpose of distinguishing one component from another. For example, a second component may be referred to as a first component, and similarly, the first component may also be referred to as the second component without departing from the scope of the present disclosure. The term “and/or” includes a combination of a plurality of related listed items or any of the plurality of related listed items.

When a certain component is described as being “connected” or “coupled” to another component, it is understood that it may be directly connected or coupled to another component or other components may also be disposed therebetween. On the other hand, when a certain component is described as being “directly connected” or “directly coupled” to another component, it should be understood that other components are not disposed therebetween.

The terms used in the application are only used to describe specific embodiments and are not intended to limit the present disclosure. The singular expression includes the plural expression unless the context clearly dictates otherwise. In the application, it should be understood that terms such as “comprise” or “have” are intended to specify that a feature, a number, a step, an operation, a component, a part, or a combination thereof described in the specification is present, but do not preclude the possibility of the presence or addition of one or more other features, numbers, steps, operations, components, parts, or combinations thereof.

Unless defined otherwise, all terms used herein, including technical or scientific terms, have the same meaning as commonly understood by those of ordinary skill in the art to which the present disclosure pertains. Terms such as those defined in a commonly used dictionary should be construed as having a meaning consistent with the meaning in the context of the related art and should not be construed in an ideal or excessively formal meaning unless explicitly defined in the application.

Hereinafter, embodiments will be described in detail with reference to the accompanying drawings, and the same or corresponding components are given the same reference numerals regardless of the reference numerals, and overlapping descriptions thereof will be omitted.

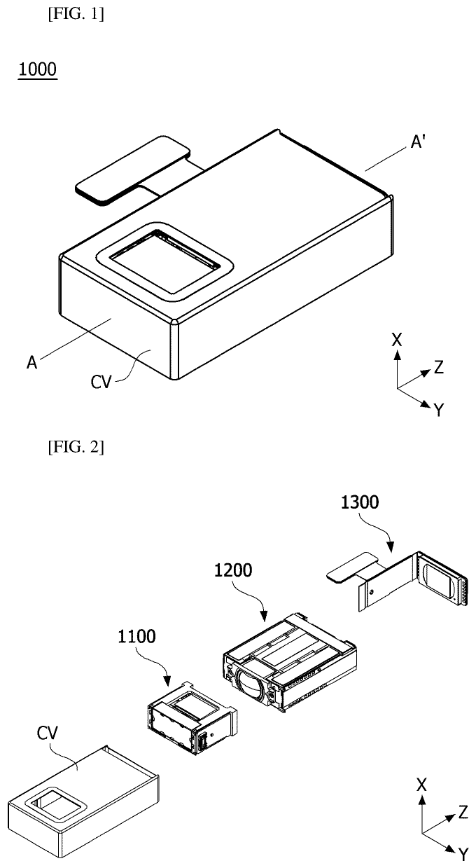

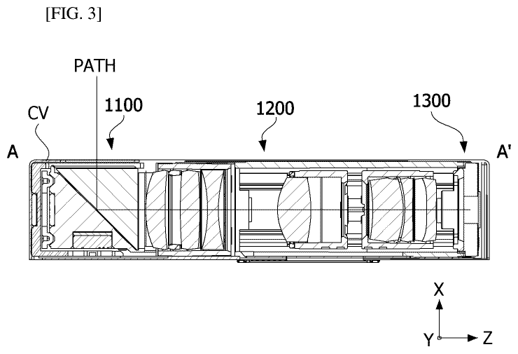

FIG. 1 is a perspective view of a camera device according to an embodiment, FIG. 2 is an exploded perspective view of the camera device according to the embodiment, and FIG. 3 is a cross-sectional view along line A-A′ in FIG. 1.

Referring to FIGS. 1 and 2, a camera device 1000 according to the embodiment may include a cover CV, a first camera actuator 1100, a second camera actuator 1200, and a circuit board 1300. Here, the first camera actuator 1100 may be used interchangeably with “first actuator,” and the second camera actuator 1200 may be used interchangeably with “second actuator.”

The cover CV may cover the first camera actuator 1100 and/or the second camera actuator 1200. It is possible to increase a coupling force between the first camera actuator 1100 and the second camera actuator 1200 by the cover CV.

Furthermore, the cover CV may be made of a material which blocks electromagnetic waves. Therefore, it is possible to easily protect the first camera actuator 1100 and the second camera actuator 1200 in the cover CV.

In addition, the first camera actuator 1100 may be an optical image stabilizer (OIS) actuator.

In the embodiment, the first camera actuator 1100 may change an optical path. In the embodiment, the first camera actuator 1100 may change the optical path vertically through an optical member (e.g., a prism or a mirror) therein. With this configuration, even when a thickness of a mobile terminal is decreased, a lens with a focal length that is greater than the thickness of the mobile terminal is disposed in the mobile terminal through a change in the optical path so that zooming, auto focusing (AF), and OIS functions may be performed.

The first camera actuator 1100 may change the optical path from a first direction to a third direction. In the specification, an optical axis direction corresponds to a proceeding direction of light provided to an image sensor in the third direction or a Z-axis direction.

Additionally, the first camera actuator 1100 may include a lens disposed in a predetermined barrel (not shown). In addition, the lens may include a fixed focal length lens. The fixed focal length lens may also be referred to as “single focal length lens” or “single lens.”

The second camera actuator 1200 may be disposed at a rear end of the first camera actuator 1100. The second camera actuator 1200 may be coupled to the first camera actuator 1100. In addition, mutual coupling may be performed by various methods.

In addition, the second camera actuator 1200 may be a zoom actuator or an AF actuator. For example, the second camera actuator 1200 may support one or more lenses and perform an AF function or a zooming function by moving the lenses according to a predetermined control signal of a control unit.

The circuit board 1300 may be disposed at a rear end of the second camera actuator 1200. The circuit board 1300 may be electrically connected to the second camera actuator 1200 and the first camera actuator 1100. In addition, a plurality of circuit boards 1300 may be provided.

The circuit board 1300 may be connected to a second housing of the second camera actuator 1200 and may have the image sensor. Furthermore, a base unit including a filter may be seated on the circuit board 1300. A description thereof will be given below.

A camera device according to the embodiment may include one or more camera devices. For example, the plurality of camera devices may include a first camera device and a second camera device. In addition, as described above, the camera device may be used interchangeably with “camera module,” “camera apparatus,” “imaging device,” “imaging module,” “imaging machine,” or the like. Furthermore, the camera actuator refers to a component for moving an optical member, a lens, or the like. Therefore, the camera actuator may or may not include the optical member, the lens, or the like. Hereinafter, description based on a camera actuator including a lens will be given. In addition, the camera actuator may be used interchangeably with “lens moving device,” “lens transfer device,” “optical member moving device,” “zoom lens transfer device,” or the like. Therefore, the first camera actuator may be used interchangeably with “first lens transfer device,” and the second camera actuator may be used interchangeably with “second lens transfer device.” Furthermore, an actuator will be described as being a device for moving an optical member such as a lens, but in the specification, will be described as being the device including the lens.

In addition, the camera device may include one or more actuators. For example, the camera device may include the first camera actuator 1100 and the second camera actuator 1200.

In addition, the camera device may include an actuator (not shown) disposed in a predetermined housing (not shown) and drive a lens unit. The actuator may be a voice coil motor, a micro actuator, a silicone actuator, and the like and applied in various methods such as an electrostatic method, a thermal method, a bimorph method, and an electrostatic force method, but the present disclosure is not limited thereto. In addition, in the specification, a camera actuator may be referred to as an “actuator” or the like. In addition, a camera device provided as a plurality of camera devices may be mounted in various electronic devices such as mobile terminals.

Referring to FIG. 3, the camera device according to the embodiment may include the first camera actuator 1100 for performing an OIS function and the second camera actuator 1200 for performing a zooming function and an AF function.

Light may enter the camera device through an opening region positioned in an upper surface of the first camera actuator 1100. In other words, the light may enter the first camera actuator 1100 in an optical axis direction (e.g., an X-axis direction). In addition, the optical path may be changed from the first direction to the third direction (e.g., a Z-axis direction) through the optical member. In addition, the light may pass through the second camera actuator 1200 and may be incident on an image sensor IS positioned at one end of the second camera actuator 1200 (PATH).

In the specification, the bottom surface refers to one side in a first direction. In addition, the first direction is the X-axis direction in the drawings and may be used interchangeably with a second axis direction or the like. A second direction is a Y-axis direction in the drawings and may be used interchangeably with a first axis direction or the like. The second direction is a direction perpendicular to the first direction. In addition, a third direction is the Z-axis direction in the drawings and may be used interchangeably with a third axis direction or the like. In addition, the third direction is perpendicular to both the first direction and the second direction. Here, the third direction (Z-axis direction) corresponds to the optical axis direction, and the first direction (X-axis direction) and the second direction (Y-axis direction) are directions perpendicular to the optical axis and may be tilted by the second camera actuator. A detailed description thereof will be given below. In addition, hereinafter, the optical axis direction corresponds to the optical path and is the third direction (Z-axis direction) in the description of the first and second camera actuators and will be described below based on this. In addition, the second direction may be referred to as “horizontal direction.” In addition, the first direction may be referred to as “vertical direction.”

In addition, with this configuration, the camera device according to the embodiment may reduce the spatial limitations of the first camera actuator and the second camera actuator by changing the optical path. In other words, the camera device according to the embodiment may extend the optical path while minimizing the thickness of the camera device in response to the change in the optical path. Furthermore, it should be understood that the second camera actuator may provide a high magnification by controlling a focus or the like in the extended optical path.

In addition, the camera device according to the embodiment may implement an OIS by controlling the optical path through the first camera actuator, thereby minimizing the occurrence of a decentering or tilting phenomenon and providing the best optical characteristics.

Furthermore, the second camera actuator 1200 may include an optical system and a lens driving unit. For example, at least one of a first lens assembly, a second lens assembly, a third lens assembly, and a guide pin may be disposed in the second camera actuator 1200.

In addition, the second camera actuator 1200 may include a coil and a magnet and perform a high-magnification zooming function.

For example, the first lens assembly and the second lens assembly may be moving lenses that each move through the coil, the magnet, and a guide pin, and the third lens assembly may be a fixed lens, but the present disclosure is not limited thereto. For example, the third lens assembly may perform a function of a focator by which light forms an image at a specific position, and the first lens assembly may perform a function of a variator for re-forming an image formed by the third lens assembly, which is the focator, at another position. Meanwhile, the first lens assembly may be in a state in which a magnification change is large because a distance to a subject or an image distance is greatly changed, and the first lens assembly, which is the variator, may play an important role in a focal length or magnification change of the optical system. Meanwhile, imaging points of an image formed by the first lens assembly, which is the variator, may be slightly different depending on a position. Therefore, the second lens assembly may perform a position compensation function for the image formed by the variator. For example, the second lens assembly may perform a function of a compensator for accurately forming an image at an actual position of the image sensor using the imaging points of the image formed by the first lens assembly which is the variator. For example, the first lens assembly and the second lens assembly may be driven by an electromagnetic force generated by the interaction between the coil and the magnet. The above description may be applied to a lens assembly to be described below.

Meanwhile, when the OIS actuator and the AF actuator or the zoom actuator are disposed according to the embodiment of the present disclosure, the magnetic field interference with an AF magnet or a zoom magnet can be prevented when an OIS is driven. Since a second optical driving magnet of the first camera actuator 1100 is disposed separately from the second camera actuator 1200, the magnetic field interference between the first camera actuator 1100 and the second camera actuator 1200 can be prevented. In the specification, an OIS may be used interchangeably with terms such as hand shaking correction, optical image stabilization, optical image correction, shake correction, or the like.

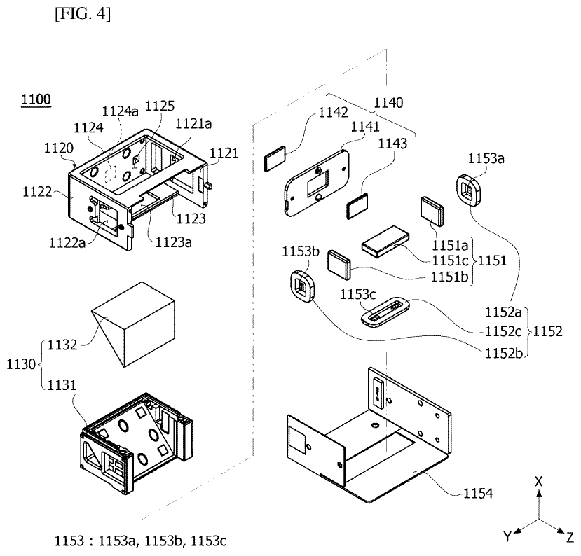

FIG. 4 is an exploded perspective view of the first camera actuator according to the embodiment.

Referring to FIG. 4, the first camera actuator 1100 according to the embodiment includes a first shield can (not shown), a first housing 1120, a mover 1130, a rotational unit 1140, and a second optical driving unit 1150.

The mover 1130 may include a holder 1131 and an optical member 1132 seated on the holder 1131. In addition, the rotational unit 1140 includes a tilting guide unit 1141, a first magnetic part 1142 having a coupling force with the tilting guide unit 1141, and a second magnetic part 1143 positioned in the tilting guide unit 1141. In addition, the second optical driving unit 1150 includes a second optical driving magnet 1151, a second optical driving coil 1152, a second Hall sensor unit 1153, and a first board unit 1154.

The first shield can (not shown) may be positioned at an outermost side of the first camera actuator 1100 and positioned to surround the rotational unit 1140 and the second optical driving unit 1150, which will be described below.

The first shield can (not shown) may block or reduce the influence of electromagnetic waves generated from the outside. Therefore, it is possible to decrease the number of occurrences of malfunction of the rotational unit 1140 or the second optical driving unit 1150.

The first housing 1120 may be positioned in the first shield can (not shown). In addition, the first housing 1120 may be positioned inside the first board unit 1154 to be described below. The first housing 1120 may be fastened to the first shield can (not shown) by being fitted into or engaged with the first shield can.

The first housing 1120 may be formed of a plurality of housing side portions. The first housing 1120 may include a first housing side portion 1121, a second housing side portion 1122, a third housing side portion 1123, and a fourth housing side portion 1124.

The first housing side portion 1121 and the second housing side portion 1122 may be disposed to face each other. In addition, the third housing side portion 1123 and the fourth housing side portion 1124 may be disposed between the first housing side portion 1121 and the second housing side portion 1122.

The third housing side portion 1123 may be in contact with the first housing side portion 1121, the second housing side portion 1122, and the fourth housing side portion 1124. In addition, the third housing side portion 1123 may be a lower portion of the first housing 1120 and may be a bottom surface.

In addition, the first housing side portion 1121 may include a first housing hole 1121a. A third coil 1152a to be described below may be positioned in the first housing hole 1121a.

In addition, the second housing side portion 1122 may include a second housing hole 1122a. In addition, a fourth coil 1152b to be described below may be positioned in the second housing hole 1122a.

The third coil 1152a and the fourth coil 1152b may be coupled to the first board unit 1154. In an embodiment, the third coil 1152a and the fourth coil 1152b may be electrically connected to the first board unit 1154 so that a current may flow therethrough. The current is an element of an electromagnetic force by which the first camera actuator may tilt with respect to an X-axis.

In addition, the third housing side portion 1123 may include a third housing hole 1123a. A fifth coil 1152c to be described below may be positioned in the third housing hole 1123a. The fifth coil 1152c may be coupled to the first board unit 1154. Further, the fifth coil 1152c may be electrically connected to the first board unit 1154 so that a current may flow therethrough. The current is an element of the electromagnetic force by which the first camera actuator may tilt with respect to a Y-axis.

The fourth housing side portion 1124 may include a first housing groove 1124a. The first magnetic part 1142 to be described below may be disposed in a region facing the first housing groove 1124a. Therefore, the first housing 1120 may be coupled to the tilting guide unit 1141 by a magnetic force or the like.

In addition, the first housing groove 1124a according to the embodiment may be positioned on an inner surface or an outer surface of the fourth housing side portion 1124. Therefore, the first magnetic part 1142 may also be disposed to correspond to a position of the first housing groove 1124a.

In addition, the first housing 1120 may include an accommodating portion 1125 formed by the first to fourth housing side portions 1121 to 1224. The mover 1130 may be positioned in the accommodating portion 1125.

The mover 1130 includes the holder 1131 and the optical member 1132 seated on the holder 1131.

The holder 1131 may be seated in the accommodating portion 1125 of the first housing 1120. The holder 1131 may include a first prism outer surface to a fourth prism outer surface respectively corresponding to the first housing side portion 1121, the second housing side portion 1122, the third housing side portion 1123, and the fourth housing side portion 1124.

A seating groove in which the second magnetic part 1143 may be seated may be disposed on the fourth prism outer surface facing the fourth housing side portion 1124.

The optical member 1132 may be seated on the holder 1131. To this end, the holder 1131 may have a seating surface, and the seating surface may be formed by an accommodating groove. The optical member 1132 may include a reflector disposed therein. However, the present disclosure is not limited thereto. In addition, the optical member 1132 may reflect light reflected from the outside (e.g., an object) into the camera device. In other words, the optical member 1132 can reduce spatial limitations of the first camera actuator and the second camera actuator by changing the path of the reflected light. As described above, it should be understood that the camera device may also provide a high magnification by extending an optical path while minimizing a thickness thereof.

The rotational unit 1140 includes the tilting guide unit 1141, the first magnetic part 1142 having a coupling force with the tilting guide unit 1141, and the second magnetic part 1143 positioned on the tilting guide unit 1141.

The tilting guide unit 1141 may be coupled to the mover 1130 and the first housing 1120. The tilting guide unit 1141 may include an additional magnetic part (not shown) positioned therein.

In addition, the tilting guide unit 1141 may be disposed adjacent to the optical axis. Therefore, the actuator according to the embodiment may easily change the optical path according to first axis tilting and second axis tilting, which will be described below.

The tilting guide unit 1141 may include first protrusions disposed to be spaced apart from each other in a first direction (X-axis direction) and second protrusions disposed to be spaced apart from each other in a second direction (Y-axis direction). In addition, the first protrusion and the second protrusion may protrude in opposite directions. A description thereof will be given below.

In addition, the first magnetic part 1142 may include a plurality of yokes, and the plurality of yokes may be positioned to face each other with respect to the tilting guide unit 1141. In an embodiment, the first magnetic part 1142 may include a plurality of facing yokes. In addition, the tilting guide unit 1141 may be positioned between the plurality of yokes.

As described above, the first magnetic part 1142 may be positioned in the first housing 1120. In addition, as described above, the first magnetic part 1142 may be seated on the inner or outer surface of the fourth housing side portion 1124. For example, the first magnetic part 1142 may be seated in a groove formed on the outer surface of the fourth housing side portion 1124. Alternatively, the first magnetic part 1142 may be seated in the first housing groove 1124a.

In addition, the second magnetic part 1143 may be positioned on the mover 1130, particularly, an outer surface of the holder 1131. With this configuration, the tilting guide unit 1141 may be easily coupled to the first housing 1120 and the mover 1130 by a coupling force generated by a magnetic force between the second magnetic part 1143 and the first magnetic part 1142 therein. In the present disclosure, positions of the first magnetic part 1142 and the second magnetic part 1143 may be changed.

The second optical driving unit 1150 includes the second optical driving magnet 1151, the second optical driving coil 1152, the second Hall sensor unit 1153, and the first board unit 1154.

The second optical driving magnet 1151 may include a plurality of magnets. In an embodiment, the second optical driving magnet 1151 may include a third magnet 1151a, a fourth magnet 1151b, and a fifth magnet 1151c.

Each of the third magnet 1151a, the fourth magnet 1151b, and the fifth magnet 1151c may be positioned on the outer surface of the holder 1131. In addition, the third magnet 1151a and the fourth magnet 1151b may be positioned to face each other. In addition, the fifth magnet 1151c may be positioned on a bottom surface of the outer surface of the holder 1131. A description thereof will be given below.

The second optical driving coil 1152 may include a plurality of coils. In an embodiment, the second optical driving coil 1152 may include the third coil 1152a, the fourth coil 1152b, and the fifth coil 1152c.

The third coil 1152a may be positioned to face the third magnet 1151a. Therefore, the third coil 1152a may be positioned in the first housing hole 1121a of the first housing side portion 1121 as described above.

In addition, the fourth coil 1152b may be positioned to face the fourth magnet 1151b. Therefore, the fourth coil 1152b may be positioned in the second housing hole 1122a of the second housing side portion 1122 as described above.

The third coil 1152a may be positioned to face the fourth coil 1152b. In other words, the third coil 1152a may be positioned to be symmetrical to the fourth coil 1152b with respect to the first direction (X-axis direction) or the third direction (Z-axis direction). This may also be applied to the third magnet 1151a and the fourth magnet 1151b in the same manner. In other words, the third magnet 1151a and the fourth magnet 1151b may be positioned symmetrically with respect to the first direction (X-axis direction) or the third direction (Z-axis direction). In addition, the third coil 1152a, the fourth coil 1152b, the third magnet 1151a, and the fourth magnet 1151b may be disposed to overlap at least partially in the second direction (Y-axis direction). With this configuration, X-axis tilting may be accurately performed without inclination to one side by an electromagnetic force between the third coil 1152a and the third magnet 1151a and an electromagnetic force between the fourth coil 1152b and the fourth magnet 1151b.

The fifth coil 1152c may be positioned to face the fifth magnet 1151c. Therefore, the fifth coil 1152c may be positioned in the third housing hole 1123a of the third housing side portion 1123 as described above. The fifth coil 1152c generates an electromagnetic force with the fifth magnet 1151c so that the mover 1130 and the rotational unit 1140 may perform Y axis tilting with respect to the first housing 1120.

Here, the X-axis tilting refers to tilting based on the X-axis, and the Y-axis tilting refers to tilting based on the Y-axis.

The second Hall sensor unit 1153 may include a plurality of Hall sensors. The Hall sensor corresponds to “sensor unit” described below and is used interchangeably therewith. In an embodiment, the second Hall sensor unit 1153 may include a third Hall sensor 1153a, a fourth Hall sensor 1153b, and a fifth Hall sensor 1153c.

The third Hall sensor 1153a may be positioned inside the third coil 1152a. The fourth Hall sensor 1153b may be disposed to be symmetrical with the third Hall sensor 1153a with respect to the first direction (X-axis direction) and the third direction (Z-axis direction). In addition, the fourth Hall sensor 1153b may be positioned inside the fourth coil 1152b.

The third Hall sensor 1153a may detect a change in magnetic flux inside the third coil 1152a. In addition, the fourth Hall sensor 1153b may detect a change in magnetic flux in the fourth coil 1152b. Therefore, positions between the third and fourth magnets 1151a and 1151b and the third and fourth Hall sensors 1153a and 1153b may be sensed. For example, the first camera actuator according to the embodiment may more accurately control X-axis tilting by detecting the position through the third and fourth Hall sensors 1153a and 1153b.

In addition, the fifth Hall sensor 1153c may be positioned inside the fifth coil 1152c. The fifth Hall sensor 1153c may detect a change in magnetic flux inside the fifth coil 1152c. Therefore, position sensing between the fifth magnet 1151c and the third Hall sensor 1153bc may be performed. Therefore, the first camera actuator according to the embodiment may control Y-axis tilting. One or more third to fifth Hall sensors may be provided.

The first board unit 1154 may be positioned on a lower portion of the second optical driving unit 1150. The first board unit 1154 may be electrically connected to the second optical driving coil 1152 and the second Hall sensor unit 1153. For example, the first board unit 1154 may be coupled to the second optical driving coil 1152 and the second Hall sensor unit 1153 through a surface mounting technology (SMT). However, the present disclosure is not limited to this method.

The first board unit 1154 may be positioned between the first shield can (not shown) and the first housing 1120 and coupled to the first shield can and the first housing 1120. The coupling method may be variously performed as described above. In addition, through the coupling, the second optical driving coil 1152 and the second Hall sensor unit 1153 may be positioned within an outer surface of the first housing 1120.

The first board unit 1154 includes a circuit board having line patterns that may be electrically connected, such as a rigid printed circuit board (RPCB), a flexible PCB (FPCB), and a rigid flexible PCB (RFPCB). However, the present disclosure is not limited to these types.

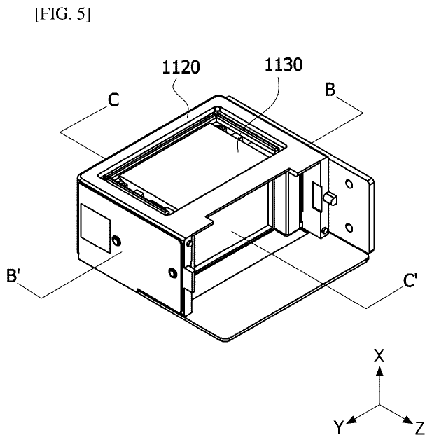

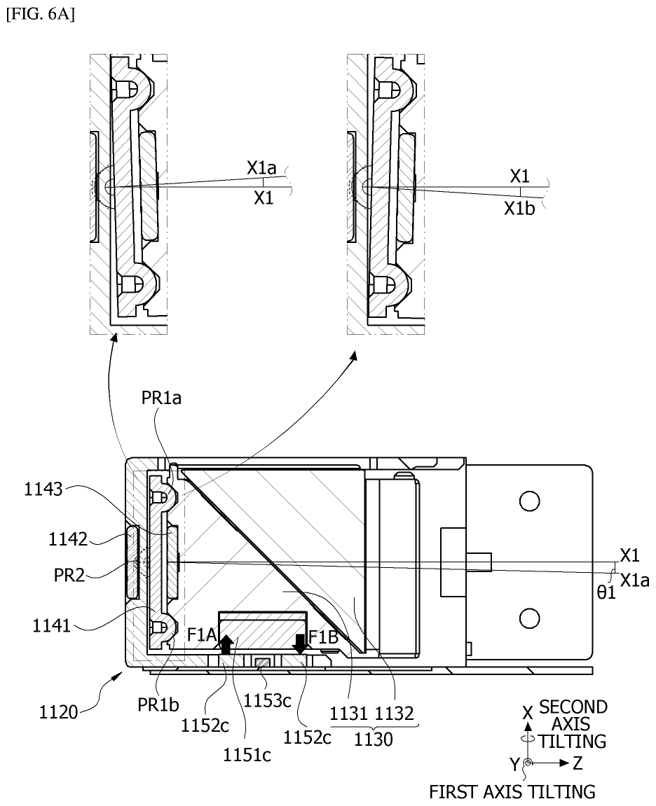

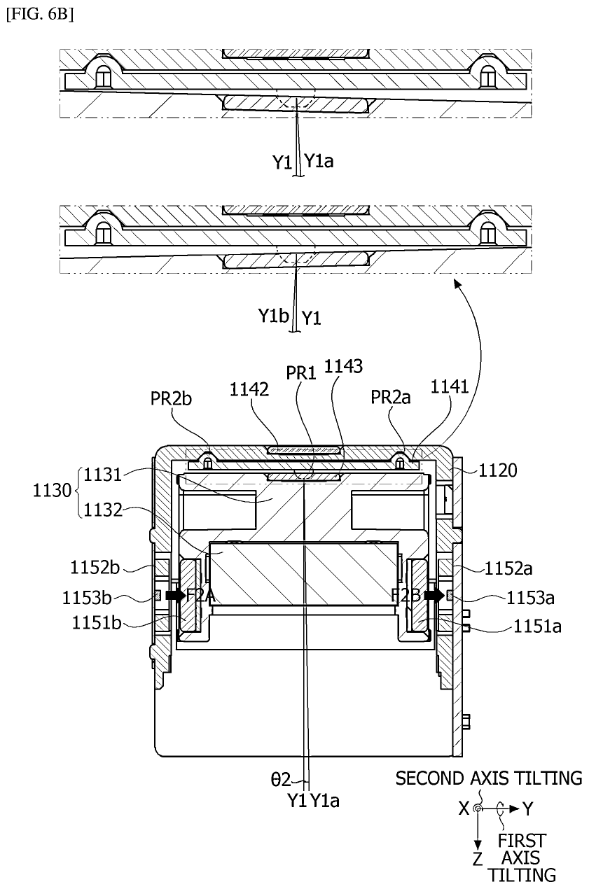

FIG. 5 is a perspective view of the first camera actuator according to the embodiment from which a first shield can and a board are removed, FIG. 6A is a cross-sectional view along line B-B′ in FIG. 5, and FIG. 6B is a cross-sectional view along line C-C′ in FIG. 5.

FIG. 5 is a perspective view of the first camera actuator according to the embodiment from which a shield can and a board are removed, FIG. 6A is a cross-sectional view along line B-B′ in FIG. 5, and FIG. 6B is a cross-sectional view along line C-C′ in FIG. 5.

Referring to FIGS. 5 to 6B, the third coil 1152a may be positioned on the first housing side portion 1121.

In addition, the third coil 1152a and the third magnet 1151a may be positioned to face each other. At least a portion of the third magnet 1151a may overlap the third coil 1152a in the second direction (Y-axis direction).

In addition, the fourth coil 1152b may be positioned on the second housing side portion 1122. Therefore, the fourth coil 1152b and the fourth magnet 1151b may be positioned to face each other. At least a portion of the fourth magnet 1151b may overlap the fourth coil 1152b in the second direction (Y-axis direction).

In addition, the third coil 1152a and the fourth coil 1152b may overlap in the second direction (Y-axis direction), and the third magnet 1151a and the fourth magnet 1151b may overlap in the second direction (Y-axis direction). With this configuration, an electromagnetic force applied to the outer surfaces of the holders (the first holder outer surface and the second holder outer surface) may be positioned on a parallel axis in the second direction (Y-axis direction), thereby accurately and precisely performing X-axis tilting.

In addition, a first accommodating groove (not shown) may be positioned in a fourth holder outer surface. In addition, first protrusions PR1a and PR1b may be disposed in the first accommodating groove. Therefore, when X-axis tilting is performed, the first protrusions PR1a and PR1b may be reference axes (or rotational axes) of the tilt. Therefore, the tilting guide unit 1141 and the mover 1130 may move in a left-right direction.

As described above, the second protrusion PR2 may be seated in the groove of an inner surface of the fourth housing side portion 1124. In addition, when Y-axis tilting is performed, the rotational plate and the mover may be rotated about the second protrusion PR2 that is a reference axis of the Y-axis tilt.

According to the embodiment, an OIS function may be performed by the first protrusion and the second protrusion.

Referring to FIG. 6A, Y-axis tilting may be performed. In other words, an OIS can be implemented by the rotation in the first direction (X-axis direction).

In an embodiment, the fifth magnet 1151c disposed under the holder 1131 may form an electromagnetic force with the fifth coil 1152c to tilt or rotate the mover 1130 in the first direction (X-axis direction).

Specifically, the tilting guide unit 1141 may be coupled to the first housing 1120 and the mover 1130 by the first magnetic part 1142 in the first housing 1120 and the second magnetic part 1143 in the mover 1130. In addition, the first protrusions PR1 may be spaced apart from each other in the first direction (X-axis direction) and supported by the first housing 1120.

In addition, the tilting guide unit 1141 may rotate or tilt based on the second protrusion PR2 protruding toward the mover 1130, which is the reference axis (or the rotational axis). In other words, the tilting guide unit 1141 may perform Y-axis tilting based on the second protrusion PR2 that is the reference axis.

For example, an OIS can be implemented by rotating (X1→X1a or X1b) the mover 130 at a first angle θ1 in the X-axis direction by first electromagnetic forces F1A and F1B between the fifth magnet 1151c disposed in the third seating groove and the fifth coil 1152c disposed on the third board side portion. The first angle θ1 may be in the range of ±1° to ±3°. However, the present disclosure is not limited thereto.

Hereinafter, in the first camera actuators according to various embodiments, the electromagnetic force may move the mover by generating a force in the described direction or move the mover in the described direction even when a force is generated in another direction. In other words, the described direction of the electromagnetic force refers to a direction of the force generated by the magnet and the coil to move the mover.

Referring to FIG. 6B, X-axis tilting may be performed. In other words, an OIS can be implemented by the rotation in the second direction (Y-axis direction).

The OIS can be implemented by tilting or rotating (or X-axis tilting) the mover 1130 in the Y-axis direction.

In an embodiment, the third magnet 1151a and the fourth magnet 1151b disposed on the holder 1131 generate electromagnetic forces with the third coil 1152a and the fourth coil 1152b, respectively, to tilt or rotate the tilting guide unit 1141 and the mover 1130 in the second direction (Y-axis direction).

The tilting guide unit 1141 may rotate or tilt (may perform X-axis tilting) based on the first protrusion PR1 that is a reference axis (or a rotational axis) in the second direction.

For example, the OIS can be implemented by rotating (Y1→Y1a or Y1b) the mover 1130 at a second angle θ2 in the Y-axis direction by second electromagnetic forces F2A and F2B between the third and fourth magnets 1151a and 1151b disposed in the first seating groove and the third and fourth coils 1152a and 1152b disposed on the first and second board side portions. The second angle θ2 may be in the range of ±1° to ±3°. However, the present disclosure is not limited thereto.

In addition, as described above, the electromagnetic force generated by the third and fourth magnets 1151a and 1151b and the third and fourth coils 1152a and 1152b may act in the third direction or in a direction opposite to the third direction. For example, the electromagnetic force may be generated from a left portion of the mover 1130 in the third direction (Z-axis direction) and may act from a right portion of the mover 1130 in the direction opposite to the third direction (Z-axis direction). Therefore, the mover 1130 may rotate with respect to the first direction. Alternatively, the mover 1130 may move along the second direction.

As described above, the second actuator according to the embodiment may control the tilting guide unit 1141 and the mover 1130 to be rotated in the first direction (X-axis direction) or the second direction (Y-axis direction) by the electromagnetic force between the second optical driving magnet in the holder and the second optical driving coil disposed in the housing, thereby minimizing the occurrence of a decentering or tilting phenomenon when implementing an OIS and providing the best optical characteristics. In addition, as described above, “Y-axis tilting” corresponds to the rotation or tilting in the first direction (X-axis direction), and “X-axis tilting” corresponds to the rotation or tilting in the second direction (Y-axis direction).

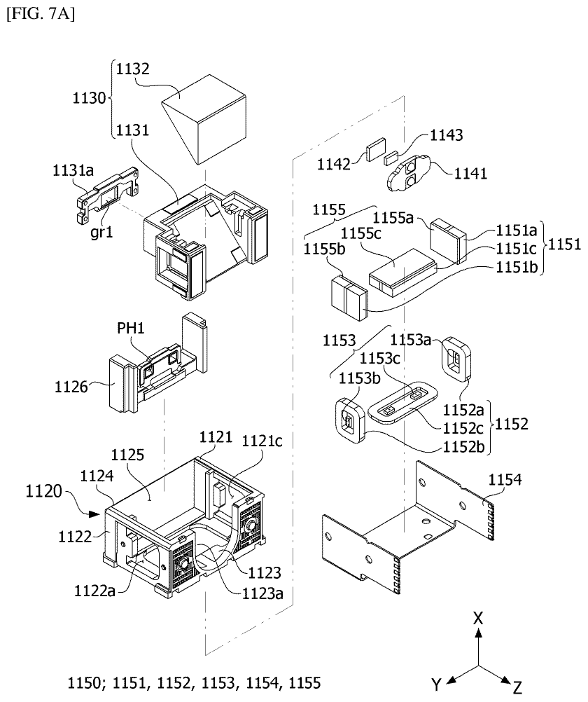

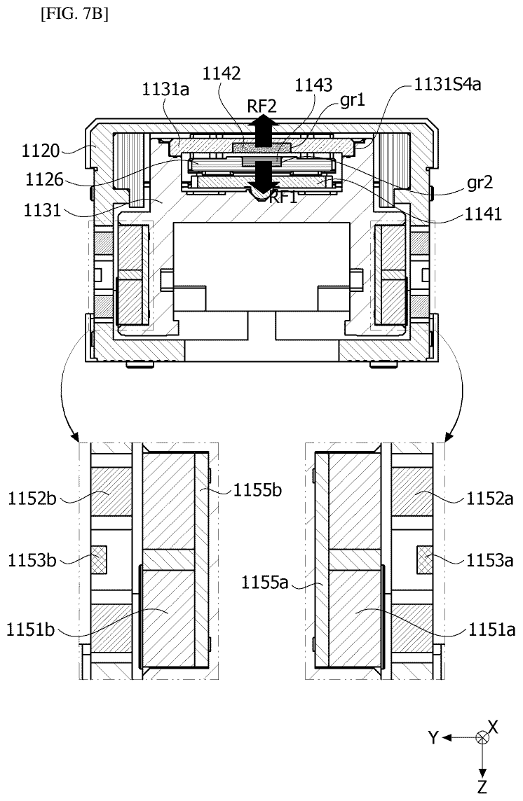

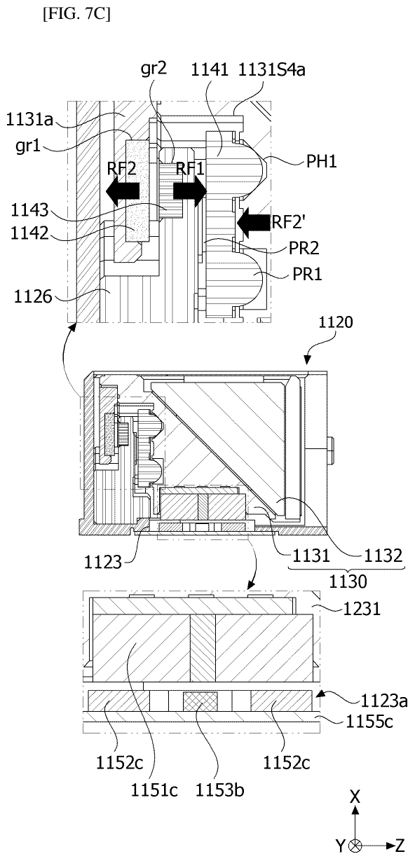

FIG. 7A is an exploded perspective view of a first camera actuator according to another embodiment, FIG. 7B is a cross-sectional view of the first camera actuator according to another embodiment, and FIG. 7C is another cross-sectional view of the first camera actuator according to another embodiment.

Referring to FIGS. 7A to 7C, a first camera actuator 1100 according to another embodiment includes a first housing 1120, the mover 1130, a rotational unit 1140, a second optical driving unit 1150, a first member 1126, and a second member 1131a.

The mover 1130 may include a holder 1131 and an optical member 1132 seated on the holder 1131. In addition, the mover 1130 may be disposed in the housing 1120. In addition, the rotational unit 1140 may include a tilting guide unit 1141, and a second magnetic part 1142 and a first magnetic part 1143 having different polarities to press the tilting guide unit 1141. The first magnetic part 1143 and the second magnetic part 1142 may have different sizes. In an embodiment, the first magnetic part 1143 may have a greater size than the second magnetic part 1142. For example, the first magnetic part 1143 and the second magnetic part 1142 may have the same length in the optical axis direction or the third direction (Z-axis direction) and have different areas in the first direction and the second direction. In this case, the area of the first magnetic part 1143 may be greater than the area of the second magnetic part 1142. In addition, the second optical driving unit 1150 includes a second optical driving magnet 1151, a second optical driving coil 1152, a Hall sensor unit 1153, a first board unit 1154, and a yoke unit 1155.

First, the first camera actuator 1100 may include a shield can (not shown). The shield can (not shown) may be positioned at an outermost side of the first camera actuator 1100 and positioned to surround the rotational unit 1140 and the second optical driving unit 1150, which will be described below.

The shield can (not shown) may block or reduce the influence of electromagnetic waves generated from the outside. In other words, the shield can (not shown) may reduce the number of occurrences of malfunction of the rotational unit 1140 or the second optical driving unit 1150.

The first housing 1120 may be positioned inside the shield can (not shown). When there is no shield can, the first housing 1120 may be positioned at the outermost side of the first camera actuator.

In addition, the first housing 1120 may be positioned inside the first board unit 1154 to be described below. The first housing 1120 may be fastened to the shield can (not shown) by being fitted into or engaged with the shield can.

The first housing 1120 may include a first housing side portion 1121, a second housing side portion 1122, a third housing side portion 1123, and a fourth housing side portion 1124. A description thereof will be given below.

The first member 1126 may be disposed in the first housing 1120. The first member 1126 may be disposed between the second member 1131a and the housing. The first member 1126 may be disposed in the housing or positioned on one side of the housing. A description thereof will be given below.

The mover 1130 includes the holder 1131 and the optical member 1132 seated on the holder 1131.

The holder 1131 may be seated in the accommodating portion 1125 of the first housing 1120. The holder 1131 may include a first holder outer surface to a fourth holder outer surface respectively corresponding to the first housing side portion 1121, the second housing side portion 1122, the third housing side portion 1123, and the first member 1126. For example, the first holder outer surface to the fourth holder outer surface may correspond to or face inner surfaces of the first housing side portion 1121, the second housing side portion 1122, the third housing side portion 1123, and the first member 1126, respectively.

In addition, the holder 1131 may include the second member 1131a disposed in a fourth seating groove. A description thereof will be given below.

The optical member 1132 may be seated on the holder 1131. To this end, the holder 1131 may have a seating surface, and the seating surface may be formed by an accommodating groove. In an embodiment, the optical member 1132 may be formed as a mirror or a prism. Hereinafter, although shown based on the prism, the optical member 1132 may be formed of a plurality of lenses as in the above-described embodiment. Alternatively, the optical member 1132 may include a plurality of lenses and prisms or mirrors. In addition, the optical member 1132 may include a reflector disposed therein. However, the present disclosure is not limited thereto.

In addition, the optical member 1132 may reflect light reflected from the outside (e.g., an object) into the camera module. In other words, the optical member 1132 may reduce spatial limitations of the first camera actuator and the second camera actuator by changing the path of the reflected light. As described above, it should be understood that the camera module may also provide a high magnification by extending the optical path while minimizing the thickness thereof.

Additionally, the second member 1131a may be coupled to the holder 1131. The second member 1131a may be disposed outside the holder 1131 and inside the housing. In addition, the second member 1131a may be seated in an additional groove positioned in an area of the fourth holder outer surface other than the fourth seating groove in the holder 1131. Therefore, the second member 1131a may be coupled to the holder 1131, and at least a portion of the first member 1126 may be positioned between the second member 1131a and the holder 1131. For example, at least a portion of the first member 1126 may pass through a space formed between the second member 1131a and the holder 1131.

In addition, the second member 1131a may be formed in a structure separated from the holder 1131. With this configuration, the first camera actuator can be easily assembled as will be described below. Alternatively, the second member 1131a may be formed integrally with the holder 1131, but a separated structure will be described below.

The rotational unit 1140 includes the tilting guide unit 1141, and the second magnetic part 1142 and the first magnetic part 1143 having different polarities to press the tilting guide unit 1141.

The tilting guide unit 1141 may be coupled to the mover 1130 and the first housing 1120. Specifically, the tilting guide unit 1141 may be disposed between the holder 1131 and the first member 1126. Therefore, the tilting guide unit 1141 may be coupled to the mover 1130 of the holder 1131 and the first housing 1120. However, unlike the above description, in the embodiment, the tilting guide unit 1141 may be disposed between the first member 1126 and the holder 1131. Specifically, the tilting guide unit 1141 may be positioned between the first member 1126 and the fourth seating groove of the holder 1131. In the embodiment, the first member 1126 may be referred to as “housing rigid.” In addition, the second member 1131a may be referred to as “mover rigid.”

In addition, the second magnetic part 1142 and the first magnetic part 1143 may be seated in a first groove gr1 formed in the second member 1131a and a second groove gr2 formed in the first member 1126, respectively. In the embodiment, the first groove gr1 and the second groove gr2 may have different positions different from those of the first and second grooves described in the above-described embodiments. However, the first groove gr1 is positioned in the second member 1131a and moves integrally with the holder, and the second groove gr2 is positioned on the first member 1126 corresponding to the first groove gr1 and coupled to the first housing 1120. Therefore, description will be given by interchangeably using these terms.

In addition, the tilting guide unit 1141 may be disposed adjacent to the optical axis. Therefore, the actuator according to another embodiment may easily change the optical path according to first axis tilting and second axis tilting, which will be described below.

The tilting guide unit 1141 may include first protrusions spaced apart from each other in the first direction (X-axis direction) and second protrusions spaced apart from each other in the second direction (Y-axis direction). In addition, the first protrusion and the second protrusion may protrude in opposite directions. A description thereof will be given below. The first protrusion may protrude toward the mover. In addition, the first protrusion may extend from a base in the optical axis direction or the third direction (Z-axis direction). The second protrusion may protrude in a direction opposite to the first protrusion. In other words, the second protrusion may extend in a direction opposite to the optical axis direction or in a direction opposite to the third direction (Z-axis direction). In addition, the second protrusion may extend toward the first member 1126 or the housing 1120. Furthermore, the tilting guide unit 1141 may include a structure including a ball member or a rolling member other than the above-described structure.

In addition, as described above, the second magnetic part 1142 may be positioned in the second member 1131a. In addition, the first magnetic part 1143 may be positioned in the first member 1126.

The second magnetic part 1142 and the first magnetic part 1143 may have the same polarity. For example, the second magnetic part 1142 may be a magnet having an N pole, and the first magnetic part 1143 may be a magnet having an N pole. Alternatively, the second magnetic part 1142 may be a magnet having an S pole, and the first magnetic part 1143 may be a magnet having an S pole.

For example, a first pole face of the first magnetic part 1143 and a second pole face of the second magnetic part 1142 facing the first pole surface may have the same polarity.

The second magnetic part 1142 and the first magnetic part 1143 may generate a repulsive force between each other due to the above-described polarities. With this configuration, the above-described repulsive force may be applied to the second member 1131a or the holder 1131 coupled to the second magnetic part 1142 and the first member 1126 or the first housing 1120 coupled to the first magnetic part 1143. At this time, the repulsive force applied to the second member 1131a may be transmitted to the holder 1131 coupled to the second member 1131a. Therefore, the tilting guide unit 1141 disposed between the second member 1131a and the first member 1126 may be pressed by the repulsive force. In other words, the repulsive force may maintain the position of the tilting guide unit 1141 between the holder 1131 and the first housing 1120 (or the first member 1126). With this configuration, the position between the mover 1130 and the first housing 1120 may be maintained even when X-axis tilting or Y-axis tilting is performed. In addition, the tilting guide unit may be in close contact with the first member 1126 and the holder 1131 by the repulsive force between the first magnetic part 1143 and the second magnetic part 1142. The tilting guide unit 1141 may guide the tilting of the mover 1130.

The second optical driving unit 1150 includes the second optical driving magnet 1151, the second optical driving coil 1152, the Hall sensor unit 1153, the first board unit 1154, and the yoke unit 1155. The above description may be applied to a description thereof in the same manner except for the contents described in the embodiment.

The third coil 1152a may be positioned on the first housing side portion 1121, and the third magnet 1151a may be positioned on a first holder outer surface 1131S1 of the holder 1131. Therefore, the third coil 1152a and the third magnet 1151a may be positioned to face each other. At least a portion of the third magnet 1151a may overlap the third coil 1152a in the second direction (Y-axis direction).

In addition, the fourth coil 1152b may be positioned on the second housing side portion 1122, and the fourth magnet 1151b may be positioned on a second holder outer surface 1131S2 of the holder 1131. Therefore, the fourth coil 1152b and the fourth magnet 1151b may be positioned to face each other. At least a portion of the fourth magnet 1151b may overlap the fourth coil 1152b in the second direction (Y-axis direction).

In addition, the third coil 1152a and the fourth coil 1152b may overlap in the second direction (Y-axis direction), and the third magnet 1151a and the fourth magnet 1151b may overlap in the second direction (Y-axis direction).

With this configuration, an electromagnetic force applied to the outer surfaces of the holders (the first holder outer surface and the second holder outer surface) may be positioned on a parallel axis in the second direction (Y-axis direction), thereby accurately and precisely performing X-axis tilting.

In addition, second protrusions PR2a and PR2b of the tilting guide unit 1141 may be in contact with the first member 1126 of the first housing 1120. The second protrusion PR2 may be seated in a second protrusion groove PH2 formed in one side surface of the first member 1126. In addition, when X-axis tilting is performed, the second protrusions PR2a and PR2b may be reference axes (or rotational axes) of the tilt. Therefore, the tilting guide unit 1141 and the mover 1130 may move in the second direction.

In addition, as described above, the third Hall sensor 1153a may be positioned outside for electrical connection and coupling with the first board unit 1154. However, the present disclosure is not limited to these positions.

In addition, the fifth coil 1152c may be positioned on the third housing side portion 1123, and the fifth magnet 1151c may be positioned on a third holder outer surface 1131S3 of the holder 1131. The fifth coil 1152c and the fifth magnet 1151c may at least partially overlap in the first direction (X-axis direction). Therefore, an intensity of the electromagnetic force between the fifth coil 1152c and the fifth magnet 1151c may be easily controlled.

As described above, the tilting guide unit 1141 may be positioned on the fourth holder outer surface 1131S4 of the holder 1131. In addition, the tilting guide unit 1141 may be seated in a fourth seating groove 1131S4a on the fourth holder outer surface. As described above, the fourth seating groove 1131S4a may include a first region, a second region, and a third region.

The second member 1131a may be positioned in the first region. In other words, the first region may overlap the second member 1131a in the first direction (X-axis direction). In particular, the first region may be a region where a member base unit of the second member 1131a is positioned. In this case, the first region may be positioned on the fourth holder outer surface 1131S4. In other words, the first region may correspond to a region positioned above the fourth seating groove 1131S4a. In this case, the first region may not be one region within the fourth seating groove 1131S4a.

The first member 1126 may be positioned in the second region. In other words, the second region may overlap the first member 1126 in the first direction (X-axis direction).

In addition, the second region may be positioned on the fourth holder outer surface 1131S4 like the first region. In other words, the second region may correspond to a region positioned above the fourth seating groove 1131S4a.

The tilting guide unit may be positioned in the third region. In particular, the base of the tilting guide unit may be positioned in the third region. In other words, the third region may overlap the tilting guide unit (e.g., the base) in the first direction (X-axis direction).

The second member 1131a is disposed in the first region, and the second member 1131a may include the first groove gr1 formed on an inner surface thereof. In addition, as described above, the second magnetic part 1142 may be disposed in the first groove gr1, and a repulsive force RF2 generated from the second magnetic part 1142 may be transmitted to the fourth seating groove 1131S4a of the holder 1131 through the second member 1131a (RF2′). Therefore, the holder 1131 may apply a force to the tilting guide unit 1141 in the same direction as that of the repulsive force RF2 generated from the second magnetic part 1142.

The first member 1126 may be disposed in the second region. The first member 1126 may include the second groove gr2 facing the first groove gr1. In addition, the first member 1126 may include a second protrusion groove PH2 disposed on a surface corresponding to the second groove gr2. In addition, a repulsive force RF1 generated from the first magnetic part 1143 may be applied to the first member 1126. Therefore, the first member 1126 and the second member 1131a may press the tilting guide unit 1141 disposed between the first member 1126 and the holder 1131 through the generated repulsive forces RF1 and RF2′. Therefore, even after the holder tilts to the X-axis or the Y-axis by a current applied to the third and fourth coils or the fifth coil 1152c, the coupling between the holder 1131, the first housing 1120, and the tilting guide unit 1141 may be maintained.

The tilting guide unit 1141 may be disposed in the third region. As described above, the tilting guide unit 1141 may include the first protrusion PR1 and the second protrusion PR2. In this case, the first protrusion PR1 and the second protrusion PR2 may also be disposed on a second surface 1141b and a first surface 1141a of the base, respectively. As described above, even in another embodiment to be described below, the first protrusion PR1 and the second protrusion PR2 may be variously positioned on the facing faces of the base.

The first protrusion groove PH1 may be positioned in the fourth seating groove 1131S4a. In addition, the first protrusion PR1 of the tilting guide unit 1141 may be accommodated in the first protrusion groove PH1. Therefore, the first protrusion PR1 may be in contact with the first protrusion groove PH1. A maximum diameter of the first protrusion groove PH1 may correspond to a maximum diameter of the first protrusion PR1. This may also be applied to the second protrusion groove PH2 and the second protrusion PR2 in the same manner. In other words, a maximum diameter of the second protrusion groove PH2 may correspond to a maximum diameter of the second protrusion PR2. In addition, therefore, the second protrusion PR2 may be in contact with the second protrusion groove PH2. With this configuration, the first axis tilting with respect to the first protrusion PR1 and the second axis tilting with respect to the second protrusion PR2 may easily occur, thereby increasing a radius of the tilt.

In addition, since the tilting guide unit 1141 may be disposed side by side with the second member 1131a and the first member 1126 in the third direction (Z-axis direction), the tilting guide unit 1141 may overlap the optical member 1132 in the first direction (X-axis direction). More specifically, in the embodiment, the first protrusion PR1 may overlap the optical member 1132 in the first direction (X-axis direction). Furthermore, at least a portion of the first protrusion PR1 may overlap the fifth coil 1152c or the fifth magnet 1151c in the first direction (X-axis direction). In other words, in the camera actuator according to the embodiment, each protrusion, which is a central axis of the tilt, may be positioned adjacent to the center of gravity of the mover 1130. Therefore, the tilting guide unit may be positioned adjacent to the center of gravity of the holder. In addition, the camera actuator according to the embodiment can minimize a moment value for tilting the holder and also minimize the consumption of current applied to the coil unit to tilt the holder, thereby reducing power consumption and improving the reliability of the device.

In addition, the second magnetic part 1142 and the first magnetic part 1143 may not overlap the fifth coil 1152c or the optical member 1132 in the first direction (X-axis direction). In other words, in the embodiment, the second magnetic part 1142 and the first magnetic part 1143 may be disposed to be spaced apart from the fifth coil 1152c or the optical member 1132 in the third direction (Z-axis direction). Therefore, it is possible to minimize the magnetic forces transmitted to the fifth coil 1152c from the second magnetic part 1142 and the first magnetic part 1143. Therefore, the camera actuator according to the embodiment may easily perform the vertical driving (Y-axis tilting), thereby minimizing power consumption.

Furthermore, as described above, the fourth Hall sensor 1153b positioned inside the fifth coil 1152c may detect a change in magnetic flux, and thus position sensing between the fifth magnet 1151c and the fourth Hall sensor 1153b may be performed. At this time, an offset voltage of the fourth Hall sensor 1153b may be changed depending on the influence of the magnetic fields formed from the second magnetic part 1142 and the first magnetic part 1143.

The first camera actuator according to the embodiment may include the second member 1131a, the second magnetic part 1142, the first magnetic part 1143, the first member 1126, the tilting guide unit 1141, and the holder 1131 sequentially disposed. However, since the second magnetic part is positioned in the second member and the first magnetic part is positioned in the first member, the second member, the first member, the tilting guide unit, and the holder may be sequentially disposed.

In addition, in an embodiment, the second magnetic part 1142 and the first magnetic part 1143 may have a separation distance from the holder 1131 (or the optical member 1132) in the third direction that is greater than a separation distance from the tilting guide unit 1141. Therefore, the fourth Hall sensor 1153b under the holder 1131 may also be disposed to be spaced a predetermined distance from the second magnetic part 1142 and the first magnetic part 1143. Therefore, it is possible to minimize the influence of the magnetic fields formed by the second magnetic part 1142 and the first magnetic part 1143 on the fourth Hall sensor 1153b, thereby preventing a Hall voltage from being concentrated to a positive or negative value and saturated. In other words, this configuration allows a Hall electrode to have a range in which Hall calibration may be performed. Furthermore, a temperature is also affected by an electrode of the Hall sensor, the resolution of a camera lens varies depending on the temperature, but in the embodiment, it is possible to prevent a case in which the Hall voltage is concentrated to the positive or negative value and also compensating for the resolution of the lens in response thereto, thereby easily preventing a reduction in the resolution.

In addition, it is also possible to easily design a circuit for compensating for an offset for the output (i.e., the Hall voltage) of the fourth Hall sensor 1153b.

In addition, according to the embodiment, some regions of the tilting guide unit 1141 may be positioned outside the fourth holder outer surface relative to the fourth holder outer surface of the holder 1131.

The tilting guide unit 1141 may be seated in the fourth seating groove 1131S4a with respect to the base except for the first protrusion PR1 and the second protrusion PR2. In other words, a length of the base in the third direction (Z-axis direction) may be smaller than a length of the fourth seating groove 1131S4a in the third direction (Z-axis direction). With this configuration, miniaturization can be easily achieved.

In addition, a maximum length of the tilting guide unit 1141 in the third direction (Z-axis direction) may be greater than the length of the fourth seating groove 1131S4a in the third direction (Z-axis direction). Therefore, as described above, an end of the second protrusion PR2 may be positioned between the fourth holder outer surface and the first member 1126. In other words, at least a portion of the second protrusion PR2 may be positioned in a direction opposite to the third direction (Z-axis direction) from the holder 1131. In other words, the holder 1131 may be spaced a predetermined distance from the end of the second protrusion PR2 (the portion in contact with the second protrusion groove) in the third direction (Z-axis direction).

With this configuration, the second member 1131a can be positioned inside the first member 1126 or positioned to surround the first member 1126, thereby improving space efficiency and realizing miniaturization. Furthermore, even when the driving (the tilting or rotation of the mover 1130) by the electromagnetic force is performed, the second member 1131a does not protrude outward from the first member 1126, and thus the contact with surrounding devices can be blocked. Therefore, it is possible to improve reliability.

In addition, a predetermined separation space may be present between the second magnetic part 1142 and the first magnetic part 1143. In other words, the second magnetic part 1142 and the first magnetic part 1143 may face each other in the same polarity.

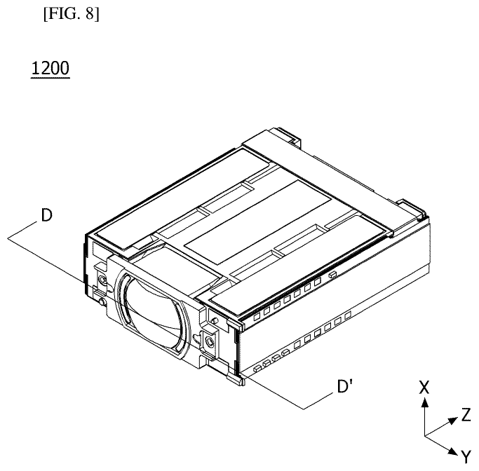

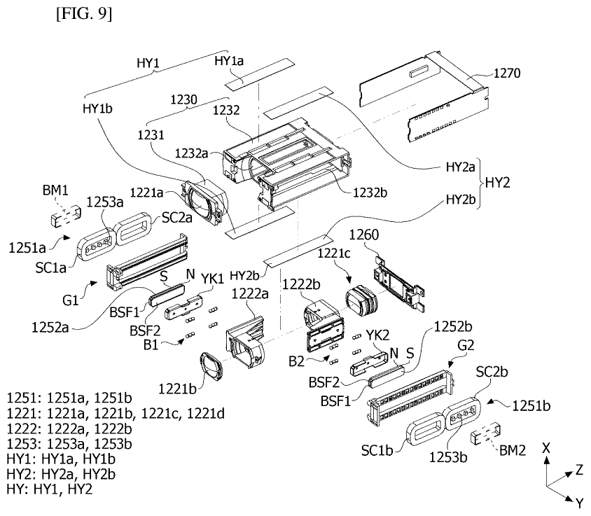

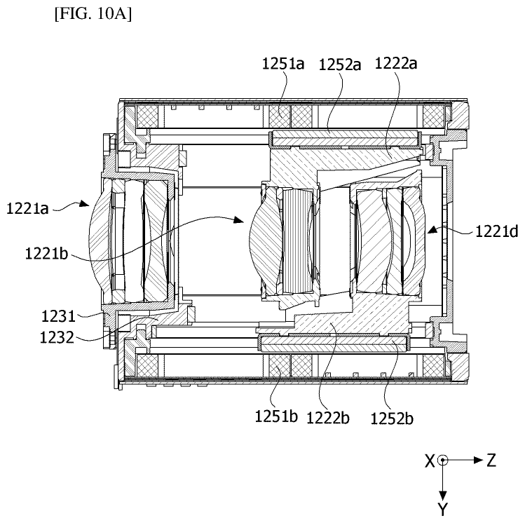

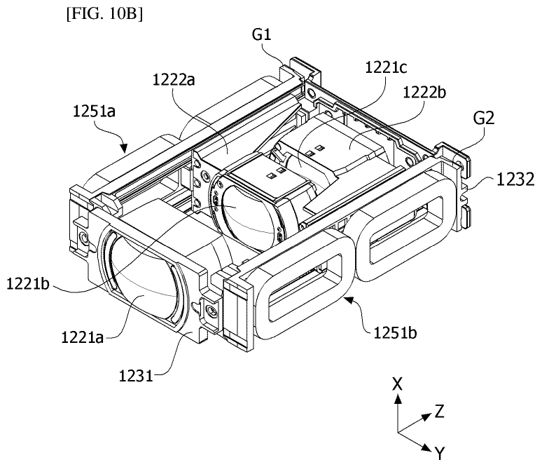

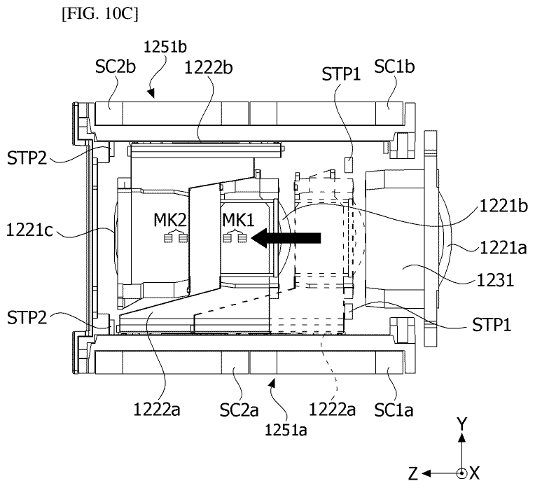

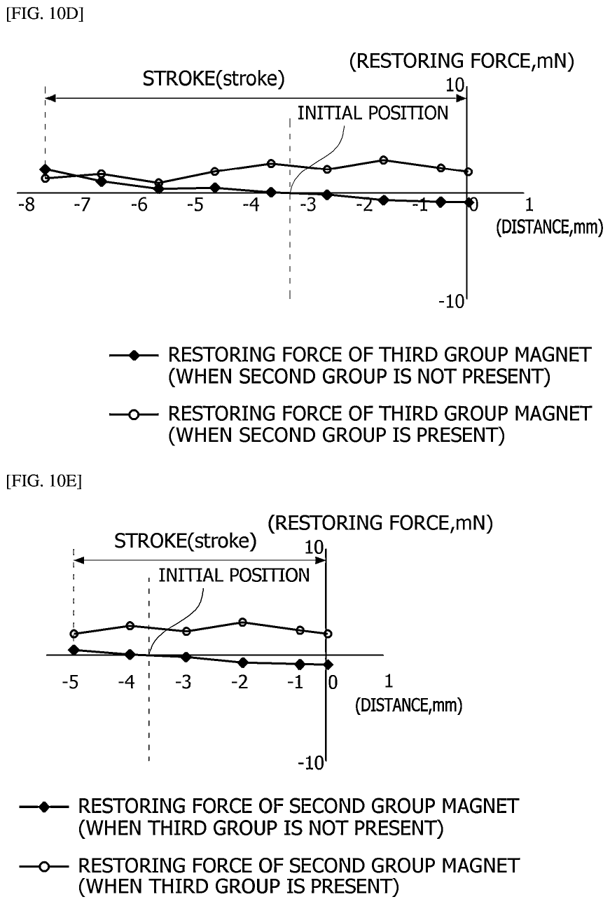

FIG. 8 is a perspective view of a second camera actuator according to the embodiment, FIG. 9 is an exploded perspective view of the second camera actuator according to the embodiment, FIG. 10A is a cross-sectional view along line D-D′ in FIG. 8, FIG. 10B is a perspective view showing a first optical driving unit, a moving assembly, and first and second guide units in the second camera actuator according to the embodiment, FIG. 10C is a view for describing the movement of a first lens assembly in the second camera actuator according to the embodiment, FIG. 10D is a graph for describing a restoring force of a second lens assembly in the second camera assembly according to the embodiment, and FIG. 10E is a graph for describing a restoring force of a third lens assembly in the second camera actuator according to the embodiment.

Referring to FIGS. 8 to 10A, the second camera actuator 1200 (or a camera device, a zoom lens transport device, a zoom lens moving device, or a lens transport device) according to the embodiment may include a lens unit 1220, a second housing 1230, a first optical driving unit 1250, a base unit 1260, a second board unit 1270, and a bonding member 1280. Furthermore, the second camera actuator 1200 may further include a second shield can (not shown), an elastic unit (not shown), and a bonding member (not shown).

In addition, as will be described below, a lens group may move in the optical axis direction. In addition, the lens group may be coupled to a lens assembly and may move in the optical axis direction. In this case, the second camera actuator may include a moving unit that moves in the optical axis direction together with the lens group and a fixed unit that does not move in the optical axis direction and is relatively fixed unlike the moving unit. In the embodiment, the moving unit may include a lens assembly (e.g., first and second lens assemblies) and a first optical driving magnet (first and second driving magnets). In addition, the fixed unit may include a second housing, a second board unit, a first optical driving coil, and a Hall sensor. Furthermore, a driving magnet may be disposed on one of the moving unit and the fixed unit, and a driving coil may be disposed on the other. A moving distance of the lens assembly to be described below corresponding to this description may correspond to a moving distance of the moving unit.

The second shield can (not shown) may be positioned in one region (e.g., an outermost side) of the second camera actuator 1200 and positioned to surround the following components (the lens unit 1220, the second housing 1230, the first optical driving unit 1250, the base unit 1260, the second board unit 1270, and an image sensor IS).

The second shield can (not shown) may block or reduce the influence of electromagnetic waves generated from the outside. Therefore, it is possible to reduce the number of occurrences of malfunction of the first optical driving unit 1250.

The lens unit 1220 may be positioned in the second shield can (not shown). The lens unit 1220 may move in the third direction (Z-axis direction or optical axis direction). Therefore, the above-described AF function or zooming function may be performed.

In addition, the lens unit 1220 may be positioned in the second housing 1230. Therefore, at least a portion of the lens unit 1220 may move in the optical axis direction or the third direction (Z-axis direction) in the second housing 1230.

Specifically, the lens unit 1220 may include a lens group 1221 and a moving assembly 1222.

First, the lens group 1221 may include one or more lenses. In addition, a plurality of lens groups 1221 may be provided, hereinafter, but description will be given based on one lens group.

The lens group 1221 may be coupled to the moving assembly 1222 and may move in the third direction (Z-axis direction) by the electromagnetic forces generated from a first magnet 1252a and a second magnet 1252b coupled to the moving assembly 1222.

In an embodiment, the lens group 1221 may include a first lens group 1221a, a second lens group 1221b, and a third lens group 1221c. The first lens group 1221a, the second lens group 1221b, and the third lens group 1221c may be sequentially disposed in the optical axis direction. Furthermore, the lens group 1221 may further include a fourth lens group 1221d. The fourth lens group 1221d may be disposed on the rear end of the third lens group 1221c.

The first lens group 1221a may be fixedly coupled to a 2-1 housing. In other words, the first lens group 1221a may not move in the optical axis direction. Therefore, the first lens group 1221a may be a fixed group in which the 2-1 housing does not move and may be the first lens assembly. In addition, the first lens assembly 1222a to be described below may become the second lens assembly by the 2-1 housing and may be a moving group. In addition, the second lens assembly 1222b may become the third lens assembly and may be the moving group. In other words, the fixed group/the moving group/the moving group may be configured as the 2-1 housing/the first lens assembly 1222a/the second lens assembly 1222b or the first lens assembly/the second lens assembly/the third lens assembly in the optical axis direction. Alternatively, the camera device may be formed of only the moving group/the moving group without the fixed group in the second camera actuator. In other words, the camera device may be formed of the first lens assembly 1222a/the second lens assembly 1222b, which will be described below. Hereinafter, the camera device will be described on the basis of the 2-1 housing/the first lens assembly 1222a/the second lens assembly 1222b.

The second lens group 1221b may be coupled to the first lens assembly 1222a and may move in the third direction or the optical axis direction. Magnification may be adjusted by moving the first lens assembly 1222a and the second lens group 1221b.

The third lens group 1221c may be coupled to the second lens assembly 1222b and may move in the third direction or the optical axis direction. Focal adjustment or AF function may be performed by moving the third lens group 1221c.

However, the present disclosure is not limited to the number of lens groups, and the fourth lens group 1221d may not be present or an additional lens group other than the fourth lens group 1221d may be further disposed.

The moving assembly 1222 may include an opening region surrounding the lens group 1221. The moving assembly 1222 is used interchangeably with the lens assembly. The moving assembly 1222 or the lens assembly may move in the optical axis direction (Z-axis direction) in the second housing 1230. In addition, the moving assembly 1222 may be coupled to the lens group 1221 by various methods. In addition, the moving assembly 1222 may include a groove in a side surface thereof, and may be coupled to the first magnet 1252a and the second magnet 1252b through the groove. A coupling member or the like may be applied to the groove.

In addition, the moving assembly 1222 may be coupled to the elastic units (not shown) on an upper end and a rear end thereof. Therefore, the moving assembly 1222 may be supported by the elastic unit (not shown) while moving in the third direction (Z-axis direction). In other words, the moving assembly 1222 may be maintained in the third direction (Z-axis direction) as the position of the moving assembly 1222 is maintained. The elastic unit (not shown) may be formed as various elastic devices such as a leaf spring.

The moving assembly 1222 may be positioned in the second housing 1230 and may include the first lens assembly 1222a and the second lens assembly 1222b.

A region where the third lens group is seated in the second lens assembly 1222b may be positioned on the rear end of the first lens assembly 1222a. In other words, the region where the third lens group 1221c is seated in the second lens assembly 1222b may be positioned between a region where the second lens group 1221b is seated in the first lens assembly 1222a and the image sensor.

The first lens assembly 1222a and the second lens assembly 1222b may face a first guide unit G1 and a second guide unit G2, respectively. The first guide unit G1 and the second guide unit G2 may be positioned on a first side portion and a second side portion of the second housing 1230 to be described below.

In addition, the first optical driving magnet may be seated on outer surfaces of the first lens assembly 1222a and the second lens assembly 1222b. For example, the second magnet 1252b may be seated on the outer surface of the second lens assembly 1222b. The first magnet 1252a may be seated on the outer surface of the first lens assembly 1222a. In the specification, the first lens assembly 1222a may be used interchangeably with “first bobbin” or “first lens carrier.” The second lens assembly 1222b may be used interchangeably with “second bobbin” or “second lens carrier.”

The second housing 1230 may be disposed between the lens unit 1220 and the second shield can (not shown). In addition, the second housing 1230 may be disposed to surround the lens unit 1220.

The second housing 1230 may include a 2-1 housing 1231 and a 2-2 housing 1232. The 2-1 housing 1231 may be coupled to the first lens group 1221a and may also be coupled to the above-described first camera actuator. The 2-1 housing 1231 may be positioned in front of the 2-2 housing 1232. The 2-1 housing 1231 may be referred to as “fixed assembly” or “front lens assembly.” The 2-2 housing 1232 may be referred to as “lens barrel” or “lens housing.”

In addition, the 2-2 housing 1232 may be positioned on the rear end of the 2-1 housing 1231. The lens unit 1220 may be seated inside the 2-2 housing 1232.

A hole may be formed in a side portion of the second housing 1230 (or the 2-2 housing 1232). The first coil 1251a and the second coil 1251b may be disposed in the hole. The hole may be positioned to correspond to the groove of the moving assembly 1222. In this case, a plurality of first coils 1251a and second coils 1211b may be provided.

In an embodiment, the second housing 1230 (in particular, the 2-2 housing 1232) may include a first side portion 1232a and a second side portion 1232b. The first side portion 1232a and the second side portion 1232b may be positioned to correspond to each other. For example, the first side portion 1232a and the second side portion 1232b may be disposed symmetrically with respect to the third direction. The first optical driving coil 1251 may be positioned on the first side portion 1232a and the second side portion 1232b. In addition, the second board unit 1270 may be seated on outer surfaces of the first side portion 1232a and the second side portion 1232b. In other words, a first board 1271 may be positioned on the outer surface of the first side portion 1232a, and a second board 1272 may be positioned on the outer surface of the second side portion 1232b.

Furthermore, the first guide unit G1 and the second guide unit G2 may be positioned on the first side portion 1232a and the second side portion 1232b of the second housing 1230 (in particular, the 2-2 housing 1232).

The first guide unit G1 and the second guide unit G2 may be positioned to correspond to each other. For example, the first guide unit G1 and the second guide unit G2 may be positioned opposite to each other with respect to the third direction (Z-axis direction). In addition, the first guide unit G1 and the second guide unit G2 may at least partially overlap each other in the second direction (Y-axis direction).

The first guide unit G1 and the second guide unit G2 may include at least one groove (e.g., a guide groove) or recess. In addition, a first ball B1 or a second ball B2 may be seated in the groove or the recess. Therefore, the first ball B1 or the second ball B2 may move in the third direction (Z-axis direction) in a guide groove of the first guide unit G1 or a guide groove of the second guide unit G2.

Alternatively, the first ball B1 or the second ball B2 may move in the third direction along a rail formed inside the first side portion 1232a of the second housing 1230 or a rail formed inside the second side portion 1232b of the second housing 1230.

Therefore, the first lens assembly 1222a and the second lens assembly 1222b may move in the third direction or the optical axis direction. At this time, the image sensor may be disposed adjacent or closer to the second lens assembly 1222b than the first lens assembly 1222a.

According to the embodiment, the first ball B1 may be in contact with the first lens assembly 1222a. The second ball B2 may be in contact with the second lens assembly 1222b. Therefore, at least a portion of the first ball B1 may overlap the second ball B2 in the first direction (X-axis direction) according to the position.

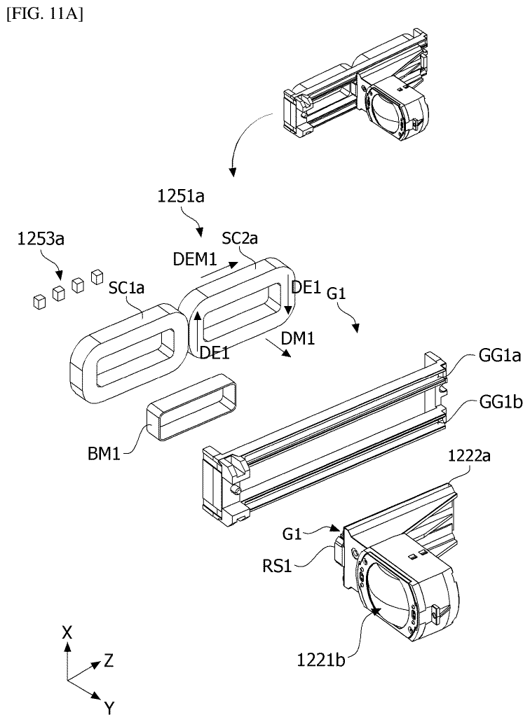

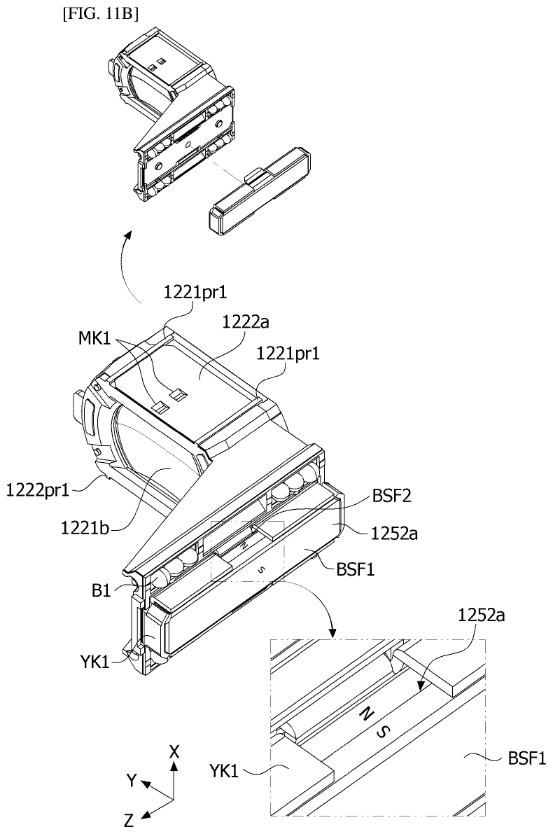

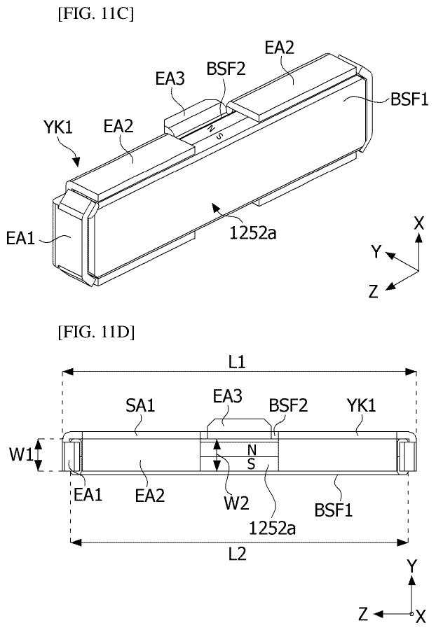

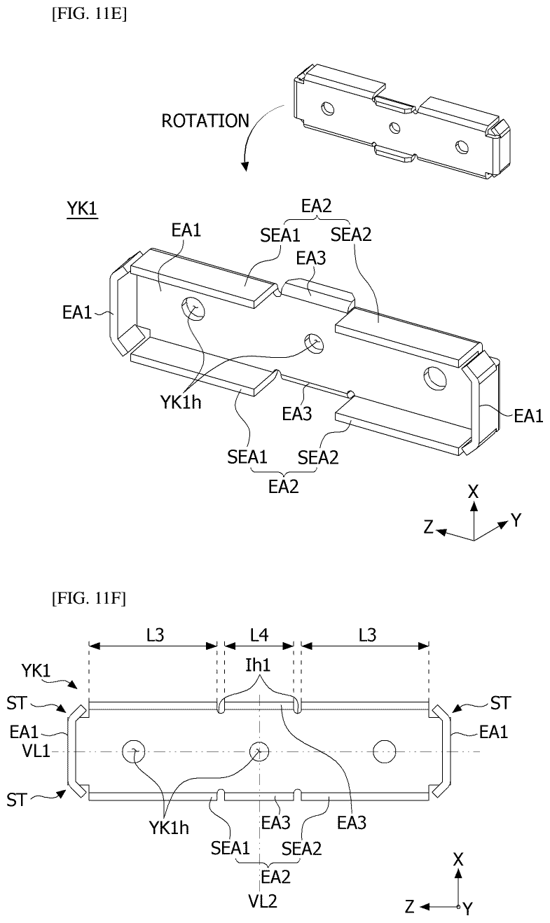

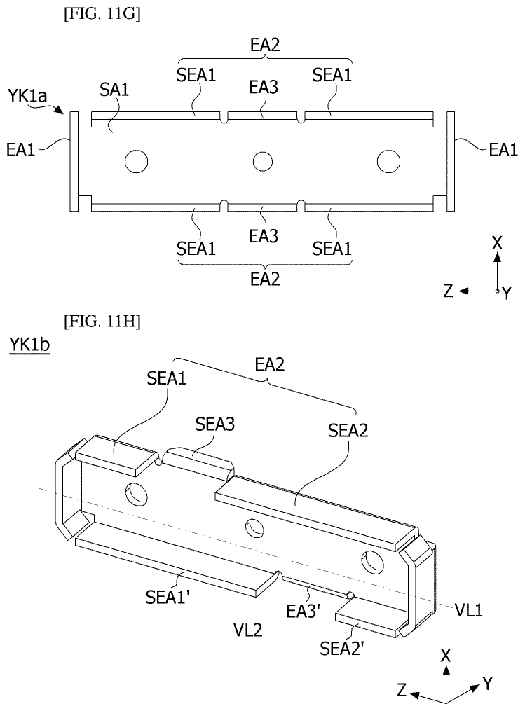

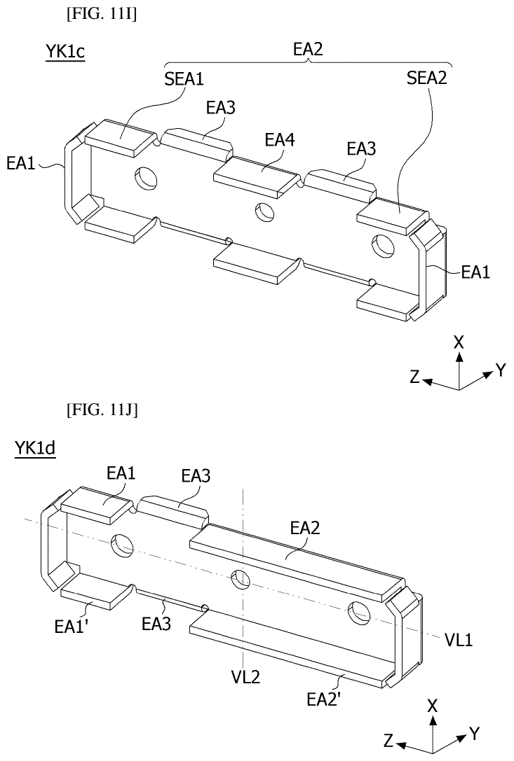

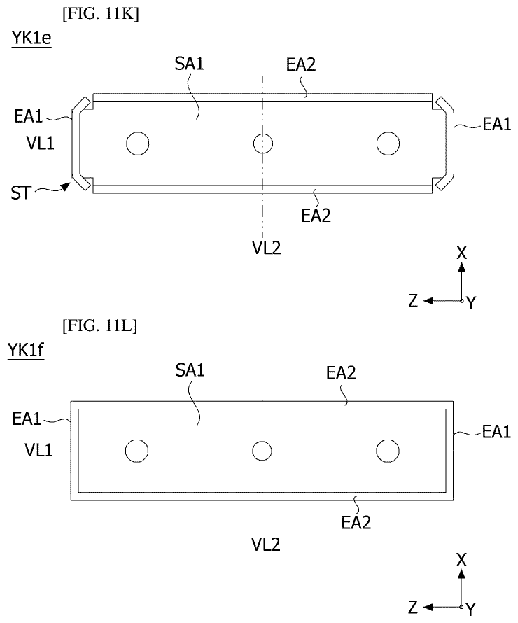

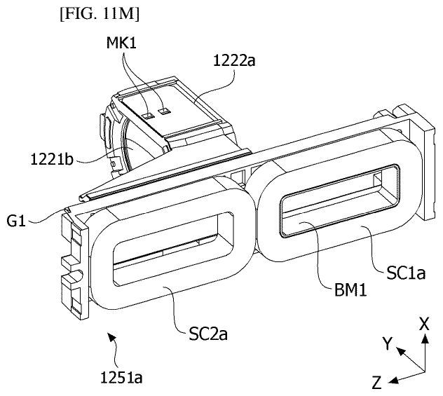

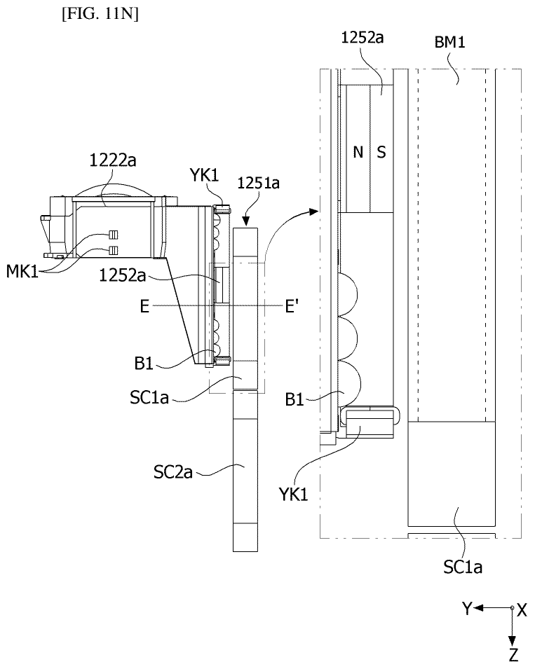

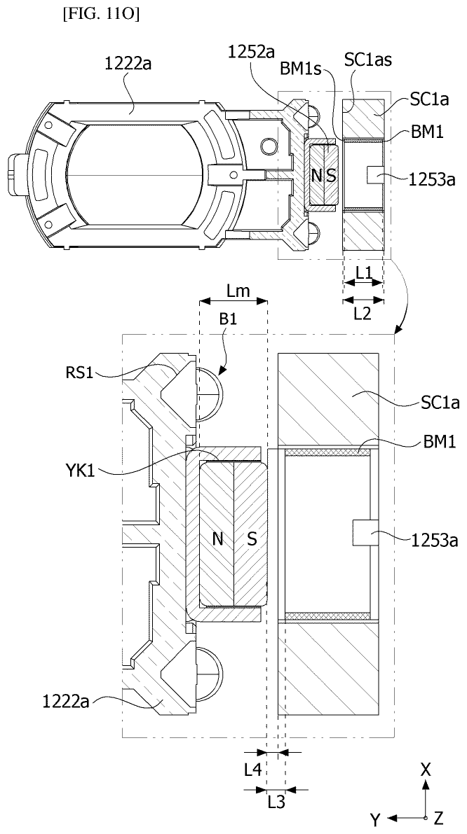

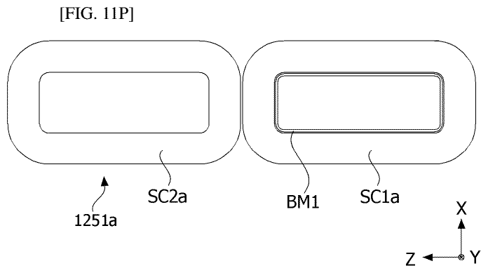

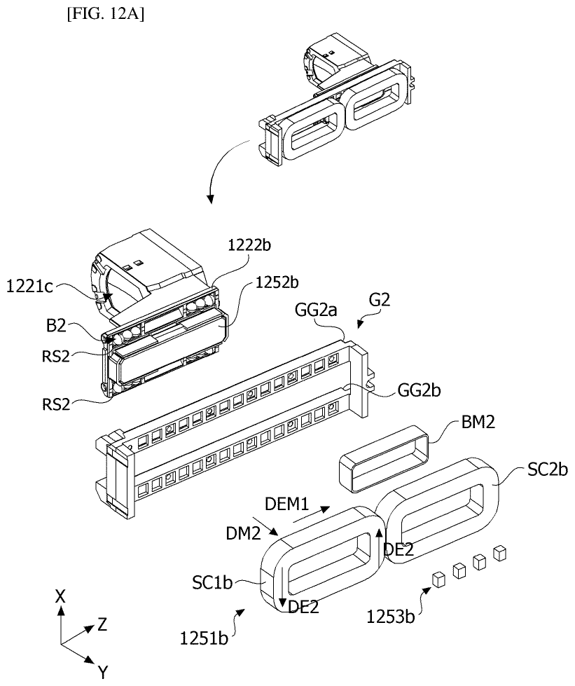

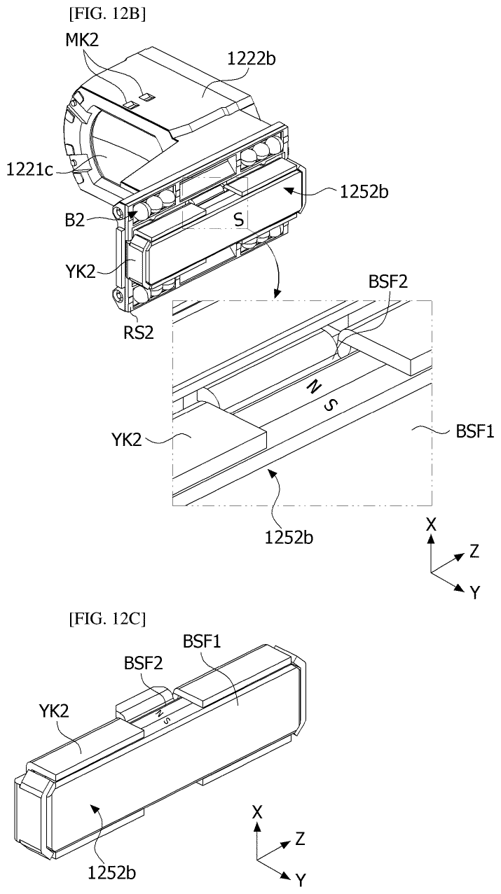

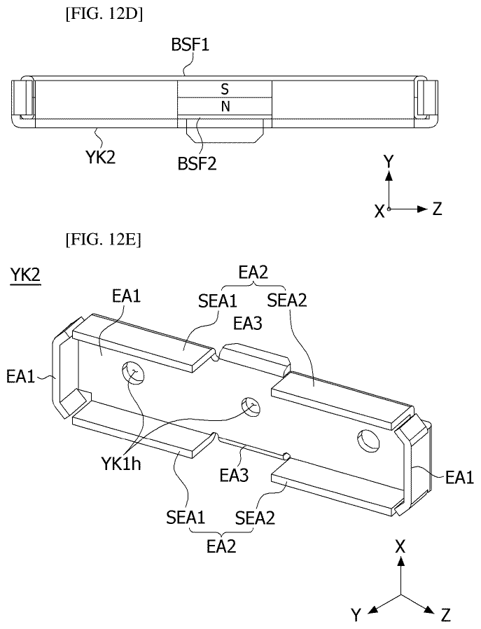

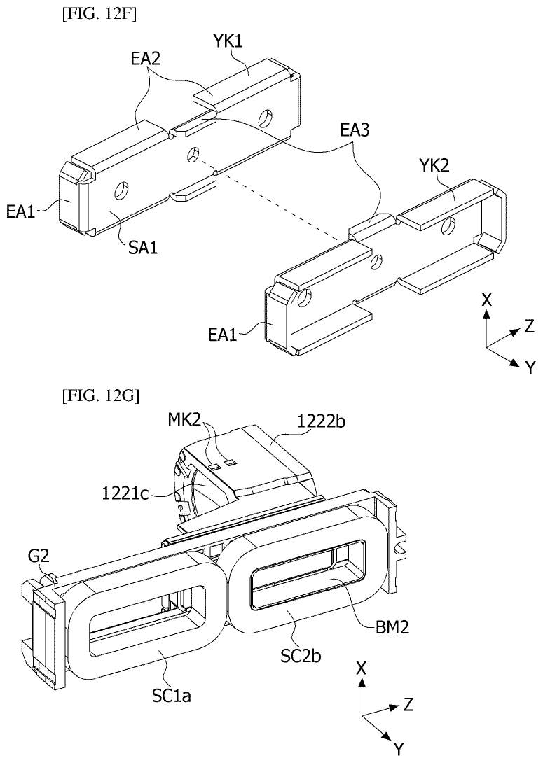

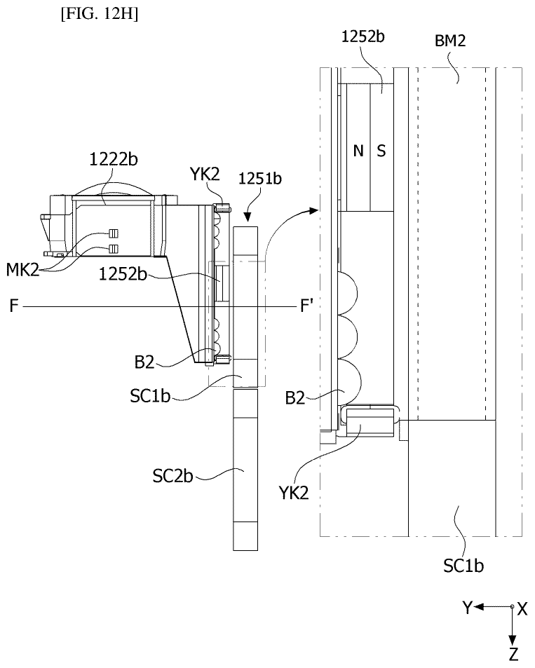

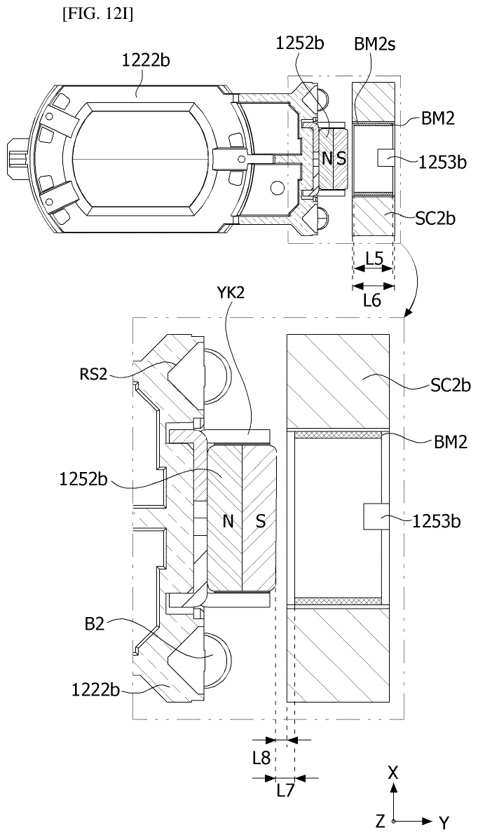

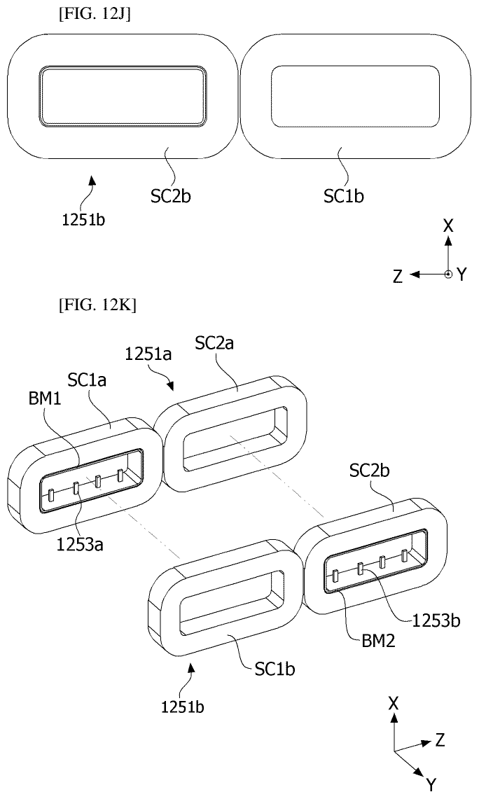

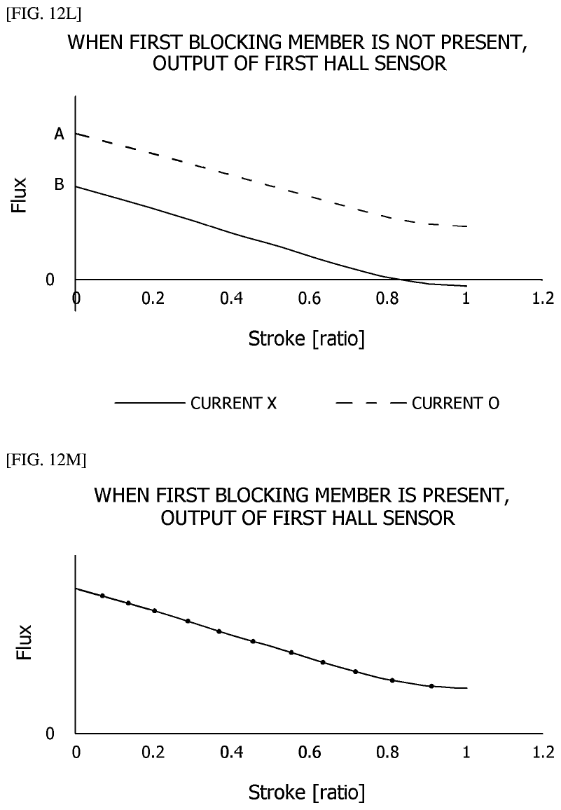

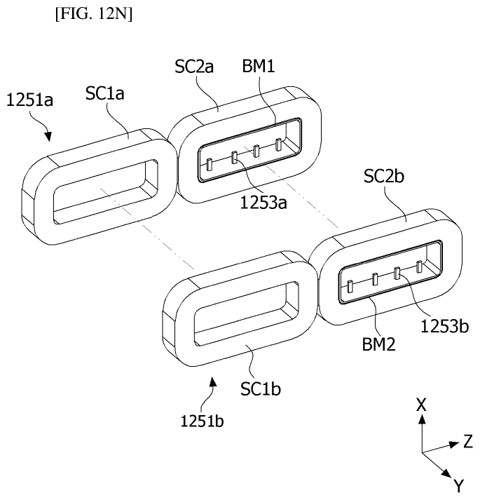

In addition, the first guide unit G1 and the second guide unit G2 may include first guide grooves GG1a and GG2a (see FIGS. 11A and 12A) facing a first recess RS1. In addition, the first guide unit G1 and the second guide unit G2 may include second guide grooves GG1b and GG2b facing a second recess RS2. The first guide grooves GG1a and GG2a and the second guide grooves GG1b and GG2b may be grooves extending in the third direction (Z-axis direction). In addition, the first guide grooves GG1a and GG2a and the second guide grooves GG1b and GG2b may be different shapes of grooves. For example, the first guide grooves GG1a and GG2a may be grooves whose side surfaces are inclined, and the second guide grooves GG1b and GG2b may be grooves whose side surfaces are perpendicular to bottom surfaces.

In addition, a plurality of first guide grooves GG1a and GG2a or a plurality of second guide grooves GG1b and GG2b may be provided. In addition, a plurality of balls having at least some different diameters may be positioned in the plurality of guide grooves. Furthermore, the first guide groove and the second guide groove may be formed integrally in the 2-2 housing.

The second magnet 1252b may be positioned to face the second coil 1251b. In addition, the first magnet 1252a may be positioned to face the first coil 1251a.

For example, at least one of the first coil 1251a and the second coil 1251b may be provided as a plurality of coils. For example, the first optical driving coil 1251 may include a first sub-coil SC1 and a second sub-coil SC2. The first sub-coil SC1 and the second sub-coil SC2 may be disposed in the optical axis direction (Z-axis direction). For example, the first sub-coil SC1 and the second sub-coil SC2 may be disposed sequentially in the optical axis direction. In addition, the first sub-coil SC1 may be disposed closest to the first camera actuator among the first sub-coil SC1 and the second sub-coil SC2. In the embodiment, the second camera actuator or the first optical driving unit may include a first driving unit and a second driving unit. The first driving unit may provide a driving force for moving the first lens assembly 1222a in the optical axis direction. The first driving unit may include the first coil 1251a and the first magnet 1252a. In addition, the first driving unit may include a first driving coil and a first driving magnet. Therefore, the first coil 1251a is described by being used interchangeably with “first driving coil.” In addition, the first magnet 1252a is described by being used interchangeably with “first driving magnet.”

In addition, the second driving unit may provide a driving force for moving the second lens assembly 1222b in the optical axis direction. The second driving unit may include the second coil 1251b and the second magnet 1252b.

In addition, the second driving unit may include a second driving coil and a second driving magnet. Therefore, the second coil 1251b is described by being used interchangeably with “second driving coil.” In addition, the second magnet 1252b is described by being used interchangeably with “second driving magnet.”

Hereinafter, description will be given based on this.

The elastic unit (not shown) may include a first elastic member (not shown) and a second elastic member (not shown). The first elastic member (not shown) may be coupled to an upper surface of the moving assembly 1222. The second elastic member (not shown) may be coupled to a lower surface of the moving assembly 1222. In addition, the first elastic member (not shown) and the second elastic member (not shown) may be formed as leaf springs as described above. In addition, the first elastic member (not shown) and the second elastic member (not shown) may provide elasticity for the movement of the moving assembly 1222. However, the present disclosure is not limited to the above-described positions, and the elastic unit may be disposed at various positions.

In addition, the first optical driving unit 1250 may provide a driving force for moving the lens unit 1220 in the third direction (Z-axis direction). The first optical driving unit 1250 may include the first optical driving coil 1251 and the first optical driving magnet 1252. The first optical driving coil 1251 and the first optical driving magnet 1252 may be positioned opposite to each other. For example, the first driving coil 1251a and the first driving magnet 1252a may be positioned to face each other. In addition, the second driving coil 1251b and the second driving magnet 1252b may be positioned to face each other. The first driving coil 1251a may be disposed on one side of the second housing in the second direction, and the second driving coil 1251a may be disposed on the other side of the second housing in the second direction.

Furthermore, the first optical driving unit 1250 may further include a first Hall sensor unit. The first Hall sensor unit 1253 may include at least one first Hall sensor 1253a and at least one fifth Hall sensor 1253b and may be positioned inside or outside the first optical driving coil 1251.

The moving assembly may move in the third direction (Z-axis direction) by the electromagnetic force formed between the first optical driving coil 1251 and the first optical driving magnet 1252.

The first optical driving coil 1251 may include the first coil 1251a and the second coil 1251b. In addition, as described above, the first coil 1251a and the second coil 1251b may be formed of a plurality of sub-coils. In addition, the first coil 1251a and the second coil 1251b may be disposed in the hole formed in the side portion of the second housing 1230. In addition, the first coil 1251a and the second coil 1251b may be electrically connected to the second board unit 1270. Therefore, the first coil 1251a and the second coil 1251b may receive a current or the like through the second board unit 1270.

In addition, the first optical driving coil 1251 may be coupled to the second board unit 1270 through a yoke or the like.

In addition, in the embodiment, the first optical driving coil 1251 is an element fixed with the second board unit 1270. In contrast, the first optical driving magnet 1252 is a moving element moving in the optical axis direction (Z-axis direction) together with the first and second assemblies.

The first optical driving magnet 1252 may include the first magnet 1252a and the second magnet 1252b.

In addition, the first magnet 1252a may face a first sub-coil SC1a and a second sub-coil SC2a. The second magnet 1252b may face a third sub-coil SC1b and a fourth sub-coil SC2b. The first sub-coil SC1a may be positioned to overlap the third sub-coil SC1b in the second direction. The second sub-coil SC2a may be positioned to overlap the fourth sub-coil SC2b in the second direction. As described above, the first magnet 1252a and the second magnet 1252b may be disposed to face the two sub-coils in the same manner. In the specification, description will be given based on the first sub-coils SC1a and SC1b and the second sub-coils SC2a and SC2b. However, in the specification, sub-coils for driving the second lens assembly may be referred to as “third sub-coil” and “fourth sub-coil.”

The first driving coil 1251a may include the first sub-coil SC1a and the second sub-coil SC2a. In addition, the second driving coil 1251b may include the third sub-coil SC1b and the fourth sub-coil SC2b.

In addition, the first sub-coil SC1a and the second sub-coil SC2a may be disposed side by side in the optical axis direction (Z-axis direction). In addition, the first sub-coil SC1a and the second sub-coil SC2a may be disposed to be spaced apart from each other in the optical axis direction. The first sub-coil SC1a and the second sub-coil SC2a may be connected in parallel. For example, one of one end and the other end of the first sub-coil SC1a may be connected to one of one end and the other end of the second sub-coil SC2a at a node. In addition, the other of the one end and the other end of the first sub-coil SC1a may be connected to the other of the one end and the other end of the second sub-coil SC2a at a different node. In other words, currents applied to the first sub-coil SC1a and the second sub-coil SC2a may be distributed to each sub-coil. Therefore, the first sub-coil SC1a and the second sub-coil SC2a may be electrically connected in parallel, thereby reducing heat.

In addition, a polarity of one surface of the first driving magnet 1252a facing the first driving coils SC1a and SC2a may be the same as a polarity of one surface of the second driving magnet 1252b facing the second driving coils SC1b and SC2b. For example, an inner surface of the first driving magnet 1252a and an inner surface of the second driving magnet 1252b may have one (e.g., an N pole) of an N pole and an S pole. An outer surface of the first driving magnet 1252a and an outer surface of the second driving magnet 1252b may have the other (e.g., S pole) of the N pole and the S pole. Here, the inner surface may be a side surface adjacent to the optical axis with respect to the optical axis, and the outer surface may be a side surface away from the optical axis.

In addition, the third sub-coil SC1b and the fourth sub-coil SC2b may be disposed side by side in the optical axis direction (Z-axis direction). In addition, the third sub-coil SC1b and the fourth sub-coil SC2b may be disposed to be spaced apart from each other in the optical axis direction.

The third sub-coil SC1b and the fourth sub-coil SC2b may be connected in parallel. For example, one of one end and the other end of the third sub-coil SC1b may be connected to one of one end and the other end of the fourth sub-coil SC2b at a node.

The first magnet 1252a and the second magnet 1252b may be disposed in the above-described groove of the moving assembly 1222 and positioned to correspond to the first coil 1251a and the second coil 1251b. In addition, the first optical driving magnet 1252 may be coupled to the first and second lens assemblies (or the moving assemblies) together with the yoke to be described below.

In addition, the first magnet 1252a may have a first pole on a first surface BSF1 facing the first optical driving coil (e.g., the first coil). In addition, the first magnet 1252a may have a second pole on a second surface BSF2 opposite to the first surface BSF1. The second magnet 1252b may have the first pole on the first surface BSF1 facing the first optical driving coil (e.g., the second coil). In addition, the second magnet 1252b may have the second pole on the second surface BSF2 opposite to the first surface BSF1. The first pole may be one of the N pole and the S pole. In addition, the second pole may be the other of the N pole and the S pole.

The base unit 1260 may be positioned between the lens unit 1220 and the image sensor IS. A component such as a filter may be fixed to the base unit 1260. In addition, the base unit 1260 may be disposed to surround the above-described image sensor. With this configuration, the image sensor can be free from foreign substances and the like, thereby improving the reliability of the device. However, hereinafter, description will be given after the image sensor is removed in some drawings.

In addition, the second camera actuator 1200 may be a zoom actuator or an AF actuator. For example, the second camera actuator may support one or more lenses and perform an AF function or a zooming function by moving the lens according to a control signal of a predetermined control unit.

In addition, the second camera actuator may be a fixed zoom actuator or a continuous zoom actuator. For example, the second camera actuator may provide the movement of the lens group 1221.

In addition, the second camera actuator may be formed of a plurality of lens assemblies. For example, one or more of a third lens assembly (not shown) other than the first lens assembly 1222a and the second lens assembly 1222b and a guide pin (not shown) may be disposed in the second camera actuator. The above description may be applied to a description thereof. Therefore, the second camera actuator may perform a high-magnification zooming function through the first optical driving unit. For example, the first lens assembly 1222a and the second lens assembly 1222b may be moving lenses moving through the first optical driving unit and the guide pin (not shown), and the fixed assembly (2-1 housing) and the third lens assembly (not shown) may be fixed lenses but the present disclosure is not limited thereto. For example, the third lens assembly may perform a function of a focator by which light forms an image at a specific position, and the first lens assembly may perform a function of a variator for re-forming an image formed by the third lens assembly, which is the focator, at another position. Meanwhile, the first lens assembly may be in a state in which a magnification change is large because a distance to a subject or an image distance is greatly changed, and the first lens assembly, which is the variator, may play an important role in a focal length or magnification change of the optical system. Meanwhile, imaging points of an image formed by the first lens assembly, which is the variator, may be slightly different depending on a position. Therefore, the second lens assembly may perform a position compensation function for the image formed by the variator. For example, the second lens assembly may perform a function of a compensator for accurately forming an image at an actual position of the image sensor using the imaging points of the image formed by the first lens assembly 1222a which is the variator. However, the configuration of the embodiment will be described with reference to the accompanying drawings.

The image sensor may be positioned inside or outside the second camera actuator. In an embodiment, as shown, the image sensor may be positioned outside the second camera actuator. For example, the image sensor may be positioned on a circuit board. The image sensor may receive light and convert the received light into an electrical signal. In addition, the image sensor may have a plurality of pixels in an array form. In addition, the image sensor may be positioned on the optical axis.

The second board unit 1270 may be in contact with the second housing side portion. For example, the second board unit 1270 may be positioned on the second housing, in particular, the outer surface (first outer surface) of the first side portion of the 2-2 housing and the outer surface (second outer surface) of the second side portion of the 2-2 housing and may be in contact with the first outer surface and the second outer surface.

In addition, the second camera actuator 1200 may include a housing yoke YK disposed on at least one of an upper portion and a lower portion of the 2-2 housing 1232 (or the second housing). The housing yoke YK may include a first housing yoke HY1 and a second housing yoke HY2.

The first housing yoke HY1 and the second housing yoke HY2 may be positioned outside an upper surface and a lower surface of the 2-2 housing 1232. Therefore, the first housing yoke HY1 and the second housing yoke HY2 can block magnetic forces generated by a first coil 1251a, a second coil 1251b, a first magnet 1252a, and a second magnet 1252b from being transmitted to facing elements. For example, the first housing yoke HY1 and the second housing yoke HY2 can reduce the amounts of magnetic forces, which are generated by the first coil 1251a and the first magnet 1252a, transmitted toward the second coil 1251b and the second magnet 1252b.

Referring to FIGS. 10B and 10C, the first lens assembly 1222a may move in the optical axis direction (Z-axis direction) in the second housing. The second lens assembly 1222b may move in the optical axis direction (Z-axis direction) in the second housing.

A first mark MK1 may be positioned on an upper surface of the first lens assembly 1222a. A second mark MK2 may be positioned on an upper surface of the second lens assembly 1222b. A plurality of first marks MK1 may be present. A plurality of second marks MK2 may be present. The plurality of first marks MK1 may be disposed side by side in the optical axis direction. The plurality of second marks MK2 may be disposed side by side in the optical axis direction. In addition, the first mark MK1 and the second mark MK2 may be recognized by a vision inspection. Therefore, positions, intervals, and the like of the first lens assembly 1222a and the second lens assembly 1222b may be recognized by the first mark MK1 and the second mark MK2. In addition, by recognizing the first mark MK1 and the second mark MK2, it is possible to accurately inspect whether the movement of the first lens assembly 1222a and the second lens assembly 1222b in the optical axis direction is accurately performed. Additionally, whether optical axes between the first and second lens assemblies are aligned may also be inspected.

The first coil 1251a may be easily coupled to the circuit board by an external board yoke. The second coil 1251b may be easily coupled to the circuit board by the external board yoke.

In addition, the first lens assembly 1222a may return to a position determined by an adjacent board yoke. In other words, the first lens assembly 1222a may be moved to a specific position by a restoring force generated by the board yoke.

In addition, the second lens assembly 1222b may return to a position determined by an adjacent board yoke. In other words, the second lens assembly 1222b may be moved to a specific position by the restoring force generated by the board yoke.

Furthermore, a first stopper and a second stopper STP1 and STP2 may block the movement of the first lens assembly 1222a and the second lens assembly 1222b in the optical axis direction. In other words, a separation distance between the first stopper and the second stopper STP1 and STP2 in the optical axis direction may be smaller than or equal to a moving range of the first lens assembly 1222a or the second lens assembly 1222b in the optical axis direction. The first stopper STP1 may be disposed closer to the first camera actuator than the second stopper STP2 is. In addition, the second stopper STP2 may be positioned closer to an image sensor than the first stopper STP1.

Referring to FIG. 10D, when the first lens assembly 1222a is not present (when a second group is not present and the first magnet and the first coil are not present), the restoring force of the second lens assembly 1222b may increase or decrease with respect to an initial position (about −3.75 mm). In other words, a sign of a magnitude of the restoring force may be opposite (positive/negative) with respect to the initial position.

However, when the first lens assembly 1222a is present (when the second group is present and the first magnet and the first coil are also present), the restoring force of the second lens assembly 1222b may not increase or decrease with respect to the initial position (about −3.75 mm). In this case, the moving range of the second lens assembly 1222b in the optical axis direction may be about 7.5 mm. In other words, the influence of the first magnet and the first coil may be applied to the second lens assembly 1222b. In other words, the second magnet coupled to the second lens assembly 1222b may be affected by the first magnet and the first coil as well as the board coil. Therefore, the restoring force of the second lens assembly 1222b may vary depending on whether the first lens assembly 1222a is present. As described above, in any one of the first lens assembly and the second lens assembly, a magnet and a coil attached to any one lens assembly may affect magnetic forces generated by a magnet and a coil (or a Hall sensor) attached to the other.

Likewise, referring to FIG. 10E, when the second lens assembly 1222b is not present (when a third group is not present and the second magnet and the second coil are not present), the restoring force of the first lens assembly 1222a may increase or decrease with respect to an initial position (about −3.75 mm). In other words, a sign of a magnitude of the restoring force may be opposite (positive/negative) with respect to the initial position.

In addition, when the second lens assembly 1222b is present (when the third group is present and the second magnet and the second coil are also present), the restoring force of the first lens assembly 1222a may not increase or decrease with respect to the initial position (about −3.75 mm). In this case, the moving range of the first lens assembly 1222a in the optical axis direction may be about 5 mm. In other words, the influence of the second magnet and the second coil may be applied to the first lens assembly 1222a. In other words, the first magnet coupled to the first lens assembly 1222a may be affected by the second magnet and the second coil as well as the board coil. Therefore, the restoring force of the first lens assembly 1222a may vary depending on whether the second lens assembly 1222b is present. As described above, in any one of the first lens assembly and the second lens assembly, a magnet and a coil attached to any one lens assembly may affect magnetic forces generated by a magnet and a coil (or a Hall sensor) attached to the other.

In the embodiment, disclosed is a structure in which in order to reduce the influence of the magnetic force, the yoke is coupled to at least one of the first lens assembly and the second lens assembly, the magnet is seated on the yoke, and at the same time, the yoke surrounds the magnet. A detailed description thereof will be given below.

Hereinafter, in the second camera actuator according to the embodiment, as described above, it is possible to suppress the influence of the magnetic force generated by the magnet (or the coil) of another lens assembly on the movement of one lens assembly.

FIG. 11A is an exploded perspective view related to the driving of the first lens assembly, FIG. 11B is a perspective view of components coupled to each other in FIG. 11A, FIG. 11C is a perspective view of a first yoke and a first magnet in FIG. 11B, FIG. 11D is a top view of FIG. 11C, FIG. 11E is a perspective view of the first yoke according to the embodiment, FIG. 11F is a side view of the first yoke according to the embodiment, FIG. 11G is a view of a first yoke according to a modified example, FIG. 11H is a view of a first yoke according to another embodiment, FIG. 11I is a view of a first yoke according to still another embodiment, FIG. 11J is a view of a first yoke according to yet another embodiment, FIG. 11K is a view of a first yoke according to yet another embodiment, FIG. 11L is a view of a first yoke according to yet another embodiment, FIG. 11M is a perspective view of a first blocking member, a first lens assembly, a first magnet, a first coil, and a first guide unit according to an embodiment, FIG. 11N is a top view of FIG. 11M, FIG. 11O is a cross-sectional view along E-E′ in FIG. 11N, and FIG. 11P is a view of the first coil and the first blocking member according to the embodiment.

In addition, FIG. 12A is an exploded perspective view related to the driving of the second lens assembly, FIG. 12B is a perspective view of components coupled to each other in FIG. 12A, FIG. 12C is a perspective view of a second yoke and a second magnet in FIG. 12B, FIG. 12D is a top view of FIG. 12C, FIG. 12E is a perspective view of the second yoke according to the embodiment, FIG. 12F is a perspective view of the first yoke and the second yoke according to the embodiment, FIG. 12G is a perspective view of a second blocking member, a second lens assembly, the second magnet, a second coil, and a second guide unit according to the embodiment, FIG. 12H is a top view of FIG. 12G, FIG. 12I is a cross-sectional view along F-F′ in FIG. 12H, FIG. 12J is a view of the second coil and the second blocking member according to the embodiment, FIG. 12K is a perspective view of the first coil, the second coil, a first Hall sensor unit, the first blocking member, and the second blocking member according to the embodiment, FIG. 12L is a graph of an output of a Hall sensor adjacent to the second lens assembly when there are no first and second blocking members, FIG. 12M is a graph of an output of the Hall sensor adjacent to the second lens assembly when the first and second blocking members are present, and FIG. 12N is a perspective view of a first coil, a second coil, a first Hall sensor unit, a first blocking member, and a second blocking member according to another embodiment.

Referring to FIGS. 11A and 12A, hereinafter, the electromagnetic force will be described below based on one coil. In the camera device according to the embodiment, by generating an electromagnetic force DEM1 between the first magnet 1252a and the first coil 1251a, the first lens assembly 1222a may move along a rail positioned on the inner surface of the housing through the first ball B1 in a direction parallel to the optical axis, that is, in the third direction (Z-axis direction) or the direction opposite to the third direction. At this time, the first magnet 1252a and the second magnet 1252b do not move to regions facing edges of the first and second sub-coils. Therefore, the electromagnetic force is formed based on the flow of current in adjacent regions of the first sub-coil and the second sub-coil.

Specifically, in the camera device according to the embodiment, the first magnet 1252a may be provided in the first lens assembly 1222a, for example, by a unipolar magnetization method. For example, in the embodiment, a face (first surface) facing the outer surface of the first magnet 1252a may be the S pole. The outer surface of the first magnet 1252a may be a surface facing the first coil 1251a. A face opposite to the first surface may be the N pole. Therefore, only one of the N pole and the S pole may be positioned to face the first coil 1251a. Here, description will be given based on the fact that the outer surface of the first magnet 1252a is the S pole. Furthermore, the first coil 1251a may be formed of a plurality of sub-coils, and currents may flow in opposite directions in the plurality of sub-coils. In other words, in a region of the first sub-coil SC1a adjacent to the second sub-coil SC2a, the same current as “DE1” may flow.

In other words, a first region of the first sub-coil SC1a and a second region of the second sub-coil SC2a may have the same current direction. The first region of the first sub-coil SC1a is a region that overlaps the first driving magnet 1252a in a direction (second direction) perpendicular to the optical axis direction and is disposed perpendicular to the optical axis direction (e.g., disposed in the first direction). The second region of the second sub-coil Sc2a is a region that overlaps the first driving magnet 1252a in the direction (second direction) perpendicular to the optical axis direction and is disposed perpendicular to the optical axis direction (e.g., disposed in the first direction).

In addition, as shown, in the embodiment, when a magnetic force is applied from the S pole of the first magnet 1252a in the second direction (Y-axis direction) and a current DE1 flows from the first coil 1251a in the first direction (X-axis direction), an electromagnetic force DEM1 may act in the third direction (Z-axis direction) according to the interaction of the electromagnetic force (e.g., Fleming's left-hand rule).

At this time, since the first coil 1251a is in a state of being fixed to the second housing side portion, the first lens assembly 1222a on which the first magnet 1252a is disposed may move in the direction opposite to the Z-axis direction by the electromagnetic force DEM1 according to the current direction. In other words, the first optical driving magnet may move in a direction opposite to the electromagnetic force applied to the first optical driving coil. In addition, the direction of the electromagnetic force may be changed depending on the current of the coil and the magnetic force of the magnet.

Therefore, the first lens assembly 1222a may move along the rail positioned on the inner surface of the housing through the first ball B1 in the third direction or the direction (both directions) parallel to the optical axis direction. At this time, the electromagnetic force DEM1 may be controlled in proportion to the current DE1 applied to the first coil 1251a.

The first lens assembly 1222a or the second lens assembly 1222b may include the first recess RS1 in which the first ball B1 is seated. In addition, the first lens assembly 1222a or the second lens assembly 1222b may include the second recess RS2 in which the second ball B2 is seated. A plurality of first recesses RS1 and second recesses RS2 may be provided. A length of the first recess RS1 may be preset in the optical axis direction (Z-axis direction). In addition, a length of the second recess RS2 may be preset in the optical axis direction (Z axis direction). Therefore, moving distances of the first ball B1 and the second ball B2 may be adjusted in the optical axis direction in each recess. In other words, the first recess RS1 or the second recess RS2 may function as a stopper for the first and second balls B1 and B2.

In addition, in the camera device according to the embodiment, the second magnet 1252b may be provided in the second lens assembly 1222b, for example, by a unipolar magnetization method.

The outer surface of the first magnet 1252a may be a surface facing the first coil 1251a. A face opposite to the first surface may be the N pole. Therefore, only one of the N pole and the S pole may be positioned to face the first coil 1251a. Here, description will be given based on the fact that the outer surface of the first magnet 1252a is the S pole. Furthermore, the first coil 1251a may be formed of a plurality of sub-coils, and currents may flow in opposite directions in the plurality of sub-coils. In other words, in a region of the first sub-coil SC1a adjacent to the second sub-coil SC2a, the same current as “DE1” may flow.

For example, in the embodiment, one of the N pole and the S pole of the second magnet 1252b may be positioned to face the second coil 1251b. In the embodiment, a face (first surface) facing the outer surface of the second magnet 1252b may be the S pole. In addition, the first surface may be the N pole. Hereinafter, as shown, description will be given based on the fact that the first surface is the N pole.

Furthermore, the second coil 1251b may be formed of a plurality of sub-coils, and currents may flow in the plurality of sub-coils in opposite directions. In other words, in a region of the first sub-coil SC1a adjacent to the second sub-coil SC2a, the same current as “DE2” may flow.

In the embodiment, when a magnetic force DM2 is applied from the first surface (N pole) of the second magnet 1252b in the second direction (Y-axis direction) and the current DE2 flows from the second coil 1251b corresponding the N pole in the first direction (X-axis direction), an electromagnetic force DEM2 may act in the third direction (Z-axis direction) according to the interaction of the electromagnetic force (e.g., Fleming's left-hand rule).

At this time, since the second coil 1251b is a state of being fixed to the second housing side portion, the second lens assembly 1222b on which the second magnet 1252b is disposed may move in the direction opposite to the Z-axis direction by the electromagnetic force DEM2 according to the current direction. For example, as described above, the direction of the electromagnetic force may be changed depending on the current of the coil and the magnetic force of the magnet. Therefore, the second lens assembly 1222b may move along the rail positioned on the inner surface of the second housing through the second ball B2 in the direction parallel to the third direction (Z-axis direction). At this time, the electromagnetic force DEM2 may be controlled in proportion to the current DE2 applied to the second coil 1251b.

Furthermore, a first blocking member BM1 may be disposed on an inner surface of the first sub-coil SC1a. In addition, a second blocking member BM2 may be disposed on an inner surface of the fourth sub-coil SC2b.

Referring to FIGS. 11A and 11M to be described below, the first blocking member BM1 may be disposed in the first coil 1251a. The first blocking member BM1 may be positioned between an inner surface of the first coil 1251a and the first Hall sensor. For example, the first blocking member BM1 may be disposed on the inner surface of the first coil 1251a. The first blocking member BM1 may be made of a magnetic blocking material. For example, the first blocking member BM1 may be formed of a magnetic material. In addition, the first blocking member BM1 may be a yoke. With this configuration, it is possible to easily block the magnetic forces generated by the first coil 1251a and the second magnet 1252b to the first Hall sensor disposed in the first coil 1251a. Therefore, it is possible to more accurately perform the position measurement by the first Hall sensor.

Referring to FIGS. 12A and 12G to be described below, the second blocking member BM2 may be disposed on an inner surface of the second coil 1251b. The second blocking member BM2 may be made of the magnetic blocking material. For example, the second blocking member BM2 may be formed of a magnetic material. In addition, the second blocking member BM2 may be a yoke. With this configuration, it is possible to easily block the magnetic forces generated by the second coil 1251b and the first magnet 1252a to the second Hall sensor disposed in the second coil 1251b. Therefore, it is possible to more accurately perform the position measurement by the second Hall sensor.

In an embodiment, the first blocking member BM1 and the second blocking member BM2 may not overlap each other in a horizontal direction. In other words, the first blocking member BM1 and the second blocking member BM2 may be positioned in sub-coils not facing each other.

In a modified example, the first blocking member BM1 and the second blocking member BM2 may be positioned in sub-coils facing each other.

Referring to FIG. 11B, the first mark MK1 may be present on the upper surface of the first lens assembly 1222a. In addition, a body portion in which a lens hole into which the second lens group 12221b is inserted is present and a wing portion facing the first guide unit on a side portion of the body portion may be present. The above-described first recess may be present on an outer surface of the wing portion. In addition, a ball may be seated in the first recess RS1.

First, in the second camera actuator or the camera device according to the embodiment, at least one of the first lens assembly 1222a and the second lens assembly 1222b may have a yoke. For example, the first lens assembly 1222a may have a first yoke so that the magnetic force by the first magnet is not transmitted to the second lens assembly. Conversely, the second lens assembly may have a second yoke so that the magnetic force by the second magnet is not transmitted to the first lens assembly. In addition, the camera device may include the first yoke. In addition, the camera device may include the second yoke. In addition, the camera device may include both of the first yoke and the second yoke. In addition, a description of the second yoke will be given below.

In addition, the first yoke YK1 may be positioned on the wing portion of the first lens assembly 1222a. The first yoke YK1 may be coupled to the wing portion of the first lens assembly 1222a. For example, the first lens assembly 1222a and the first yoke YK1 may be coupled by a bonding member (e.g., epoxy). In addition, the first yoke YK1 may be coupled to the first lens assembly 1222a by a coupling portion of the first yoke YK1.

Furthermore, the first magnet 1252a may be seated on the first yoke YK1. As described above, the first surface BSF1 of the first magnet 1252a may face the outside or the first coil. In addition, the second surface BSF2 of the first magnet 1252a may come into contact with a bottom surface of the first yoke YK1. Alternatively, the second surface BSF2 of the first magnet 1252a may come into contact with a bottom portion to be described below.

The first magnet 1252a may be seated on the first yoke YK1, and at least some of at least five surfaces of the first magnet 1252a may be surrounded by the first yoke YK1. In other words, the outside, that is, the first surface BSF1 of the first magnet 1252a may be entirely exposed to the outside. On the other hand, at least a portion of a surface of the first magnet 1252a other than the first surface BSF1 may be surrounded by the first yoke YK1. Alternatively, the surface of the first magnet 1252a other than the first surface BSF1 may come into contact with or face each region of the first yoke YK1.

Additionally, in the embodiment, the following description will be given on the basis of the first lens assembly 1222a having protrusions or assembly protrusions 1222pr1 and 1222pr2. Furthermore, the protrusion is a protrusion on an outer surface (hereinafter referred to as “upper surface” or “lower surface”) of any one of the first lens assembly 1222a and the second housing (or the 2-2 housing) and may be formed integrally with any one of the first lens assembly 1222a and the second housing (or the 2-2 housing). In addition, the protrusion may be in a separate type from any one of the first lens assembly 1222a and the second housing (or the 2-2 housing). For example, the protrusion may include a poron or the like to absorb an impact.

The protrusion or the assembly protrusions 1222pr1 and 1222pr2 may extend in a direction perpendicular to the optical axis direction. For example, the protrusion or the assembly protrusions 1222pr1 and 1222pr2 may extend in a first direction or a vertical direction (X-axis direction).

Referring to FIGS. 11C to 11F, the first yoke according to the embodiment may include a bottom portion SA1 facing a bottom surface of the first magnet 1252a, first side plate portions EA1 extending outward from the bottom portion SA1 and facing each other in the optical axis direction (Z-axis direction), and second side plate portions EA2 extending outward from the bottom portion SA1 and facing each other in the vertical direction (X-axis direction). Furthermore, the side plate portion may include the first side plate portion and the second side plate portion. Furthermore, the side plate portion may further include a third plate portion to be described below. Heights of the side plate portions may be smaller than or equal to heights of the first and second magnets. Therefore, when viewed from the outside, the side plate portion may not protrude more than the first and second magnets. In other words, some regions of the first and second magnets may be exposed by the side plate portions.

The bottom portion SA1 may come into contact with or face the second surface BSF2 of the first magnet 1252a.

In addition, the first side plate portion EA1 may be positioned on an edge of the bottom portion SA1 and connected to the bottom portion SA1. The second side plate portion EA2 may be positioned on the edge of the bottom portion SA1 and connected to the bottom portion SAL.

In an embodiment, the first magnet 1252a may be surrounded by the bottom portion SA1, the first side plate portion EA1, and the second side plate portion EA2. Alternatively, the first magnet 1252a may be surrounded by the bottom portion SA1, the first side plate portion EA1, and the second side plate portion EA2. Alternatively, the first magnet 1252a may be covered by the bottom portion SA1, the first side plate portion EA1, and the second side plate portion EA2. Only one surface of side surfaces of the first magnet 1252a may be entirely exposed by the bottom portion SA1, the first side plate portion EA1, and the second side plate portion EA2. Alternatively, only a surface of the first magnet 1252a facing the first coil may be entirely exposed by the bottom portion SA1, the first side plate portion EA1, and the second side plate portion EA2.

A length of the first side plate portion EA1 in the first direction or the vertical direction may be greater than a length of the second side plate portion EA2 in the first direction (or the vertical direction). In addition, the length of the first side plate portion EA1 in the third direction or the optical axis direction may be smaller than the length of the second side plate portion EA2 in the third direction (or the optical axis direction). Alternatively, the first side plate portion EA1 may be positioned on a short side of the bottom portion SAL. In addition, the second side plate portion EA2 may be positioned on a long side (long edge) of the bottom portion SA1.

The first side plate portion EA1 may include a stepped portion ST inclined toward the second side plate portion EA2 on the edge thereof. For example, the first side plate portion EA1 may have a chamfer. With this configuration, it is possible to easily prevent the first magnet 1252a disposed on the first yoke YK1 from being separated. The first side plate portion EA1 and the second side plate portion EA2 may also be connected or may also be separated from each other. In other words, the first side plate portion EA1 and the second side plate portion EA2 may form an opened loop or a closed loop on an XY plane.

In addition, a length L1 of the first yoke YK1 in the optical axis direction or the third direction may be greater than a length L2 of the first magnet 1252a in the optical axis direction or the third direction.

In addition, a length W1 of the first side plate portion EA1 in the second direction (Y-axis direction) may be smaller than or equal to a length W2 of the first magnet 1252a in the second direction (Y-axis direction).

In addition, the length W1 of the second side plate portion EA2 in the second direction (Y-axis direction) or the horizontal direction may be smaller than or equal to the length W2 of the first magnet 1252a in the horizontal direction or the second direction.

Therefore, the outer surface or the first surface BSF1 of the first magnet 1252a may be disposed outside the second side plate portion EA2. Alternatively, the outer surface or the first surface BSF1 of the first magnet 1252a may be disposed outside the first side plate portion EA1. With this configuration, the first yoke YK1 can block the magnetic force generated by the first magnet 1252a from being applied to the Hall sensor (first Hall sensor), the second magnet, the second coil, and the like of the second lens assembly. In addition, it is possible to prevent a reduction in electromagnetic force (e.g., a Lorentz force) generated by the magnetic force generated by the first magnet 1252a together with the first coil. Therefore, it is possible to prevent a reduction in the driving force of the first driving unit.

The first yoke YK1 may include a coupling portion EA3 extending inward from the bottom portion SAL. The coupling portion EA3 may be positioned on the long side of the edge of the bottom portion SA1.

In addition, as described above, in the specification, an inward direction is a direction toward the optical axis, and an outward direction may correspond to a direction away from the optical axis, for example, a direction from the center toward the outer surface of the lens group.

In an embodiment, the second side plate portion EA2 may include a first sub-side plate portion SEA1 and a second sub-side plate portion SEA2 disposed to be spaced apart from each other in the optical axis direction. In other words, the first sub-side plate portion SEA1 and the second sub-side plate portion SEA2 may be disposed to be spaced apart by a predetermined distance from each other in the optical axis direction.

The coupling portion EA3 may be disposed between the first sub-side plate portion SEA1 and the second sub-side plate portion SEA2. In addition, the coupling portion EA3 may extend in a direction different from that of the second side plate portion EA2.

In addition, the coupling portion EA3 may be disposed to be spaced apart by a predetermined distance from the first sub-side plate portion SEA1 in the optical axis direction. In addition, the coupling portion EA3 may be disposed to be spaced apart by a predetermined distance from the second sub-side plate portion SEA2 in the optical axis direction. With this configuration, it is possible to easily form the second side plate portion EA2 and the coupling portion EA3 extending in different directions.

At least a portion of the coupling portion EA3 may overlap the first lens assembly in the vertical direction. In other words, the coupling portion EA3 may be disposed in a groove disposed in the outer surface of the wing portion of the first lens assembly. Therefore, it is possible to increase a coupling force between the first yoke YK1 and the first lens assembly through the coupling portion EA3.

In addition, the first sub-side plate portion SEA1 and the second sub-side plate portion SEA2 may have the same length L3 in the optical axis direction (Z-axis direction).

In addition, a length L4 of the coupling portion EA3 in the optical axis direction may be smaller than the length L3 of the second side plate portion EA2 in the optical axis direction. In addition, the length L4 of the coupling portion EA3 in the optical axis direction may be smaller than a length of the first sub-side plate portion SEA1 or the second sub-side plate portion SEA2 in the optical axis direction. With this configuration, it is possible to minimize the magnetic force generated by the first magnet 1252a from passing between the first sub-side plate portion SEA1 and the second sub-side plate portion SEA2 and being provided from the first yoke YK1 to an opposite side.

In addition, the bottom portion SA1 may include a yoke groove IH1 disposed in at least one of a space between the first sub-side plate portion SEA1 and the coupling portion EA3 and a space between the second sub-side plate portion SEA2 and the coupling portion EA3. The yoke groove IH1 may be positioned between the second side plate portion EA2 and the coupling portion EA3 on the edge of the bottom portion SA1. In addition, the yoke groove IH1 may be convex toward the center of the bottom portion SA1.

Furthermore, the coupling portion EA3 may be positioned between the first balls disposed to be spaced apart from each other. In other words, the coupling portion EA3 may be positioned between the first balls spaced apart from each other in the optical axis direction. Furthermore, the coupling portion may be positioned between the first recesses RS1 spaced apart from each other in the optical axis direction.

Furthermore, the first yoke YK1 may include a yoke hole YK1h positioned in the bottom portion SA1. A plurality of yoke holes YK1h may be present. A bonding member (e.g., epoxy) may be applied through the yoke hole YK1h. Therefore, it is possible to increase a coupling force between at least two of the first magnet 1252a, the first yoke YK1, and the first lens assembly.

The yoke hole YK1h may be disposed on a first virtual line VL1 that bisects the first yoke YK1 in the vertical direction. For example, the center of the yoke hole YK1h may be positioned on the first virtual line VL1.

A plurality of yoke holes YK1h may have the same size as each other. Alternatively, any one of the plurality of yoke holes YK1h may also be different from the other. For example, the size of the yoke hole YK1h positioned at the center may be the smallest.

Furthermore, the coupling portion EA3 may be disposed on a second virtual line VL2 that bisects the first yoke YK1 in the optical axis direction (Z-axis direction). Therefore, even when the magnetic force generated by the first magnet 1252a moves to the opposite side, a distance may be maximally increased.

Referring to FIG. 11G, the above description of the first yoke YK1 according to the embodiment except for the following description may be applied to the first yoke YK1a according to the modified example in the same manner.

In the first yoke YK1a according to the modified example, the first side plate portion EA1 may not be inclined toward the second side plate portion EA2. In other words, the first side plate portion EA1 may not have a stepped portion. Therefore, a separation distance between the first sub-side plate portion SEA1 and the coupling portion EA3 in the optical axis direction may be smaller than a separation distance between the first sub-side plate portion SEA1 and the first side plate portion EA1 in the optical axis direction. In addition, a separation distance between the second sub-side plate portion SEA2 and the coupling portion EA3 in the optical axis direction may be smaller than a separation distance between the second sub-side plate portion SA2 and the first side plate portion EA1 in the optical axis direction.

Referring to FIG. 11H, the above description of the first yoke YK1 according to the embodiment except for the following description may be applied to a first yoke YK1b according to another embodiment in the same manner.

The first sub-side plate portion SEA1 and the second sub-side plate portion SEA2 may have different lengths in the optical axis direction.

Furthermore, the coupling portion EA3 may be disposed between the first sub-side plate portion SEA1 and the second sub-side plate portion SEA2, and a plurality of coupling portions EA3 may be present.

For example, the first sub-side plate portion may include a 1-1 sub-side plate portion SEA1 disposed on one side thereof and a 1-2 sub-side plate portion SEA1′ disposed on the other side thereof. In addition, the second sub-side plate portion may include a 2-1 sub-side plate portion ESA2 disposed on one side thereof and a 2-2 sub-side plate portion SEA2′ disposed on the other side thereof. In addition, the coupling portion may include a first coupling portion EA3 and a second coupling portion EA3′. The first coupling portion EA3 may be disposed between the 1-1 sub-side plate portion SEA1 and the 2-1 sub-side plate portion SEA2. In addition, the second coupling portion EA3′ may be disposed between the 1-2 sub-side plate portion SEA1′ and the 2-2 sub-side plate portion SEA2′.

Furthermore, in the first yoke YK1b according to the embodiment, a portion of the 1-1 sub-side plate portion SEA1 may overlap the 1-2 sub-side plate portion SEA1′. A portion of the 1-2 sub-side plate portion SEA1′ may not overlap the 1-1 sub-side plate portion SEA1 in the vertical direction (X-axis direction).

In addition, the 1-2 sub-side plate portion SEA1′ may overlap the first coupling portion EA3 in the vertical direction. In addition, the first coupling portion EA3 may not overlap the second coupling portion EA3′ in the vertical direction. In other words, the first coupling portion EA3 may be misaligned with the second coupling portion EA3′ in the vertical direction. In addition, a portion of the 2-1 sub-side plate portion SEA2 may overlap the 2-2 sub-side plate portion SEA2′ in the vertical direction. In addition, the 2-1 sub-side plate portion SEA2 may overlap the second coupling portion EA3′ in the vertical direction. In addition, a portion of the 2-1 sub-side plate portion SEA2 may not overlap the 2-2 sub-side plate portion SEA2′ in the vertical direction.

In addition, the coupling portion EA3 may not be disposed on the second virtual line VL2. Furthermore, a plurality of coupling portions EA3 may not overlap each other in the vertical direction.

Referring to FIG. 11I, the above description of the first yoke YK1c according to another embodiment except for the following description may be applied to a first yoke YK1 according to still another embodiment in the same manner.

A plurality of coupling portions EA3 may be disposed to be spaced apart from each other in the optical axis direction. Therefore, the plurality of coupling portions EA3 disposed on one side of the bottom portion SA1 may be disposed to be spaced apart from each other in the optical axis direction. In addition, the third side plate portion EA4 connected to the edge of the bottom portion SA1 and extending outward may be disposed between the plurality of coupling portions EA3.

A plurality of third side plate portions EA4 may be disposed to face each other in the optical axis direction.

In addition, the first yoke YK1c may further have a yoke groove, which is convex, on the first virtual line VL1, disposed between the third side plate portion EA4 and the coupling portion EA3.

Referring to FIG. 11J, the above description of the first yoke YK1 according to the embodiment except for the following description may be applied to a first yoke YK1 according to yet another embodiment in the same manner.

The first sub-side plate portion SEA1 and the second sub-side plate portion SEA2 may have different lengths in the optical axis direction.

Furthermore, the coupling portion EA3 may be disposed between the first sub-side plate portion SEA1 and the second sub-side plate portion SEA2, and a plurality of coupling portions EA3 may be present. The plurality of coupling portions EA3 may be disposed to face each other in the optical axis direction.

For example, the first sub-side plate portion may include a 1-1 sub-side plate portion SEA1 disposed on one side thereof and a 1-2 sub-side plate portion SEA1′ disposed on the other side thereof. In addition, the second sub-side plate portion may include a 2-1 sub-side plate portion ESA2 disposed on one side thereof and a 2-2 sub-side plate portion SEA2′ disposed on the other side thereof. In addition, the coupling portion may include a first coupling portion EA3 and a second coupling portion EA3′. The first coupling portion EA3 may be disposed between the 1-1 sub-side plate portion SEA1 and the 2-1 sub-side plate portion SEA2. In addition, the second coupling portion EA3′ may be disposed between the 1-2 sub-side plate portion SEA1′ and the 2-2 sub-side plate portion SEA2′.

Furthermore, in the first yoke YK1b according to the embodiment, the 1-1 sub-side plate portion SEA1 may overlap the 1-2 sub-side plate portion SEA1′. A length of the 1-2 sub-side plate portion SEA1′ in the optical axis direction may be the same as a length of the 1-1 sub-side plate portion SEA1 in the optical axis direction.

In addition, the 1-2 sub-side plate portion SEA1′ may not overlap the first coupling portion EA3 in the vertical direction. In addition, the first coupling portion EA3 may overlap the second coupling portion EA3′ in the vertical direction.

In addition, the 2-1 sub-side plate portion SEA2 may overlap the 2-2 sub-side plate portion SEA2′ in the vertical direction. In addition, the 2-1 sub-side plate portion SEA2 may not overlap the second coupling portion EA3′ in the vertical direction. A length of the 2-1 sub-side plate portion SEA2 in the optical axis direction may be the same as a length of the 2-2 sub-side plate portion SEA2′ in the optical axis direction.

Referring to FIG. 11K, the above description of the first yoke YK1e according to the embodiment except for the following description may be applied to a first yoke YK1 according to still yet another embodiment in the same manner. Furthermore, the contents described in other embodiments may also be applied.

In other words, the first yoke may include the first side plate portion EA1 and the second side plate portion EA2, which extend outward. The first side plate portion EA1 may be positioned on the short side of the bottom portion SAL. In addition, the second side plate portion EA2 may be positioned on a long side of the bottom portion SAL. Furthermore, the second side plate portion EA2 may be 0.7 times or more in length as an optical axis of the magnet (first magnet) seated thereon. Therefore, in the embodiment, the first yoke may be disposed in the groove (e.g., the outer surface of the wing portion) disposed in the side surface of the first lens assembly. In other words, the first yoke may be seated on the groove positioned in the side surface of the first lens assembly facing the first guide unit. Furthermore, the first lens assembly and the first yoke may be coupled to each other through the bonding member (e.g., epoxy).

Referring to FIG. 11L, the above description of the first yoke YK1f according to the embodiment except for the following description may be applied to a first yoke YK1 according to further another embodiment in the same manner. Furthermore, the contents described in other embodiments may also be applied.

The first yoke may include the first side plate portion EA1 and the second side plate portion EA2, which extend outward. The first side plate portion EA1 may be positioned on the short side of the bottom portion SA1. In addition, the second side plate portion EA2 may be positioned on a long side of the bottom portion SAL. Furthermore, the first side plate portion EA1 and the second side plate portion EA2 may come into contact with each other. In other words, the first side plate portion EA1 and the second side plate portion EA2 may be connected. Therefore, the bottom portion SA1, the first side plate portion EA1, and the second side plate portion EA2 may be connected. Therefore, the first side plate portion EA1 and the second side plate portion EA2 may form a closed loop with respect to the XY plane. In other words, the first side plate portion EA1 and the second side plate portion EA2 may surround the first magnet without an opening region.

In addition, in the embodiment, the first yoke may be disposed in the groove (e.g., the outer surface of the wing portion) disposed in the side surface of the first lens assembly. In other words, the first yoke may be seated on the groove positioned in the side surface of the first lens assembly facing the first guide unit. Furthermore, the first lens assembly and the first yoke may be coupled to each other through the bonding member (e.g., epoxy).

The above description of the plurality of embodiments may be applied to different embodiments in the same manner. In addition, the description of the first yoke coupled to the first lens assembly may also be applied to the second yoke coupled to the second lens assembly in the same manner.

Specifically, the first blocking member BM1 may be disposed in the sub-coil of the first coils 1251a, which is disposed in the first Hall sensor. For example, the first sub-coil SC1a and the second sub-coil SC2a may be disposed to overlap each other in the optical axis direction (Z-axis direction). Furthermore, the first sub-coil SC1a may be positioned closer to the first camera actuator or the first lens group than the second sub-coil SC2a. The second sub-coil SC2a may be disposed closer to the image sensor than the first sub-coil SC1a is.

In addition, the first blocking member BM1 may have a shape corresponding to the formation of the hole of the first coil 1251a. As another example, the first blocking member BM1 may have various shapes such as a polygon, such as a circle or a quadrangle. A description thereof may also be applied to the second blocking member BM2 and the second coil in the same manner.

The first Hall sensor may be disposed in the first sub-coil SC1a. In addition, the first blocking member BM1 may be disposed on the inner surface of the first sub-coil SC1a. An inward direction of the sub-coil may be a direction toward the center of the sub-coil, and an outward direction of the sub-coil may correspond to a direction from the center toward the edge of the sub-coil.

Referring to FIGS. 11N to 11E, a horizontal thickness L1 of the first blocking member BM1 according to the embodiment may be smaller than a thickness L2 of the first sub-coil SC1a. Alternatively, a height L1 of the first blocking member BM1 may be smaller than a height L2 of the first sub-coil SC1a. The length L1 of the first blocking member BM1 according to the embodiment in the horizontal direction (Y-axis direction) may be smaller than the length L2 of the first sub-coil SC1a in the horizontal direction or the second direction (Y-axis direction). Therefore, an inner end SC1as of the first sub-coil may be disposed closer to the first magnet 1252a than an inner end BM1s of the first blocking member BM1 is. In other words, a length between the inner end BMIs of the first blocking member BM1 and the first magnet 1252a in the second direction may be greater than a length between the inner end SC1as of the first sub-coil and the first magnet 1252a in the second direction.

In addition, the separation distance L3 between the first blocking member BM1 and the first magnet 1252a in the horizontal direction (Y-axis direction) may be greater than the separation distance L4 between the first sub-coil SC1a and the first magnet 1252a in the horizontal direction. With this configuration, the first blocking member BM1 may block most magnetic force transmitted from the second magnet to the first Hall sensor 1253a in the first sub-coil SC1a.

In addition, the separation distance L3 between the first blocking member BM1 and the first magnet 1252a in the horizontal direction (Y-axis direction) may be smaller than a thickness Lm of the first magnet 1252a. In other words, the separation distance between the first blocking member BM1 and the first magnet 1252a may be smaller than the length Lm of the first magnet 1252a in the horizontal direction.

In addition, the first yoke YK1 may be coupled to the first magnet 1252a and the first lens assembly 1222a as described above.

In an embodiment, the first yoke YK1 and the first blocking member BM1 may at least partially overlap each other in the horizontal direction or the second direction (Y-axis direction) in at least a partial section (region) while the first yoke YK1 moves in the optical axis direction. In other words, the first yoke YK1 and the first blocking member BM1 may at least partially overlap in the horizontal direction according to the position of the first yoke YK1. In addition, a ratio of the length of the first yoke YK1 in the vertical direction to the length of the first blocking member BM1 in the vertical direction may be 1:0.8 to 1:1.2. Therefore, as described above, the first yoke YK1 may overlap the first blocking member BM1 in the horizontal direction corresponding to the movement of the first yoke YK1. With this configuration, it is possible to maximally block the first yoke YK1 and the first blocking member BM1 from being transmitted to the first Hall sensor 1253a. Therefore, it is possible to accurately detect the position of the first lens assembly 1222a.

In addition, the first yoke YK1 and the first blocking member BM1 may be disposed to be spaced apart from each other in the horizontal direction or the second direction (Y-axis direction). Therefore, it is possible to suppress the interference with the movement of the first lens assembly 1222a due to the contact between the first yoke YK1 and the first blocking member BM1.

Furthermore, the inner surface (or the inner surface) of the first sub-coil SC1a and the first blocking member BM1 may be bonded through the bonding member or the like. Therefore, the bonding member may be applied between the first sub-coil SC1a and the first blocking member BM1. In other words, the bonding member may be disposed between the first coil 1251a and the first blocking member BM1. For example, a thickness of the bonding member may be the same as or different from a thickness of the first blocking member BM1.

Furthermore, the first coil 1251a and the first blocking member BM1 may also be bonded to the second board unit. Therefore, the bonding member may be positioned between the first coil 1251a and the second board unit. In addition, the bonding member may be applied between the first blocking member BM1 and the second board unit. A description thereof may also be applied to the second blocking member BM2 and the second coil in the same manner.

Referring to FIG. 12B, the second mark MK2 may be present on the upper surface of the second lens assembly 1222b. In addition, the body portion having the lens hole into which the second lens group 12221b is inserted and the wing portion facing the second guide unit on the side of the body portion may be present. The above-described second recess may be present on the outer surface of the wing portion. In addition, a ball may be seated in the second recess RS2.

In addition, the second yoke YK2 may be positioned on the wing portion of the second lens assembly 1222b. The second yoke YK2 may be coupled to the wing portion of the second lens assembly 1222b. For example, the second lens assembly 1222b and the second yoke YK2 may be coupled by the bonding member (e.g., epoxy). In addition, the second yoke YK2 may be coupled to the second lens assembly 1222b by the coupling portion of the second yoke YK2.

Furthermore, the second magnet 1252b may be seated on the second yoke YK2. As described above, the first surface BSF1 of the second magnet 1252b may face the outside or the second coil as described above. In addition, the second surface BSF2 of the second magnet 1252b may come into contact with the bottom surface of the second yoke YK2. Alternatively, the second surface BSF2 of the second magnet 1252b may come into contact with a bottom portion to be described below.

The second magnet 1252a may be seated on the second yoke YK1, and at least some of at least five surfaces of the second magnet 1252b may be surrounded by the second yoke YK1. In other words, the outside, that is, the second surface BSF2 of the second magnet 1252a may be entirely exposed to the outside. Unlike this, at least a portion of a surface of the second magnet 1252b other than the first surface BSF1 may be surrounded by the second yoke YK2. Alternatively, the surface of the second magnet 1252b other than the first surface BSF1 may come into contact with or face each region of the second yoke YK2.

Referring to FIGS. 12C to 12E, the second yoke according to the embodiment may include a bottom portion SA1 facing a bottom surface of the second magnet 1252b, first side plate portions EA1 extending outward from the bottom portion SA1 and opposite to each other in the optical axis direction (Z-axis direction), and second side plate portions EA2 extending outward from the bottom portion SA1 and facing each other in the vertical direction (X-axis direction).

The bottom portion SA1 may come into contact with or face the second surface BSF2 of the second magnet 1252b.

In addition, the first side plate portion EA1 may be positioned on an edge of the bottom portion SA1 and connected to the bottom portion SA1. The second side plate portion EA2 may be positioned on the edge of the bottom portion SA1 and connected to the bottom portion SAL.

In an embodiment, the second magnet 1252b may be surrounded by the bottom portion SA1, the first side plate portion EA1, and the second side plate portion EA2.

A length of the first side plate portion EA1 in the first direction or the vertical direction may be greater than a length of the second side plate portion EA2 in the first direction (or the vertical direction). In addition, the length of the first side plate portion EA1 in the third direction or the optical axis direction may be smaller than the length of the second side plate portion EA2 in the third direction (or the optical axis direction). Alternatively, the first side plate portion EA1 may be positioned on a short side of the bottom portion SAL. In addition, the second side plate portion EA2 may be positioned on a long side of the bottom portion SA1.

The first side plate portion EA1 may include a stepped portion ST inclined toward the second side plate portion EA2 on the edge thereof. For example, the first side plate portion EA1 may have a chamfer. With this configuration, it is possible to easily prevent the second magnet 1252b disposed on the second yoke YK2 from being separated.

In addition, a length L1 of the second yoke YK2 in the optical axis direction or the third direction may be greater than a length L2 of the second magnet 1252b in the optical axis direction or the third direction.

In addition, a length W1 of the first side plate portion EA1 in the second direction (Y-axis direction) may be smaller than or equal to a length W2 of the second magnet 1252b in the second direction (Y-axis direction).

In addition, the length W1 of the second side plate portion EA2 in the second direction (Y-axis direction) or the horizontal direction may be smaller than or equal to the length W2 of the second magnet 1252b in the horizontal direction or the second direction.

Therefore, the outer surface or the first surface BSF1 of the second magnet 1252b may be disposed outside the second side plate portion EA2. Alternatively, the outer surface or the first surface BSF1 of the second magnet 1252b may be disposed outside the first side plate portion EA1. With this configuration, the second yoke YK2 can block the magnetic force generated by the second magnet 1252b from being applied to the Hall sensor, the second magnet, the second coil, and the like of the second lens assembly. In addition, it is possible to prevent a reduction in electromagnetic force (e.g., a Lorentz force) generated by the magnetic force generated by the second magnet 1252b together with the first coil. Therefore, it is possible to prevent a reduction in the driving force of the first driving unit.

The second yoke YK2 may include a coupling portion EA3 extending inward from the bottom portion SAL. The coupling portion EA3 may be positioned on the long side of the edge of the bottom portion SA1.

In addition, as described above, in the specification, an inward direction is a direction toward the optical axis, and an outward direction may correspond to a direction away from the optical axis, for example, a direction from the center toward the outer surface of the lens group.

In an embodiment, the second side plate portion EA2 may include a first sub-side plate portion SEA1 and a second sub-side plate portion SEA2 disposed to be spaced apart from each other in the optical axis direction. In other words, the first sub-side plate portion SEA1 and the second sub-side plate portion SEA2 may be disposed to be spaced apart by a predetermined distance from each other in the optical axis direction.

The coupling portion EA3 may be disposed between the first sub-side plate portion SEA1 and the second sub-side plate portion SEA2. In addition, the coupling portion EA3 may extend in a direction different from that of the second side plate portion EA2.

In addition, the coupling portion EA3 may be disposed to be spaced apart by a predetermined distance from the first sub-side plate portion SEA1 in the optical axis direction. In addition, the coupling portion EA3 may be disposed to be spaced apart by a predetermined distance from the second sub-side plate portion SEA2 in the optical axis direction. With this configuration, it is possible to easily form the second side plate portion EA2 and the coupling portion EA3 extending in different directions.

At least a portion of the coupling portion EA3 may overlap the second lens assembly in the vertical direction. In other words, the coupling portion EA3 may be disposed in the groove disposed in the outer surface of the wing portion of the second lens assembly. Therefore, it is possible to increase the coupling force between the second yoke YK2 and the second lens assembly through the coupling portion EA3.

In addition, the first sub-side plate portion SEA1 and the second sub-side plate portion SEA2 may have the same length L3 in the optical axis direction (Z-axis direction).

In addition, a length L4 of the coupling portion EA3 in the optical axis direction may be smaller than the length L3 of the second side plate portion EA2 in the optical axis direction. In addition, the length L4 of the coupling portion EA3 in the optical axis direction may be smaller than the length L4 of the first sub-side plate portion SEA1 or the second sub-side plate portion SEA2 in the optical axis direction. With this configuration, it is possible to minimize the magnetic force generated by the second magnet 1252b from passing between the first sub-side plate portion SEA1 and the second sub-side plate portion SEA2 and being provided from the second yoke YK2 to an opposite side.

In addition, the bottom portion SA1 may include a yoke groove IH1 disposed in at least one of spaces between the first sub-side plate portion SEA1 and the coupling portion EA3 and between the second sub-side plate portion SEA2 and the coupling portion EA3. The yoke groove IH1 may be positioned between the second side plate portion EA2 and the coupling portion EA3 on the edge of the bottom portion SA1. In addition, the yoke groove IH1 may be convex toward the center of the bottom portion SA1.

The coupling portion EA3 may be positioned between second balls disposed to be spaced apart from each other. In other words, the coupling portion EA3 may be positioned between the second balls spaced apart from each other in the optical axis direction. Furthermore, the coupling portion may be positioned between the second recesses RS2 spaced apart from each other in the optical axis direction.

Furthermore, the second yoke YK2 may include a yoke hole YK2h positioned in the bottom portion SAL. A plurality of yoke holes YK2h may be present. A bonding member (e.g., epoxy) may be applied through the yoke hole YK2h. Therefore, it is possible to increase the coupling force between at least two of the second magnet 1252b, the second yoke YK2, and the second lens assembly.

The yoke hole YK2h may be disposed on the first virtual line VL1 that bisects the second yoke YK2 in the vertical direction. For example, the center of the yoke hole YK2h may be positioned on the first virtual line VL1.

Furthermore, the coupling portion EA3 may be disposed on the second virtual line VL2 that bisects the second yoke YK2 in the optical axis direction (Z-axis direction). Therefore, even when the magnetic force generated by the second magnet 1252b moves to the opposite side, a distance can be maximally increased.

Referring to FIG. 12F, the first yoke YK1 and the second yoke YK2 may be disposed to face each other with respect to the optical axis or the optical axis direction. Furthermore, the coupling portion EA3 of the first yoke YK1 and the coupling portion EA3 of the second yoke YK2 may face each other. However, the positions of the first yoke YK1 and the second yoke YK2 may vary depending on the movement of the first lens assembly and the second lens assembly.

Furthermore, through the bottom portion, the first side plate portion, and the second side plate portion EA2, the first yoke YK1 and the second yoke YK2 can maximally suppress the magnetic forces generated by the first magnet and the second magnet respectively seated thereon from being provided therebetween. Therefore, it is possible to prevent the restoring forces of the first and second lens assemblies from being degraded by the magnetic forces.

In addition, it is possible to prevent the first Hall sensor unit from being affected by the first magnet and the second magnet. For example, the influence of the magnetic force generated by the first magnet on the second Hall sensor can be reduced or suppressed by the first yoke YK1. In addition, the influence of the magnetic force generated by the second magnet on the first Hall sensor can be reduced or suppressed by the second yoke YK2.

Specifically, the second blocking member BM2 may be disposed in the sub-coil of the second coil 1251b, which is disposed in the second Hall sensor. For example, the third sub-coil SC1b and the fourth sub-coil SC2b may be disposed to overlap each other in the optical axis direction (Z-axis direction). Furthermore, the third sub-coil SC1b may be positioned closer to the first camera actuator or the first lens group than the fourth sub-coil SC2b. The fourth sub-coil SC2b may be disposed closer to the image sensor than the third sub-coil SC1b is.

The second Hall sensor may be disposed in the fourth sub-coil SC2b. In addition, the second blocking member BM2 may be disposed on an inner surface of the fourth sub-coil SC2b. An inward direction of the sub-coil may be a direction toward the center of the sub-coil, and an outward direction of the sub-coil may correspond to a direction from the center toward the edge of the sub-coil.

Referring to FIGS. 12H to 12E, a horizontal thickness L5 of the second blocking member BM2 according to the embodiment may be smaller than a thickness L6 of the fourth sub-coil SC2b. In other words, the length L5 of the second blocking member BM2 according to the embodiment in the horizontal direction or the second direction (Y-axis direction) may be smaller than the length L6 of the fourth sub-coil SC2b (or the third sub-coil Sc1b) in the horizontal direction or the second direction (Y-axis direction). Therefore, an inner end SC1bs of the fourth sub-coil SC2b may be disposed closer to the second magnet 1252a than an inner end BM2s of the second blocking member BM2 is. In other words, a length between the inner end BM2s of the second blocking member BM2 and the second magnet 1252a in the second direction may be greater than a length between the inner end SC2bs of the fourth sub-coil SC2b and the second magnet 1252a in the second direction.

In addition, a separation distance L7 between the second blocking member BM2 and the second magnet 1252a in the horizontal direction (Y-axis direction) may be greater than a separation distance L8 between the fourth sub-coil SC2b and the second magnet 1252a in the horizontal direction. With this configuration, it is possible to block most magnetic force transmitted from the first magnet and the second coil to the second Hall sensor 1253a in the fourth sub-coil SC2b.

In addition, the separation distance L7 between the second blocking member BM2 and the second magnet 1252a in the horizontal direction (Y-axis direction) may be smaller than a length Lm of the second magnet 1252a in the horizontal direction.

In addition, the second yoke YK2 may be coupled to the second magnet 1252a and the second lens assembly 1222b as described above.

In an embodiment, the second yoke YK2 and the second blocking member BM2 may at least partially overlap each other in the horizontal direction or the second direction (Y-axis direction) in at least some sections (regions) while the second yoke YK2 moves in the optical axis direction

With this configuration, it is possible to maximally block the second yoke YK2 and the second blocking member BM2 from being transmitted to the second Hall sensor 1253a. Therefore, it is possible to accurately detect the position of the second lens assembly 1222b.

In addition, the second yoke YK2 and the second blocking member BM2 may be disposed to be spaced apart from each other in the horizontal direction or the second direction (Y-axis direction). Therefore, it is possible to suppress the interference with the movement of the second lens assembly 1222b due to the contact between the second yoke YK2 and the second blocking member BM2.

Furthermore, the inner surface (or the inner surface) of the fourth sub-coil SC2b and the second blocking member BM2 may be bonded through a bonding member or the like. Therefore, the bonding member may be applied between the fourth sub-coil SC2b and the second blocking member BM2.

Referring to FIG. 12K, the third sub-coil SC1b of the second coil 1251b may be disposed to correspond to the first sub-coil SC1a with respect to the optical axis. For example, the third sub-coil SC1b of the second coil 1251b may be positioned symmetrically with the first sub-coil SC1a with respect to the optical axis.

In addition, the fourth sub-coil SC2b of the second coil 1251b may be disposed to correspond to the second sub-coil SC2a with respect to the optical axis. For example, the fourth sub-coil SC2b of the second coil 1251b may be positioned symmetrically with the second sub-coil SC2a with respect to the optical axis.

In addition, in an embodiment, the first blocking member BM1 and the second blocking member BM2 may not overlap each other in the horizontal direction. Furthermore, the first Hall sensor 1253a and the second Hall sensor 1253b may not overlap each other in the horizontal direction (Y-axis direction).

Referring to FIG. 12L, when the first blocking member is not present, an output of the first Hall sensor is affected by the first magnet when no current flows through the first coil and thus may linearly vary depending on a moving distance (or a stroke).

In addition, the output of the first Hall sensor may be affected by the first magnet and the first coil when a current flows through the first coil and thus may increase compared to a case in which no current flows. In other words, the amount of flux detected by the first Hall sensor in a case in which a current flows may be greater than that of a case in which no current flows (A>B). In other words, a malfunction of the first Hall sensor may be caused by the first coil.

Referring to FIG. 12M, when the first blocking member is present, the output of the first Hall sensor is affected by the first magnet when no current flows through the first coil and thus may linearly vary depending on the moving distance (or the stroke).

In addition, the output of the first Hall sensor may be affected by the first magnet and the first coil when the current flows through the first coil and thus may be similar to or the same as the case in which no current flows. In other words, the occurrence of the malfunction of the first Hall sensor due to the first coil can be reduced by the blocking member.

Referring to FIG. 12N, the above description of the first coil, the second coil, the first Hall sensor unit, the first blocking member, and the second blocking member except for the following description may be applied to a first coil, a second coil, a first Hall sensor unit, a first blocking member, and a second blocking member according to another embodiment in the same manner.

In an embodiment, the first Hall sensor 1253a and the second Hall sensor 1253b may be disposed to at least partially overlap each other in the horizontal direction (Y-axis direction). Furthermore, the second sub-coil SC2a and the fourth sub-coil SC2b may overlap each other in the horizontal direction. In addition, the first blocking member BM1 may be disposed on the inner surface of the second sub-coil SC2a. In addition, the second blocking member BM2 may be disposed on the inner surface of the fourth sub-coil SC2b. Therefore, the first blocking member BM1 and the second blocking member BM2 may overlap each other in the horizontal direction (Y-axis direction). Therefore, the influence of the magnetic force generated by the second sub-coil SC2a on the first Hall sensor 1253a can be minimized by the first blocking member BM1. In addition, the influence of the magnetic force generated by the fourth sub-coil SC2b on the second Hall sensor 1253b can be minimized by the second blocking member BM2.

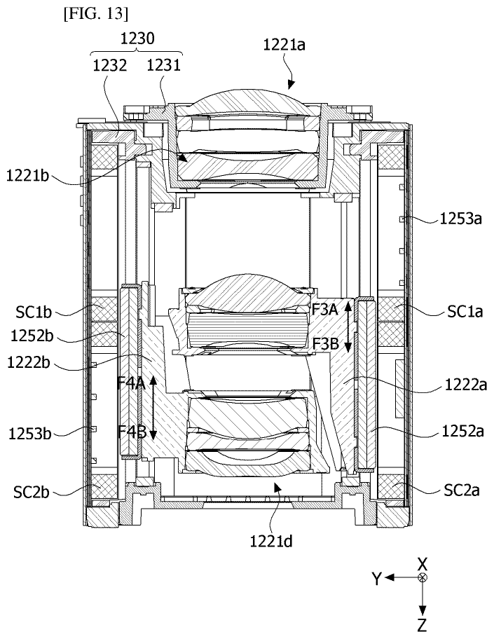

FIG. 13 is a view for describing the driving of the second camera actuator according to the embodiment.

Referring to FIG. 13, in the camera device according to the embodiment, the first optical driving unit may provide driving forces F3A, F3B, F4A, and F4B for moving the first lens assembly 1222a and the second lens assembly 1222b of the lens unit 1220 in the third direction (Z-axis direction). As described above, the first optical driving unit may include the first optical driving coil 1251 and the first optical driving magnet 1252. In addition, the lens unit 1220 may move in the third direction (Z-axis direction) by the electromagnetic force formed between the first optical driving coil 1251 and the first optical driving magnet 1252.

At this time, the first coil 1251a and the second coil 1251b may be disposed in the holes formed in the side portions (e.g., the first side portion and the second side portion) of the second housing 1230. In addition, the second coil 1251b may be electrically connected to the first board 1271. The first coil 1251a may be electrically connected to the second board 1272. Therefore, the first coil 1251a and the second coil 1251b may receive a driving signal (e.g., a current) from a driving driver on the circuit board of the circuit board 1300 through the second board unit 1270.

At this time, the first lens assembly 1222a on which the first magnet 1252a is seated may move in the third direction (Z-axis direction) by the electromagnetic forces F3A and F3B between the first coil 1251a and the first magnet 1252a. In addition, the second lens group 1221b seated on the first lens assembly 1222a may also move in the third direction.

In addition, the second lens assembly 1222b on which the second magnet 1252b is seated may move in the third direction (Z-axis direction) by the electromagnetic forces F4A and F4B between the second coil 1251b and the second magnet 1252b. In addition, the third lens group 1221c seated on the second lens assembly 1222b may also move in the third direction.

Therefore, as described above, the focal length or magnification of the optical system may be changed by moving the second lens group 1221b and the third lens group 1221c. In an embodiment, the magnification may be changed by moving the second lens group 1221b. In other words, zooming may be performed. In addition, the focus may be adjusted by moving the third lens group 1221c. In other words, an AF function may be performed. With this configuration, the second camera actuator may be a fixed zoom actuator or a continuous zoom actuator.

Furthermore, the first Hall sensor 1253a and the second Hall sensor 1253b may be disposed in the sub-coils of at least one of the first coil and the second coil. For example, the first Hall sensor 1253a and the second Hall sensor 1253b may also overlap each other in the second direction. For example, the first Hall sensor 1253a and the second Hall sensor 1253b may be positioned in overlapping or facing sub-coils in the second direction. As described above, since the first Hall sensor 1253a and the second Hall sensor 1253b are disposed so as not to overlap each other in the second direction, it is possible to prevent the magnetic force generated by the magnet from being transmitted to the Hall sensor on the other side rather than the Hall sensor facing each other. For example, it is possible to easily block the magnetic force generated by the first magnet from being provided to the second Hall sensor by the second magnet, the second lens assembly, and the like. Therefore, the Hall sensor can be accurately driven, and the interference with the restoring force of the lens assembly can also be reduced.

Alternatively, the first Hall sensor 1253a and the second Hall sensor 1253b may partially overlap in the second direction. Alternatively, the first Hall sensor 1253a and the second Hall sensor 1253b may not overlap each other in the second direction.

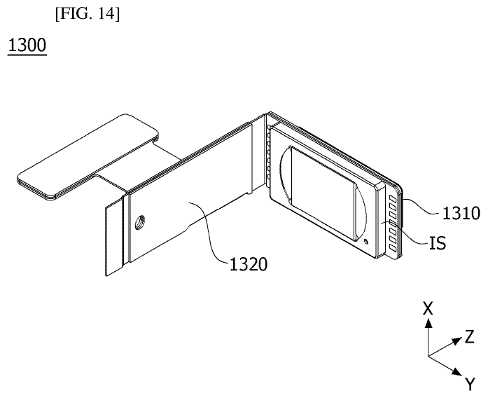

FIG. 14 is a schematic diagram showing a circuit board according to an embodiment.

Referring to FIG. 14, as described above, the circuit board 1300 according to the embodiment may include a first circuit board unit 1310 and a second circuit board unit 1320. The first circuit board unit 1310 may be positioned under and coupled to the base. In addition, the image sensor IS may be disposed on the first circuit board unit 1310. In addition, the first circuit board unit 1310 and the image sensor IS may be electrically connected.

In addition, the second circuit board unit 1320 may be positioned on a side portion of the base. In particular, the second circuit board unit 1320 may be positioned on a first side portion of the base. Therefore, the second circuit board unit 1320 may be positioned adjacent to the first coil positioned adjacent to the first side portion so that electrical connection may be easily made.

Furthermore, the circuit board 1300 may further include a fixed board (not shown) positioned on a side surface thereof. Therefore, even when the circuit board 1300 is made of a flexible material, the circuit board 1300 may be coupled to the base while maintaining stiffness by the fixed board.

The second circuit board unit 1320 of the circuit board 1300 may be positioned on a side portion of the first optical driving unit 1250. The circuit board 1300 may be electrically connected to the second optical driving unit and the first optical driving unit. For example, the electrical connection may be made by the SMT. However, the present disclosure is not limited to this method.

The circuit board 1300 may include a circuit board having line patterns that may be electrically connected, such as an RPCB, an FPCB, and an RFPCB. However, the present disclosure is not limited to these types.

In addition, the circuit board 1300 may be electrically connected to another camera module in the terminal or a processor of the terminal. Therefore, the camera actuator and the camera device including the above-described camera actuator may transmit and receive various signals within the terminal.

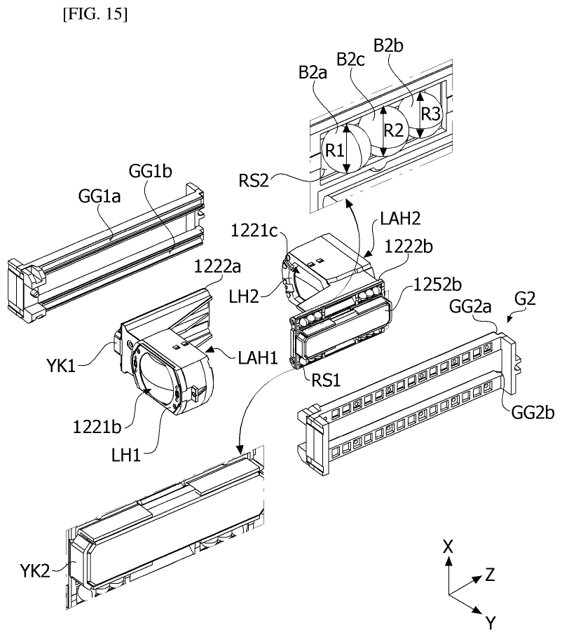

FIG. 15 is a perspective view of some components of the second camera actuator according to the embodiment.

Referring to FIG. 15, the first lens assembly 1222a and the second lens assembly 1222b may be disposed to be spaced apart from each other in the optical axis direction (Z-axis direction). In addition, the first lens assembly 1222a and the second lens assembly 1222b may move in the optical axis direction (Z-axis direction) by the first optical driving unit. For example, an AF or zooming function may be performed by moving the first lens assembly 1222a and the second lens assembly 1222b.

In addition, the first lens assembly 1222a may include a first lens holder LAH1 holding and coupling the second lens group 1221b. The first lens holder LAH1 may be coupled to the second lens group 1221b. In addition, the first lens holder LAH1 may include a first lens hole LH1 for accommodating the second lens group 1221b. In other words, the second lens group 1221b including at least one lens may be disposed in the first lens hole LH1. The first guide unit G1 may be disposed to be spaced apart from one side of the first lens holder LAH1. For example, the first guide unit G1 and the first lens holder LAH1 may be sequentially disposed in the second direction (Y-axis direction).

The second lens assembly 1222b may include a second lens holder LAH2 holding and coupling the third lens group 1221c. In addition, the second lens holder LAH2 may include a second lens hole LH2 for accommodating the third lens group 1221c. In addition, at least one lens may be disposed in the second lens hole LH2.

The second guide unit G2 may be disposed on the other side of the second lens holder LAH2. The second guide unit G2 may be disposed opposite to the first guide unit G1.

In an embodiment, the first guide unit G1 and the second guide unit G2 may at least partially overlap in the second direction (Y-axis direction). With this configuration, it is possible to space efficiency of the first optical driving unit for moving the first and second lens assemblies in the second camera actuator, and thus the second camera actuator can be easily miniaturized.

In addition, the second guide unit G2 and the second lens holder LAH2 may be sequentially disposed in the direction opposite to the second direction (Y-axis direction).

As described above, the first ball, the first coil, and the like may be disposed in the first guide unit G1, and as described above, the second ball, the second coil, and the like may be disposed in the second guide unit G2.

In addition, according to the embodiment, each of the first and second lens assemblies 1222a and 1222b may include yokes YK1 and YK2 disposed on the side surfaces thereof.

The first yoke YK1 may be positioned on a side surface of the first lens assembly 1222a. The second yoke YK2 may be positioned on a side surface of the second lens assembly 1222b. At least some of the first yoke YK1 and the second yoke YK2 may extend outward. Therefore, the first yoke YK1 may surround at least a portion of a side surface of the first magnet 1252a. As shown, the first yoke YK1 may be formed in various structures surrounding the inner surface and a portion of the side surface of the first magnet 1252a. For example, the first yoke YK1 may be formed of divided members, and each divided member may be positioned on the inner surface and side surface of the first magnet 1252a. Therefore, it is possible to improve a coupling force between the first optical driving magnet magnetized in a unipolar fashion and the yoke. Likewise, the second yoke YK2 may surround at least a portion of a side surface of the second magnet 1252b. As shown, the second yoke YK2 may be formed in various structures surrounding the inner surface and a portion of the side surface of the second magnet 1252b. For example, the second yoke YK2 may be formed of divided members, and each divided member may be positioned on the inner surface and the side surface of the second magnet 1252b.

Furthermore, the yokes may be positioned to be coupled to the first optical driving coil as well as the first optical driving magnet.

In addition, a plurality of balls may be positioned on the outer surface of the lens assembly. As described above, the first ball B1 may be positioned on the outer surface of the first lens assembly 1222a. The second ball B2 may be positioned on the outer surface of the second lens assembly 1222b.

A plurality of first balls B1 and second balls B2 may be provided. For example, the plurality of first balls B1 may be disposed side by side in one recess of the first lens assembly 1222a in the optical axis direction (Z-axis direction). In addition, the plurality of second balls B2 may be disposed side by side in one recess of the second lens assembly 1222b in the optical axis direction (Z-axis direction).

For example, the second ball B2 may include a first sub-ball B2a, a second sub-ball B2b, and a third sub-ball B2c. The first sub-ball B2a, the second sub-ball B2b, and the third sub-ball B2c may be disposed side by side in the optical axis direction. Therefore, the first sub-ball B2a, the second sub-ball B2b, and the third sub-ball B2c may at least partially overlap each other in the optical axis direction.

In addition, the first sub-ball B2a and the second sub-ball B2b may be positioned at outer sides among the plurality of balls. The third sub-ball B2c may be positioned between the first sub-ball B2a and the second sub-ball B2b.

The plurality of balls may have the same diameter or different diameters. For example, at least some of the first sub-ball B2a, the second sub-ball B2b, and the third sub-ball B2c may have the same diameters R1, R3, and R2. In addition, the first sub-ball B2a, the second sub-ball B2b, and the third sub-ball B2c may have different diameters R1, R3, and R2.

In an embodiment, the diameters R1 and R3 of the balls (first and second sub-balls) positioned at the outer sides may be smaller than the diameter R2 of the ball (third sub-ball) positioned at an inner side among the plurality of balls. For example, the diameters R1 and R3 of the first sub-ball B2a and the second sub-ball B2b may be smaller than the diameter R2 of the third sub-ball B2c. With this configuration, the lens assembly may be accurately moved by the plurality of balls without tilting to one side.

In addition, as described above, the first optical driving magnet may be provided as a plurality of first optical driving magnets and formed of the first magnet and the second magnet. In addition, the first magnet and the second magnet may be opposite to each other, and the same pole may be disposed outside. In other words, the first surface (outer surface) of the first magnet and the first surface (outer surface) of the second magnet may have the first pole. In addition, the second surface (inner surface) of the first magnet and the second surface (inner surface) of the second magnet may have the second pole.

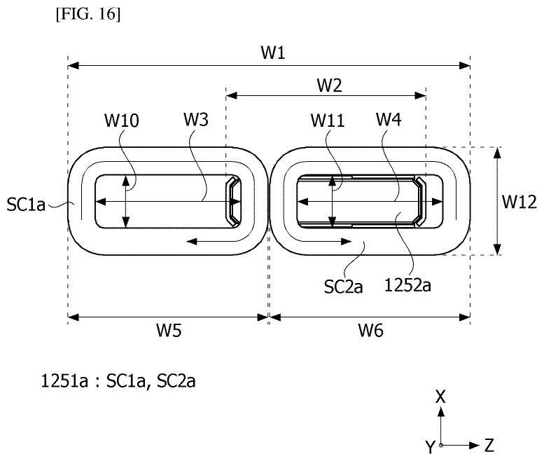

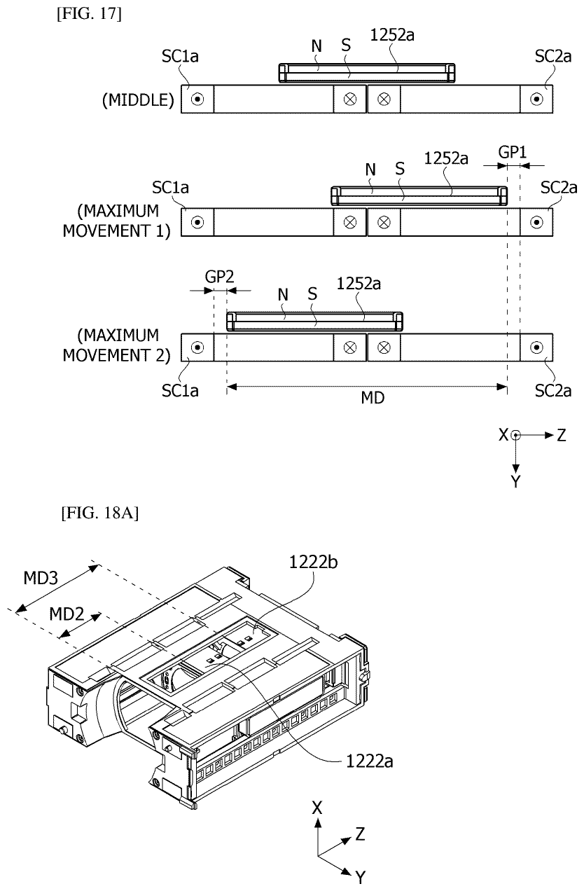

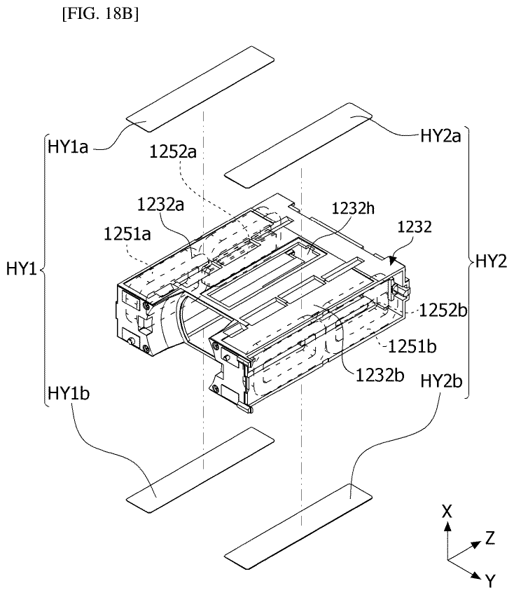

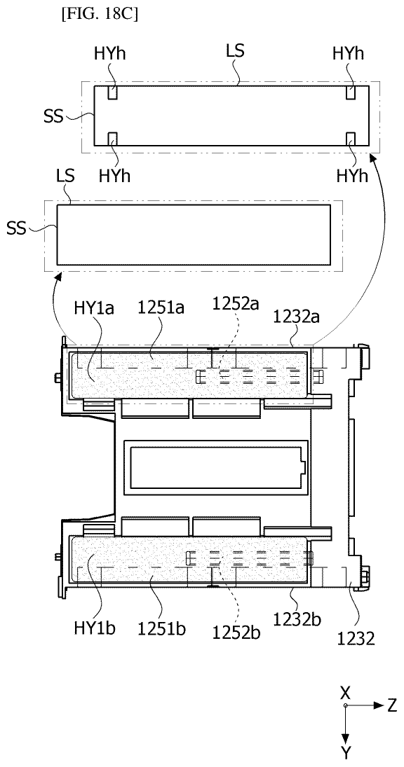

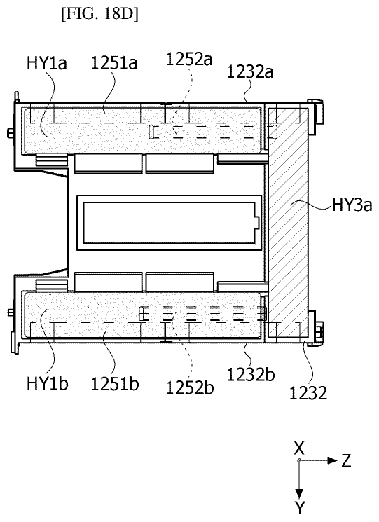

FIG. 16 is a view showing a first optical driving coil, a first optical driving magnet, and a yoke according to an embodiment, FIG. 17 is a view describing the movement of the first optical driving magnet by a first driving unit according to an embodiment, FIG. 18A is a view for describing the movement of the second and third lens assemblies according to the embodiment, FIG. 18B is an exploded perspective view of the second housing and the housing yoke according to the embodiment, FIG. 18C is a view of the second housing and the housing yoke according to the embodiment, and FIG. 18D is a view of a second housing and a housing yoke according to a modified example.

Referring to FIGS. 16 to 18A, a length W5 of the first sub-coil SC1a in the optical axis direction (Z-axis direction) may be the same as a length W6 of the second sub-coil SC2a in the optical axis direction (Z-axis direction). With this configuration, driving force control may easily be performed by the first sub-coil SC1a and the second sub-coil SC2a.

In addition, a total length W1 (or a maximum length) of the first optical driving coil in the optical axis direction (Z-axis direction) may be greater than a length W2 (maximum length W2) of the first optical driving magnet 1252a in the optical axis direction (Z-axis direction). With this configuration, a stroke may be maximally performed by the first optical driving magnet. Furthermore, a long stroke may be performed by the first optical driving magnet of unipolar magnetization.

In addition, in an embodiment, a maximum moving distance MD of the first lens assembly in the optical axis direction may be greater than a length W10 of a hole (or a hollow) of the first sub-coil SC1a in a short axis direction (first direction) and may be smaller than or equal to a length W3 of a hole (or a hollow) of the first sub-coil SC1a in a long axis direction (optical axis direction or third direction).

In addition, the maximum moving distance MD of the first lens assembly may be greater than a length of a hole (or hollow) of the second sub-coil SC2a in the short axis direction (first direction) and smaller than or equal to a length W4 of the hole (or hollow) of the second sub-coil SC2a in the long axis direction (optical axis direction or third direction).

In addition, in an embodiment, a maximum moving distance MD3 of the second lens assembly in the optical axis direction may be greater than a length of a hole (or hollow) of the third sub-coil SC1b in the short axis direction (first direction) and smaller than or equal to the length of the hole (or hollow) of the third sub-coil SC1b in the long axis direction (optical axis direction or third direction).

In addition, the maximum moving distance MD3 of the second lens assembly may be greater than the length of the hole (or hollow) of the fourth sub-coil SC2b in the short axis direction (first direction) and smaller than or equal to the length of the hole (or hollow) of the fourth sub-coil SC2b in the long axis direction (optical axis direction or third direction).

Furthermore, the length W3 of an inner hole of the first sub-coil SC1a in the optical axis direction may be the same as the length W4 of an inner hole of the second sub-coil SC2a in the optical axis direction.

In addition, the length W2 of the driving magnet 1252a in the optical axis direction (Z-axis direction) may be greater than the length W3 of the inner hole of the first sub-coil SC1a in the optical axis direction. In addition, the length W2 of the driving magnet 1252a in the optical axis direction (Z-axis direction) may be greater than the length W4 of the inner hole of the second sub-coil SC2a in the optical axis direction. Therefore, the first optical driving magnet may move in the optical axis within the entire length of the first optical driving coil in the optical axis direction.

A maximum length (or width, W11) of the first driving magnet in the short axis direction (or the first direction) may be smaller than a maximum length (or width, W12) of the first driving coil in the short axis direction (or first direction). In this case, the maximum length of the first driving coil in the short axis direction (or the first direction) may correspond to a distance between outermost circumferences of the first driving coil separated in the first direction.

In addition, in an embodiment, the hollow (or hole) of one coil of the first optical driving coil may have a length in the optical axis direction that is greater than a length in the short axis direction or the first direction. For example, the length W3 of the hole (or hollow) of the first sub-coil SC1a in the long axis direction (optical axis direction or third direction) may be greater than the length W10 of the hole (or the hollow) of the first sub-coil SC1a in the short axis direction. In addition, a horizontal length (or a width) of the hollow of the sub-coil may be greater than a vertical length (or a length).

In addition, the length W2 of the first optical driving magnet (or the first and second driving magnets) in the optical axis direction (Z-axis direction) may be greater than the lengths W3 and W4 of one of the hollows (or the holes) of each sub-coil (first sub-coil to fourth sub-coil) in the optical axis direction.

The length W2 of the first optical driving magnet (or the first and second driving magnets) in the optical axis direction (Z-axis direction) may be smaller than a length or a range W7 from one side the inner hole of the first sub-coil SC1a to the other side of the inner hole of the second sub-coil SC2a. Here, one side and the other side of the sub coil refer to ends in opposite directions in the optical axis direction.

The length W2 of the first optical driving magnet (or the first and second driving magnets) in the optical axis direction (Z-axis direction) may be smaller than a length or a range W8 from one side of the inner hole of the first sub-coil SC1a to one side of the inner hole of the second sub-coil SC2a.

Furthermore, the length W2 of the first optical driving magnet (or the first and second driving magnets) in the optical axis direction (Z-axis direction) may be smaller than a length or a range W9 from one side of the inner hole of the first sub-coil SC1a to one side of the inner hole of the second sub-coil SC2a.

The length W2 (maximum length) of the first optical driving magnet in the optical axis direction (Z-axis direction) may be smaller than the length W5 of the first sub-coil SC1a in the optical axis direction (Z-axis direction).

With this configuration, no counter electromotive force is generated in the movement of the lens assembly in the optical axis direction, and a long stroke can be implemented.

The length (maximum length, W2) of the first optical driving magnet (or the first and second driving magnets) in the optical axis direction (Z-axis direction) may be 0.6 times or less the maximum length W1 of the corresponding first driving coil in the optical axis direction. Preferably, the length (maximum length, W2) of the first optical driving magnet (or the first and second driving magnets) in the optical axis direction (Z-axis direction) may be 0.55 times or less the maximum length W1 of the corresponding first driving coil in the optical axis direction. More preferably, the length (maximum length, W2) of the first optical driving magnet (or the first and second driving magnets) in the optical axis direction (Z-axis direction) may be 0.5 times or less the maximum length W1 of the corresponding first driving coil in the optical axis direction. Therefore, the camera device can provide the long stroke in a state in which the counter electromotive force is minimized.

The maximum moving distance MD of the first lens assembly in the optical axis direction may be smaller than the length (maximum length, W2) of the first optical driving magnet (or the first and second driving magnets) in the optical axis direction (Z-axis direction). For example, the maximum moving distance MD of the first lens assembly in the optical axis direction may be in the range of 0.66 times or more or 0.92 times or less the length (maximum length, W2) of the first optical driving magnet (or the first and second driving magnets) in the optical axis direction (Z-axis direction). Preferably, the maximum moving distance MD of the first lens assembly in the optical axis direction may be in the range of 0.7 times or more or 0.9 times or less the length (maximum length, W2) of the first optical driving magnet (or the first and second driving magnets) in the optical axis direction (Z-axis direction). More preferably, the maximum moving distance MD of the first lens assembly in the optical axis direction may be in the range of 0.74 times or more or 0.88 times or less the length (maximum length, W2) of the first optical driving magnet (or the first and second driving magnets) in the optical axis direction (Z-axis direction). Therefore, it is possible to maximally suppress the generation of the counter electromotive force.

In addition, in an embodiment, the total length W1 (or the maximum length) of the first optical driving coil in the optical axis direction (Z-axis direction) may be in the range of 18 mm to 20 mm. Furthermore, the length W2 of the first optical driving magnet in the optical axis direction (Z-axis direction) may be in the range of 8 mm to 12 mm. In addition, the length W3 of the hole (or the hollow) of the first sub-coil SC1a in the long axis direction (optical axis direction or third direction) may be in the range of 5.6 mm to 8.7 mm. In addition, the length W4 of the hole (or the hollow) of the second sub-coil SC2a in the long axis direction (optical axis direction or third direction) may be in the range of 5.6 mm to 8.7 mm.

The length W5 of the first sub-coil SC1a in the optical axis direction (Z-axis direction) may be in the range of 8 mm to 10 mm. However, as described above, the length W5 of the first sub-coil SC1a in the optical axis direction (Z-axis direction) may be greater than or equal to the length W2 of the first optical driving magnet in the optical axis direction (Z-axis direction).

In addition, the length W6 of the second sub-coil SC2a in the optical axis direction (Z-axis direction) may be in the range of 8 mm to 10 mm. However, as described above, the length W5 of the second sub-coil SC2a in the optical axis direction (Z-axis direction) may be greater than or equal to the length W2 of the first optical driving magnet in the optical axis direction (Z-axis direction).

The length W7 from the one side of the inner hole of the first sub-coil SC1a to the other side of the inner hole of the second sub-coil SC2a may be in the range of 13.6 mm to 20.7 mm.

The length or range W8 from the one side of the inner hole of the first sub coil SC1a to one side of the inner hole of the second sub coil SC2a may be in the range of 8 mm to 12 mm. In addition, the length or range W8 from the one side of the inner hole of the first sub-coil SC1a to one side of the inner hole of the second sub-coil SC2a may be greater than or equal to the length W2 of the first optical driving magnet in the optical axis direction (Z-axis direction).

The length or range W9 from the one side of the inner hole of the first sub-coil SC1a to the one side of the inner hole of the second sub-coil SC2a may be in the range of 8 mm to 12 mm. The length or range W9 from the one side of the inner hole of the first sub-coil SC1a to the one side of the inner hole of the second sub-coil SC2a may be greater than or equal to the length W2 of the first optical driving magnet in the optical axis direction (Z-axis direction).

In addition, according to the unipolar magnetization of the first optical driving magnet, currents may flow in the first sub-coil SC1a and the second sub-coil SC2a in different directions. For example, the current may flow in one of clockwise and counterclockwise directions in the first sub-coil SC1a, and the current may flow in the other of the clockwise and counterclockwise directions in the second sub-coil SC2a.

Furthermore, the length W2 of the first optical driving magnet in the optical axis direction (Z-axis direction) may be greater than the moving distances MD2 and MD3 of the lens assembly in the optical axis direction. In other words, the length W2 of the first optical driving magnet in the optical axis direction (Z-axis direction) may be greater than the maximum moving distance of the first lens assembly or the maximum moving distance of the second lens assembly. With this configuration, a driving force for the movement in the optical axis direction can be safely provided.

The first optical driving magnet (e.g., the first magnet 1252a) may move in the range W7 from the one side of the inner hole of the first sub-coil SC1a to the other side of the inner hole of the second sub-coil SC2a in the optical axis direction (Z-axis direction). In other words, the first optical driving magnet may move in the optical axis direction of the hole in the second optical driving coil within the maximum range MD in the optical axis direction.

In addition, as described above, a plurality of lens assemblies may be provided, and a lens assembly disposed on a rear end among the plurality of lens assemblies may have a greater moving distance in the optical axis direction than a lens assembly disposed on a front end among the plurality of lens assemblies.

For example, the moving distance MD2 of the first lens assembly 1222a in the optical axis direction (Z-axis direction) may be smaller than the moving distance MD3 of the second lens assembly 1222b in the optical axis direction (Z-axis direction). In other words, the moving distance of the second lens assembly 1222b in the optical axis direction may be greater than the moving distance of the first lens assembly 1222a in the optical axis direction. The first lens assembly 1222a may be positioned on a front end of the second lens assembly 1222b.

In addition, in the camera actuator according to the embodiment, the first optical driving magnet 1252a may move from “center” to “maximum movement 1” or “maximum movement 2.” Here, in the case of “center,” the first optical driving magnet 1252a may overlap the first sub-coil SC1a and the second sub-coil SC2a in the second direction. In other words, both of the first sub-coil SC1a and the second sub-coil SC2a may face the first optical driving magnet.

In addition, since the first sub-coil SC1a and the second sub-coil SC1b are coils extending in the first direction actually providing the driving force by the electromagnetic force, the region where the first sub-coil SC1a and the first optical driving magnet 1252a overlap may be the same as the region where the second sub-coil SC2a and the first optical driving magnet 1252a overlap. Therefore, it is possible to minimize the generation of the counter electromotive force, thereby implementing the long stroke.

In addition, “maximum movement 1” may correspond to a case in which the first optical driving magnet 1252a maximally moves in the direction opposite to the third direction (Z-axis direction). In this case, the first optical driving magnet 1252a may have a region overlapping the first sub-coil SC1a greater than a region overlapping the second sub-coil SC2a. Furthermore, at least a portion of the first optical driving magnet 1252a may overlap the inner hole of the first sub-coil SC1a. More specifically, the first optical driving magnet 1252a may be spaced a predetermined separation distance GP2 from the edge of the inner hole of the first sub-coil SC1a in the optical axis direction. With this configuration, it is possible to reduce the counter electromotive force generated on the end of the first sub-coil SC1a. For example, the first optical driving magnet 1252a may move to a region not overlapping the end of the first sub-coil SC1a in the direction opposite to the optical axis direction in the second direction (Y-axis direction) with a maximum stroke.

In addition, “maximum movement 2” may correspond to a case in which the first optical driving magnet 1252a maximally moves in the third direction (Z-axis direction). In this case, the first optical driving magnet 1252a may have a region overlapping the second sub-coil SC2a greater than a region overlapping the first sub-coil SC1a. Furthermore, at least a portion of the first optical driving magnet 1252a may overlap the inner hole of the second sub-coil SC2a. More specifically, the first optical driving magnet 1252a may be spaced the predetermined separation distance GP2 from the edge of the inner hole of the second sub-coil SC2a in the optical axis direction. With this configuration, it is possible to reduce the counter electromotive force generated on the end of the second sub-coil SC2a. For example, the first optical driving magnet 1252a may move to a region not overlapping the end of the second sub-coil SC2a in the optical axis direction in the second direction (Y-axis direction) with a maximum stroke.

Therefore, even when the length of the first optical driving magnet 1252a in the direction of the optical axis is small, it is possible to efficiently implement the long stroke of the camera actuator through the unipolar magnetization and the current directions of the plurality of first optical driving coils.

In addition, the maximum moving distance of the first optical driving magnet 1252a may correspond to the lengths of the first and second recesses accommodating the first ball or the second ball in the above-described first lens assembly in the optical axis direction. In addition, the maximum moving distance of the first optical driving magnet 1252a may correspond to a moving distance of the first optical driving magnet 1252a from the maximum movement 1 to the maximum movement 2 in the optical axis direction (Z-axis direction). Alternatively, the maximum moving distance of the first optical driving magnet 1252a may correspond to a distance between stoppers for restricting the movement of the first ball or the second ball in the optical axis direction. Alternatively, the maximum moving distance of the first optical driving magnet 1252a is a maximum distance that the bobbin may move and may correspond to the separation distance in the optical axis direction between a stopper positioned in the optical axis direction with respect to the bobbin and a stopper positioned in the direction opposite to the optical axis direction.

In addition, the maximum moving distance of the first optical driving magnet 1252a may correspond to twice the distance moving from the center to the maximum movement 1. In addition, the moving distance of the first optical driving magnet 1252a according to the embodiment may be in the range of −4 mm to +4 mm with respect to the center. Specifically, the moving distance of the first optical driving magnet 1252a may be in the range of −3.8 mm to +3.8 mm with respect to the center. More specifically, the moving distance of the first optical driving magnet 1252a may be in the range of −3.5 mm to +3.5 mm with respect to the center. Here, the moving distance from the center in the optical axis direction is denoted by “+,” and a direction opposite to the optical axis direction is denoted by “-.” Therefore, the first optical driving magnet 1252a (or at least one of the first lens assembly and the second lens assembly) according to the embodiment may move in the range of 0 mm to 12 mm in the optical axis direction. In addition, the above-described maximum moving distance may correspond to the maximum stroke of the lens assembly in the camera module.

Referring to FIGS. 18B and 18C, the second housing 1230 (particularly, the 2-2 housing 1232) may include a housing opening 1232h disposed in an upper surface thereof. At least a portion of the first lens assembly and at least a portion of the second lens assembly may be exposed to the outside by the housing opening 1232h. In particular, the first mark of the first lens assembly and the second mark of the second lens assembly may be exposed through the housing opening 1232h. Therefore, as described above, it is possible to easily inspect whether the movement of the first lens assembly or the second lens assembly is accurately performed through vision recognition.

The first housing yoke HY1 and the second housing yoke HY2 may be disposed on at least one of the upper surface and the lower surface of the second housing 1230 (in particular, the 2-2 housing 1232).

The first housing yoke HY1 and the second housing yoke HY2 may be disposed outside the housing opening 1232h.

Furthermore, the first housing yoke HY1 may include a 1-1 housing yoke HY1a disposed on an upper portion thereof and a 1-2 housing yoke HY1b disposed on a lower portion thereof. In addition, the second housing yoke HY2 may include a 2-1 housing yoke HY2a disposed on an upper portion thereof and a 2-2 housing yoke HY2b disposed on a lower portion thereof.

In an embodiment, at least a portion of the first housing yoke HY1 may overlap the first coil 1251a and the first magnet 1252a in the vertical direction (X-axis direction).

In this case, the first housing yoke HY1 may have a portion not overlapping the first magnet 1252a according to the movement of the first magnet 1252a.

In addition, the first housing yoke HY1 may overlap the first coil 1251a in the vertical direction, and at least a portion of the first housing yoke HY1 may or may not overlap the first magnet 1252a in the vertical direction (X-axis direction).

With this configuration, the first housing yoke HY1 can prevent the magnetic force generated by the second magnet from being provided to the first Hall sensor in the first coil 1251a. Therefore, the first Hall sensor can be accurately driven.

Specifically, the first housing yoke HY1 may overlap an inner region of the first coil 1251a in the vertical direction. In other words, the first housing yoke HY1 may not overlap an outer region of the first coil 1251a in the vertical direction. In addition, an outermost surface of the first coil 1251a may not overlap the first housing yoke HY1 in the vertical direction. Alternatively, the outermost surface of the first coil 1251a may overlap the first housing yoke HY1 in the vertical direction. Therefore, the first housing yoke HY1 can easily block the magnetic force provided to the opposite side or the like. This may also be applied to the second housing yoke in the same manner.

In addition, the first housing yoke HY1 may overlap the first magnet 1252a in the vertical direction. For example, the first magnet 1252a moves in the optical axis direction, but the first housing yoke HY1 may have a predetermined length in the optical axis direction corresponding to the moving distance of the first magnet 1252a. For example, a length of the first housing yoke HY1 in the optical axis direction may be greater than a length of the first magnet 1252a in the optical axis direction. With this configuration, the influence of the magnetic force generated by the first magnet 1252a on the second Hall sensor, the second coil, or the like positioned on the opposite side can be suppressed by the first housing yoke HY1 even when the first magnet 1252a moves.

In an embodiment, at least a portion of the second housing yoke HY2 may overlap the second coil 1251b and the second magnet 1252b in the vertical direction (X-axis direction).

In this case, the second housing yoke HY2 may have a portion not overlapping the second magnet 1252b according to the movement of the second magnet 1252b.

In addition, the second housing yoke HY2 may overlap the second coil 1251b in the vertical direction, and at least a portion of the second housing yoke HY2 may or may not overlap the second magnet 1252b in the vertical direction (X-axis direction).

With this configuration, the second housing yoke HY2 can prevent the magnetic force generated by the first magnet from being provided to the second Hall sensor in the second coil 1251b. Therefore, the second Hall sensor can be accurately driven.

Specifically, the second housing yoke HY2 may overlap an inner region of the second coil 1251b in the vertical direction. In other words, the second housing yoke HY2 may not overlap an outer region of the second coil 1251b in the vertical direction. In addition, an outermost surface of the second coil 1251b may not overlap the second housing yoke HY2 in the vertical direction. Therefore, the second housing yoke HY2 can easily block the magnetic force or the like provided to the opposite side.

In addition, the second housing yoke HY2 may overlap the second magnet 1252b in the vertical direction. For example, the second magnet 1252b moves in the optical axis direction, but the second housing yoke HY2 may have a predetermined length in the optical axis direction corresponding to the moving distance of the second magnet 1252b. For example, a length of the second housing yoke HY2 in the optical axis direction may be greater than a length of the second magnet 1252b in the optical axis direction. With this configuration, the influence of the magnetic force generated by the second magnet 1252b on the second Hall sensor, the second coil, or the like positioned on the opposite side can be suppressed by the second housing yoke HY2 even when the second magnet 1252b moves.

In addition, a housing yoke groove HYh may be positioned on a long side portion LS or a short side portion SS of the housing yoke HY in order to easily perform the coupling with the second housing. For example, the housing yoke groove HYh may be positioned on at least one of the long side portion LS and the short side portion SS. However, in terms of ease of manufacture, the housing yoke groove HYh may be positioned on the long side portion LS. In addition, a plurality of housing yoke grooves HYh may be present and disposed to be spaced apart from each other.

Referring to FIG. 18D, the housing yoke HY according to another embodiment may further include a third housing yoke HY3 connecting the first housing yoke HY1 and the second housing yoke HY2. In addition, the third housing yoke HY3 may include a 3-1 housing yoke HY3a disposed on an upper portion thereof and a 3-2 housing yoke HY3b disposed on a lower portion thereof.

For example, the 3-1 housing yoke HY3a may be disposed between the 1-1 housing yoke HY1a and the 2-1 housing yoke HY2a. The 3-1 housing yoke HY3a may come into contact with the 1-1 housing yoke HY1a and the 2-1 housing yoke HY2a or may be disposed to be spaced apart by a predetermined distance from each other.

In addition, the third housing yoke may be disposed outside the housing opening. For example, the first housing yoke, the third housing yoke, and the second housing yoke may be disposed along an edge of the upper surface of the second housing.

As described above, the third housing yoke according to the embodiment can suppress the movement of the magnetic forces generated by the first magnet and the second magnet to the opposite side.

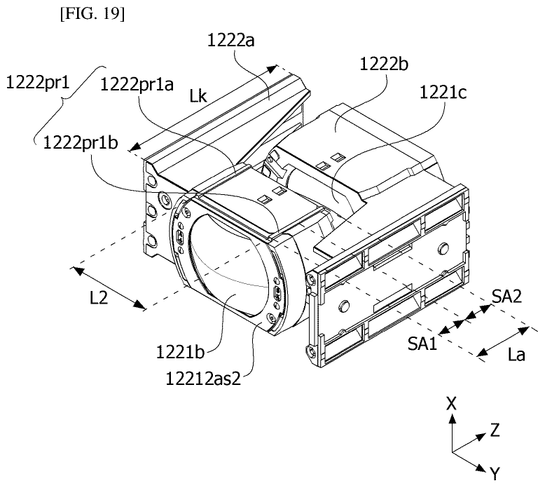

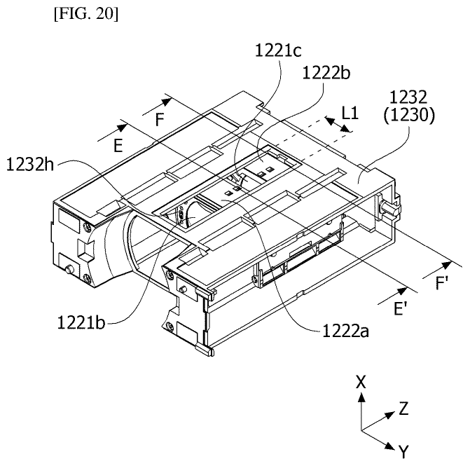

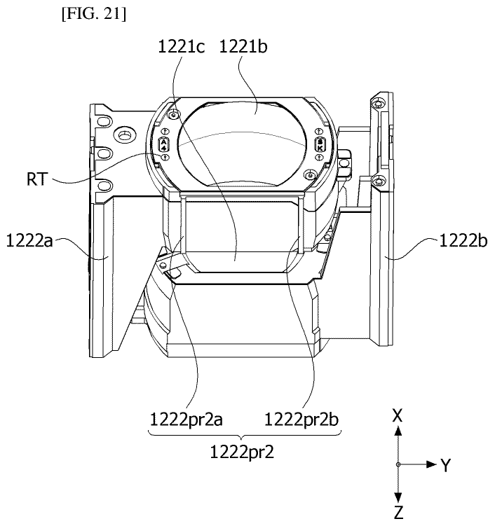

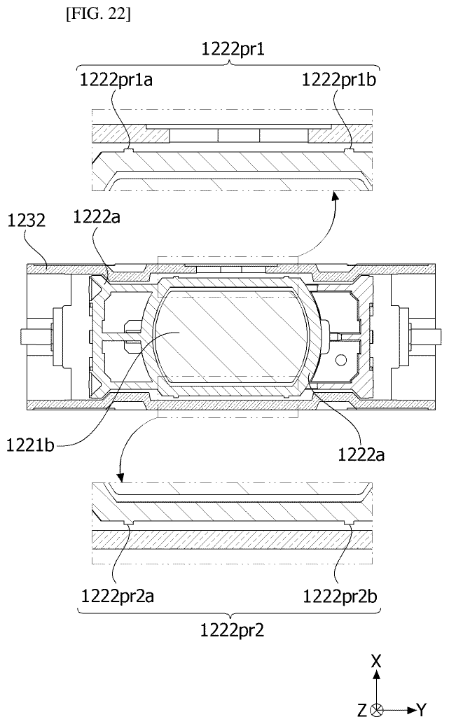

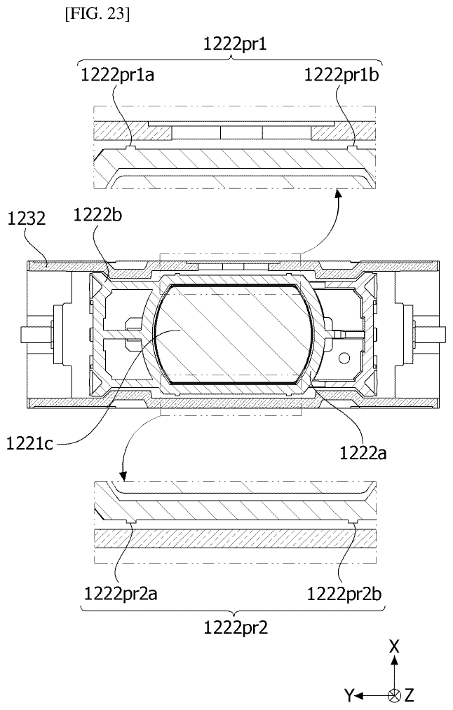

FIG. 19 is a perspective view of a first lens assembly, a second lens group, a second lens assembly, and a third lens group, FIG. 20 is a view showing the second housing added to FIG. 19, FIG. 21 is a view showing a bottom surface of FIG. 19, FIG. 22 is a cross-sectional view along line E-E′ in FIG. 20, and FIG. 23 is a cross-sectional view along line F-F′ in FIG. 20.

Referring to FIGS. 19 to 23, any one of the first lens assembly 1222a and the second housing (or the 2-2 housing) according to the embodiment may include protrusions protruding toward the other. In the embodiment, the following description will be given on the basis that the first lens assembly 1222a has protrusions or assembly protrusions 1222pr1 and 1222pr2. Furthermore, the protrusion is a protrusion on an outer surface (hereinafter referred to as “upper surface” or “lower surface”) of any one of the first lens assembly 1222a and the second housing (or the 2-2 housing) and may be formed integrally with any one of the first lens assembly 1222a and the second housing (or the 2-2 housing). In addition, the protrusion may be in a separate type from any one of the first lens assembly 1222a and the second housing (or the 2-2 housing). For example, the protrusion may include a poron or the like to absorb an impact.

The protrusion or the assembly protrusions 1222pr1 and 1222pr2 may extend in a direction perpendicular to the optical axis direction. For example, the protrusion or the assembly protrusions 1222pr1 and 1222pr2 may extend in the first direction or the vertical direction (X-axis direction). In this case, the first lens assembly 1222a may have an outer surface with respect to the lens hole into which the second lens group is inserted. The outer surface of the first lens assembly 1222a may include an upper surface 1222as1 that is a first side surface and a lower surface 1222as2 that is a second side surface, which are disposed in the vertical direction. The first side surface and the second side surface may be surfaces opposite to or corresponding to each other. Hereinafter, the following description will be given on the basis of the upper surface and the lower surface.

The upper surface 1222as1 and the lower surface 1222as2 of the first lens assembly 1222a may not have a curvature. In other words, the upper surface 1222as1 and the lower surface 1222as2 of the first lens assembly 1222a may be disposed parallel to a plane perpendicular to the vertical direction (X-axis direction). Furthermore, the first lens assembly 1222a may have a length in the horizontal direction (Y-axis direction) greater than a length in the vertical direction (X-axis direction). Therefore, the second lens group 1221b in the first lens assembly 1222a may have a length in the horizontal direction (Y-axis direction) greater than a length in the vertical direction (X-axis direction).

Furthermore, the 2-2 housing 1232 or the second housing 1230 according to the embodiment may include a housing opening 1232h disposed in an upper surface thereof. The housing opening 1232h may overlap in the vertical direction along the optical axis. In other words, the housing opening 1232h may be positioned above the optical axis.

At least a portion of the first lens assembly 1222a may be exposed through the housing opening 1232h. Likewise, at least a portion of the second lens assembly 1222b may be exposed through the housing opening 1232h. Therefore, a degree of the movement (e.g., a moving distance) of the first lens assembly 1222a and the second lens assembly 1222b in the optical axis direction may be recognized through vision recognition by each of the above-described first marker and second marker.

The first lens assembly 1222a may include a first protrusion or a first assembly protrusion 1222pr1 extending upward from the upper surface 1222as1. In addition, the first lens assembly 1222a may include a second protrusion or a second assembly protrusion 1222pr2 extending downward on the lower surface 1222as2. Hereinafter, the following description will be given on the basis of the first protrusion 1222pr1 and the second protrusion 1222pr2.

At least one of the first protrusion 1222pr1 and the second protrusion 1222pr2 may be disposed to be misaligned with the housing opening 1222h in the vertical direction (Y-axis direction). In other words, at least one of the first protrusion 1222pr1 and the second protrusion 1222pr2 may not overlap the housing opening 1222h in the vertical direction (Y-axis direction). In other words, the housing opening 1222h may be disposed between the first protrusion 1222pr1 and the second protrusion 1222pr2. With this configuration, the first protrusion 1222pr1 and the second protrusion 1222pr2 may not be exposed through the housing opening 1222h. Therefore, an impact between the first lens assembly 1222a and the second housing 1230 can be easily absorbed by the first protrusion 1222pr1 and the second protrusion 1222pr2. In other words, it is possible to protect the second lens group 1221b in the first lens assembly 1222a.

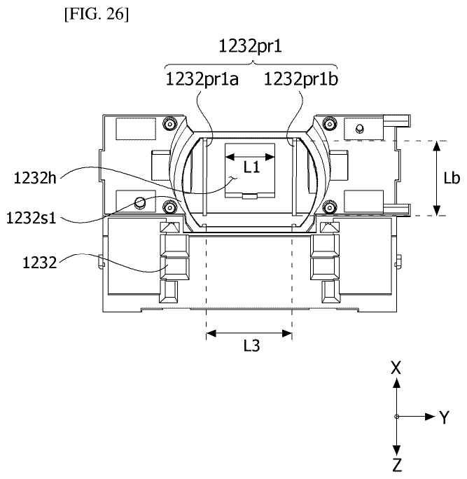

For example, the first protrusion 1222pr1 may not overlap the housing opening 1222h in the vertical direction (X-axis direction). Therefore, the first protrusion 1222pr1 may overlap the upper surface 1222as1 of the first lens assembly 1222a and a first inner surface 1232s1 (see FIG. 26) of the second housing 1230 facing the upper surface 1222as1 in the vertical direction, thereby easily absorbing the impact between the first lens assembly 1222a and the second housing 1230.

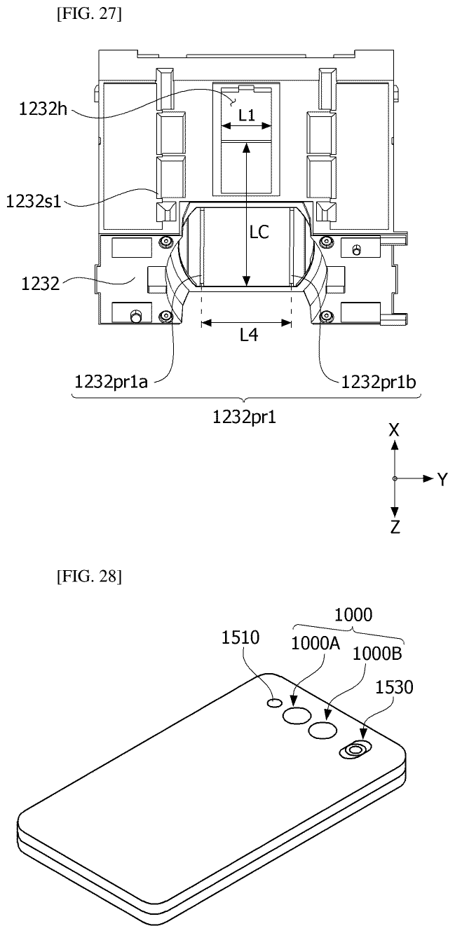

Furthermore, the second protrusion 1222pr2 may overlap the lower surface 1222as2 of the first lens assembly 1222a and a second inner surface 1232s2 (see FIG. 27) of the second housing 1230 facing the lower surface 1222as2 in the vertical direction. However, only a portion of the second protrusion 1222pr2 may or may not overlap the first protrusion 1222pr1 in the vertical direction (X-axis direction). Therefore, the second protrusion 1222pr2 may not overlap the housing opening 1232h in the vertical direction. With this configuration, it is possible to easily distribute the impact.

In addition, the first protrusion 1222pr1 may overlap the second protrusion 1222pr2 in the vertical direction (X-axis direction). With this configuration, it is possible to improve reliability against impact.

The first protrusion 1222pr1 may be disposed on the upper surface 1222as1 of the first lens assembly 1222a and may extend upward in the vertical direction. In addition, the second protrusion 1222pr2 may be disposed on the lower surface 1222as2 of the first lens assembly 1222a and may extend downward in the vertical direction.

In addition, in an embodiment, the first protrusion 1222pr1 may be disposed in a partial region of the upper surface 1222as1 of the first lens assembly 1222a. In addition, the second protrusion 1222pr2 may be disposed in a partial region of the lower surface 1222as2 of the first lens assembly 1222a.

The first lens assembly 1222a may include a first assembly region SA1 (or a front region) positioned in a front portion thereof and a second assembly region SA2 (or a rear region) positioned in a rear portion thereof. The first assembly region SA1 may be positioned closer to the first camera actuator or the 2-1 housing than the second assembly region SA2. In addition, the second assembly region SA2 may be positioned closer to the image sensor than the first assembly region SAL.

In this case, at least one of the first protrusion 1222pr1 and the second protrusion 1222pr2 may be disposed in the first assembly region SAL. For example, the first protrusion 1222pr1 may be disposed in the first assembly region SAL.

In an embodiment, the second lens group 1221b may be positioned in the first lens assembly 1222a as described above. In this case, the second lens group 1221b may include at least one lens. In addition, at least one lens may be made of glass. Furthermore, a glass lens among the at least one lens may be positioned on a foremost end in the second lens group 1221b.

Furthermore, the lens positioned on the foremost end of the at least one lens may protrude outward from the first lens assembly 1222a. In other words, the lens positioned on the foremost end may have a region disposed closer to the first camera actuator than the first lens assembly 1222a is.

In other words, the first protrusion 1222pr1 and the second protrusion 1222pr2 may be positioned to correspond to the lens. For example, the first protrusion 1222pr1 and the second protrusion 1222pr2 may be positioned to correspond to the lens made of a material such as glass. In other words, the first protrusion 1222pr1 and the second protrusion 1222pr2 may be positioned to overlap a specific lens in the vertical direction (X-axis direction).

With this configuration, since the first protrusion 1222pr1 is disposed in the first assembly region SA1, it is possible to easily protect the lens made of glass that is fragile.

Furthermore, a plurality of first protrusions 1222pr1 may be disposed to be spaced apart from each other in the horizontal direction (Y-axis direction) on the upper surface 1222as1 of the first lens assembly 1222a. For example, the first protrusion 1222pr1 may include a first sub-protrusion 1222pr1a and a second sub-protrusion 1222pr1b.

The first sub-protrusion 1222pr1a and the second sub-protrusion 1222pr1b may be disposed to be spaced apart from each other in the horizontal direction (Y-axis direction). For example, lengths L2 of the first sub-protrusion 1222pr1a and the second sub-protrusion 1222pr1b in the horizontal direction may be greater than a length L1 of the housing opening 1232h in the horizontal direction.

In addition, a length La of the first protrusion 1222pr1 in the optical axis direction may be smaller than a length La of the housing opening 1232h in the optical axis direction. The length La of the first protrusion 1222pr1 in the optical axis direction may correspond to a length of the first lens holder in the optical axis direction. Furthermore, the first lens assembly may include a first lens holder and a wing portion disposed on a side surface of the first lens holder. In addition, the wing portion may face the first guide unit. In this case, a length Lk of the wing portion in the optical axis direction may be greater than a length La of the first lens holder in the optical axis direction.

In addition, the second lens assembly 1222b may also include protrusions extending in the vertical direction. Therefore, the protrusion may be positioned on any one of the upper surface and lower surface of the second lens assembly 1222b. In other words, the above description of the first and second protrusions of the first lens assembly may also be applied to the second lens assembly in the same manner.

In addition, a first support member or a first retainer RT for supporting the second lens group 1221b may be positioned at a front end of the first lens assembly 1222a. In addition, a second support member or a second retainer for supporting the third lens group 1221c may be positioned on the rear end of the second lens assembly 1222b. Therefore, the first retainer RT can prevent the second lens group 1221b from being separated from the first lens assembly 1222a. In addition, the second retainer can prevent the third lens group 1221c from being separated from the second lens assembly 1222b.

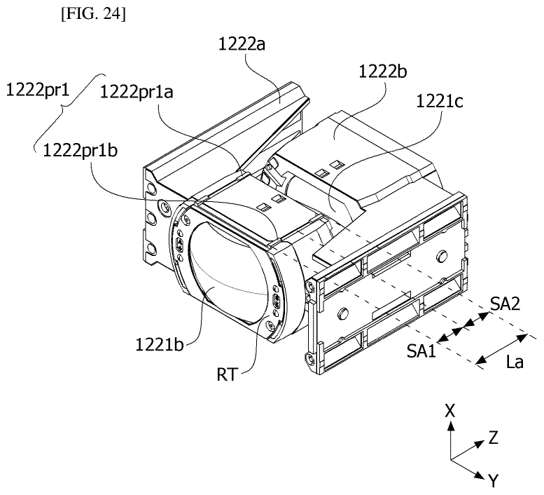

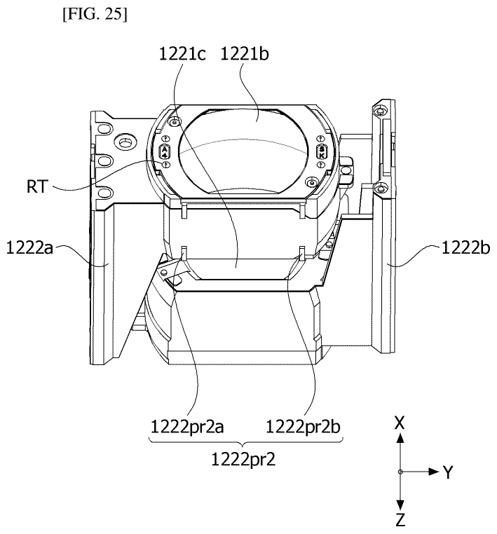

FIG. 24 shows modified examples of elements in FIG. 19, and FIG. 25 is a view showing bottom surfaces of elements in FIG. 24.

Referring to FIG. 24, the first protrusion 1222pr1 and the second protrusion 1222pr2 may extend in the vertical direction (Y-axis direction), and a plurality of first protrusions 1222pr1 and a plurality of second protrusions 1222pr2 may be present. For example, the plurality of first protrusions 1222pr1 may be disposed to be spaced apart from each other in the optical axis direction (Z-axis direction) or the horizontal direction (Y-axis direction) on the upper surface of the first lens assembly 1222a.

Furthermore, a plurality of first sub-protrusions 1222pr1a may be present. In addition, a plurality of second sub-protrusions 1222pr1b may be present. The plurality of first sub-protrusions 1222pr1a may be disposed to be spaced apart from each other in the optical axis direction (Z-axis direction) or the horizontal direction (Y-axis direction). In addition, the second sub-protrusions 1222pr1b may be disposed to be spaced apart from each other in the optical axis direction (Z-axis direction) or the horizontal direction (Y-axis direction).

This may also be applied to the second protrusion 1222pr2 in the same manner. For example, the second protrusion 1222pr2 may include a third sub-protrusion 1222pr2a and a fourth sub-protrusion 1222pr2b. In addition, a plurality of third sub-protrusions 1222pr2a may be disposed to be spaced apart from each other in the horizontal direction or the optical axis direction. A plurality of fourth sub-protrusions 1222pr2b may be disposed to be spaced apart from each other in the horizontal direction or the optical axis direction.

With this configuration, an impact may be transmitted through the plurality of first protrusions 1222pr1 and second protrusions 1222pr2. However, since a separation space between the first lens assembly 1222a and the second housing is reduced by heights of the first protrusion 1222pr1 and the second protrusion 1222pr2, the amount of impact between the first lens assembly and the second housing may also be reduced. Therefore, it is also possible to improve the reliability of the first lens assembly and the second lens group.

FIG. 26 is a perspective view of the second housing according to the embodiment, and FIG. 27 is a perspective view in a different direction of FIG. 26.

Referring to FIG. 26, the second housing 1230 according to the embodiment may include the housing opening 1232h in the upper surface thereof as described above.

Furthermore, the second housing 1230 may include a first protrusion or a first housing protrusion 1232pr1 vertically extending from the first inner surface 1232s1 facing the upper surface of the first lens assembly. The first housing protrusion 1232pr1 may extend downward. Furthermore, the first housing protrusion 1232pr1 may include a first sub-housing protrusion 1232pr1a and a second sub-housing protrusion 1232pr1b.

The first sub-housing protrusion 1232pr1a and the second sub-housing protrusion 1232pr1b may be disposed to be spaced apart from each other in the horizontal direction (Y-axis direction). A separation distance L3 between the first sub-housing protrusion 1232pr1a and the second sub-housing protrusion 1232pr1b in the horizontal direction may be greater than a length L1 of the housing opening 1232h in the horizontal direction. Therefore, it is possible to reduce the impact between the lens assembly and the housing independently of the inspection of the first lens assembly and the second lens assembly.

Furthermore, a length Lb or Lc of the first housing protrusion 1232pr1 or the second housing protrusion 1232pr2 in the optical axis direction may be greater than the length of the first lens assembly in the optical axis direction. In addition, the length Lb or Lc of the first housing protrusion 1232pr1 or the second housing protrusion 1232pr2 in the optical axis direction may be greater than the length Lk of the wing portion in the optical axis direction. In other words, the length Lb or Lc of the first housing protrusion 1232pr1 or the second housing protrusion 1232pr2 in the optical axis direction may be greater than a maximum length of the first lens assembly in the optical axis direction. In addition, the length Lb or Lc of the first housing protrusion 1232pr1 or the second housing protrusion 1232pr2 in the optical axis direction may be greater than the length of the first lens holder in the optical axis direction.

The length Lb or Lc of the first housing protrusion 1232pr1 or the second housing protrusion 1232pr2 in the optical axis direction may be greater than the length of the second lens assembly in the optical axis direction. With this configuration, the amount of the impact between the first and the second lens assemblies and the second housing 1230 can be reduced throughout the moving ranges of the first lens assembly and the second lens assembly.

In addition, the second housing 1230 may include the second protrusion or the second housing protrusion 1232pr2 vertically extending from the second inner surface 1232s2 facing the lower surface of the first lens assembly. The second housing protrusion 1232pr2 may extend upward. Furthermore, the second housing protrusion 1232pr2 may include a third sub-housing protrusion 1232pr2a and a fourth sub-housing protrusion 1232pr2b.

In an embodiment, the third sub-housing protrusion 1232pr2a and the fourth sub-housing protrusion 1232pr2b may be disposed to be spaced apart from each other in the horizontal direction. Furthermore, a separation distance L4 between the third sub-housing protrusion 1232pr2a and the fourth sub-housing protrusion 1232pr2b in the horizontal direction may be greater than the length L1 of the housing opening 1232h in the horizontal direction.

In addition, the separation distance L4 between the third sub-housing protrusion 1232pr2a and the fourth sub-housing protrusion 1232pr2b in the horizontal direction may be equal to or different from the separation distance L3 between the first sub-housing protrusion 1232pr1a and the second sub-housing protrusion 1232pr1b in the horizontal direction.

For example, the separation distance L4 between the third sub-housing protrusion 1232pr2a and the fourth sub-housing protrusion 1232pr2b in the horizontal direction may be equal to the separation distance L3 between the first sub-housing protrusion 1232pr1a and the second sub-housing protrusion 1232pr1b in the horizontal direction. Therefore, the first housing protrusion 1232pr1 and the second housing protrusion 1232pr2 may at least partially overlap each other in the vertical direction. With this configuration, it is possible to improve reliability against impact.

The separation distance L4 between the third sub-housing protrusion 1232pr2a and the fourth sub-housing protrusion 1232pr2b in the horizontal direction may be different from the separation distance L3 between the first sub-housing protrusion 1232pr1a and the second sub-housing protrusion 1232pr1b in the horizontal direction. Therefore, at least a portion of the first sub-housing protrusion 1232pr1a may not overlap the third sub-housing protrusion 1232pr2a in the vertical direction. In addition, at least a portion of the second sub-housing protrusion 1232pr1b may not overlap the fourth sub-housing protrusion 1232pr2b in the vertical direction. With this configuration, it is possible to easily distribute the impact.

In addition, in the above-described second camera actuator, the first lens assembly may have first and second assembly protrusions, and the second housing may have first and second housing protrusions. Furthermore, the first and second assembly protrusions and the first and second housing protrusions may at least partially overlap each other in the vertical direction. Therefore, the impact between the lens assembly and the second housing can be distributed through each of the assembly protrusions and the housing protrusions.

In addition, the first and second housing protrusions and the first and second lens assembly protrusions may not overlap each other in the vertical direction. Therefore, it is possible to improve the impact reliability of the lens assembly and the second housing, and the first and second lens assemblies may easily perform the accurate straight movement along the optical axis.

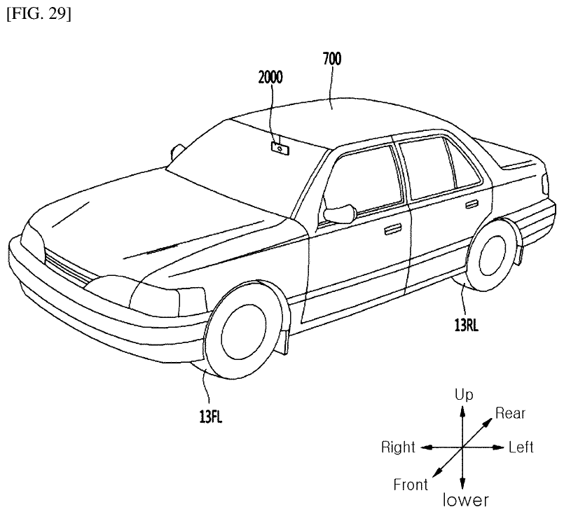

FIG. 28 is a perspective view of a portable terminal to which the camera device according to the embodiment is applied.

Referring to FIG. 28, a portable terminal 1500 according to the embodiment may include a camera device 1000, a flash module 1530, and an AF device 1510, which are provided on a rear surface thereof.

The camera device 1000 may include an image capturing function and an AF function. For example, the camera device 1000 may include the AF function using an image.

The camera device 1000 processes an image frame of a still image or a moving image obtained by an image sensor in a capturing mode or a video call mode.

The processed image frame may be displayed on a predetermined display and stored in a memory. A camera (not shown) may also be disposed on a front surface of a body of the portable terminal.

For example, the camera device 1000 may include a first camera device 1000A and a second camera device 1000B, and the first camera device 1000A may implement an OIS function together with an AF or zooming function. In addition, the AF, zooming, and OIS functions may be performed by the second camera device 1000B. In this case, since the first camera device 1000A includes both of the first camera actuator and the second camera actuator, the camera device can be easily miniaturized by changing an optical path.

The flash module 1530 may include a light emitting device for emitting light therein. The flash module 1530 may be operated by a camera operation of the mobile terminal or the user's control.

The AF device 1510 may include one of packages of a surface light emitting laser device as a light emitting unit.

The AF device 1510 may include the AF function using a laser. The AF device 1510 may be mainly used in a condition that the AF function using the image of the camera device 1000 is degraded, for example, a proximity of 10 m or less or dark environment.

The AF device 1510 may include a light emitting unit including a vertical cavity surface emitting laser (VCSEL) semiconductor device and a light receiving unit for converting light energy into electrical energy, such as a photodiode.

FIG. 29 is a perspective view of a vehicle to which the camera module according to the embodiment is applied.

For example, FIG. 29 is an external view of the vehicle including a vehicle driver assistance device to which the camera device 1000 according to the embodiment is applied.

Referring to FIG. 29, a vehicle 700 in the embodiment may include wheels 13FL and 13FR rotated by a power source and a predetermined sensor. The sensor may be a camera sensor 2000, but the present disclosure is not limited thereto.

The camera sensor 2000 may be a camera sensor to which the camera device 1000 according to the embodiment is applied. The vehicle 700 in the embodiment may acquire image information through the camera sensor 2000 for capturing a front image or a surrounding image, determine a situation in which a lane line is not identified using the image information, and generate a virtual lane line when the lane line is not identified.

For example, the camera sensor 2000 may acquire a front image by capturing a view in front of the vehicle 700, and a processor (not shown) may acquire image information by analyzing an object included in the front image.

For example, when objects, such as a median, a curb, or a street tree corresponding to a lane line, an adjacent vehicle, a traveling obstacle, and an indirect road mark, are captured in the image captured by the camera sensor 2000, the processor may detect the object and include the detected object in the image information. At this time, the processor may further supplement the image information by acquiring distance information to the object detected through the camera sensor 2000.

The image information may be information on the object captured in the image. The camera sensor 2000 may include an image sensor and an image processing module.

The camera sensor 2000 may process still images or moving images obtained by the image sensor (e.g., a complementary metal-oxide semiconductor (CMOS) or a charge-coupled device (CCD)).

The image processing module may process the still images or moving images acquired through the image sensor to extract necessary information, and transmit the extracted information to the processor.

At this time, the camera sensor 2000 may include a stereo camera for improving the measurement accuracy of the object and further securing information such as a distance between the vehicle 700 and the object, but the present disclosure is not limited thereto.

Although embodiments have been mainly described above, these are only illustrative and do not limit the present disclosure, and those skilled in the art to which the present disclosure pertains will understand that various modifications and applications not exemplified above are possible without departing from the essential characteristics of the embodiments. For example, each component specifically shown in the embodiments may be implemented by modification. In addition, differences related to these modifications and applications should be construed as being included in the scope of the present disclosure defined in the appended claims.

1. A camera device comprising:
a housing;
a first bobbin configured to move in an optical axis direction with respect to the housing; and
a first driving unit configured to move the first bobbin,
wherein the first driving unit includes a first coil and a first magnet facing the first coil,
the camera device further includes a first yoke which is coupled to the first bobbin and on which the first magnet is disposed,
the first yoke includes a bottom portion and a side plate portion disposed on a side surface of the bottom portion, and
the first magnet is surrounded by the bottom portion and the side plate portion.

2. The camera device of claim 1, wherein the side plate portion includes first side plate portions facing in the optical axis direction and second side plate portions facing in a vertical direction, and
the first yoke includes a coupling portion extending from the bottom portion toward the first bobbin.

3. The camera device of claim 2, wherein the second side plate portions include a first sub-side plate portion and a second sub-side plate portion disposed to be spaced apart from each other in the optical axis direction.

4. The camera device of claim 3, wherein the coupling portion is disposed between the first sub-side plate portion and the second sub-side plate portion.

5. The camera device of claim 2, wherein at least a portion of the coupling portion overlaps the first bobbin in the vertical direction.

6. The camera device of claim 3, wherein the first sub-side plate portion and the second sub-side plate portion have the same length in the optical axis direction.

7. The camera device of claim 3, wherein a length of the coupling portion in the optical axis direction is smaller than a length of the first sub-side plate portion or the second sub-side plate portion in the optical axis direction.

8. The camera device of claim 3, wherein the bottom portion includes a yoke groove disposed in at least one of a space between the first sub-side plate portion and the coupling portion and a space between the second sub-side plate portion and the coupling portion.

9. The camera device of claim 1, wherein the first yoke includes a yoke hole disposed in the bottom portion, and
the yoke hole is disposed on a first virtual line that bisects the first yoke in a vertical direction.

10. The camera device of claim 4, wherein the coupling portion is disposed on a virtual line that bisects the first yoke in the optical axis direction.

11. The camera device of claim 3, wherein the first sub-side plate portion and the second sub-side plate portion have different lengths in the optical axis direction.

12. The camera device of claim 4, wherein the coupling portion is not disposed on a second virtual line, and
the second virtual line is a line that bisects the first yoke in the optical axis direction.

13. The camera device of claim 4, wherein the coupling portion is provided as a plurality of coupling portions that do not overlap each other in the vertical direction.

14. The camera device of claim 2, wherein a length of the second side plate portion in a horizontal direction is smaller than or equal to a length of the first magnet in the horizontal direction.

15. The camera device of claim 2, wherein an outer surface of the first magnet is disposed outside the second side plate portion.

16. The camera device of claim 1, wherein the first coil includes a first sub-coil and a second sub-coil disposed to overlap each other in the optical axis direction, and
a maximum length of the first sub-coil in the optical axis direction is greater than a length of the first magnet in the optical axis direction.

17. The camera device of claim 2, wherein a length of the first magnet in the optical axis direction is greater than a maximum moving distance of the first bobbin.

18. The camera device of claim 1, further comprising:
a second bobbin configured to move in the optical axis direction; and
a second driving unit configured to move the second bobbin,
wherein the second driving unit includes a second coil and a second magnet facing the second coil, and
the second coil includes a third sub-coil and a fourth sub-coil disposed to overlap each other in the optical axis direction.

19. The camera device of claim 18, further comprising an image sensor,
wherein the second bobbin is disposed closer to the image sensor than the first bobbin is, and
a moving distance of the second bobbin in the optical axis direction is greater than a moving distance of the first bobbin in the optical axis direction.

20. A camera device comprising:
a housing;
a first bobbin and a second bobbin configured to move in an optical axis direction with respect to the housing;
a first driving unit including a first magnet configured to move the first bobbin; and
a second driving unit including a second magnet configured to move the second bobbin,
wherein the first magnet and the second magnet are positioned at sides opposite to each other, and
the camera device further includes a yoke on which any one of the first magnet and the second magnet is disposed.
